(19) United States
(12) Patent Application Publication
(10) Pub. No.: US 2026/0032243 A1
(43) Pub. Date: Jan. 29, 2026

(54) METHOD, APPARATUS, AND MEDIUM FOR VIDEO PROCESSING

(71) Applicants: Douyin Vision Co., Ltd., Beijing (CN); Bytedance Inc., Los Angeles, CA (US)

(72) Inventors: Chaoyi LIN, Beijing (CN); Ye-Kui Wang, Los Angeles, CA (US); Jizheng Xu, Los Angeles, CA (US); Yue Li, Los Angeles, CA (US); Junru Li, Beijing (CN); Kai Zhang, Los Angeles, CA (US); Li Zhang, Los Angeles, CA (US)

(21) Appl. No.: 19/349,894

(22) Filed: Oct. 3, 2025

Related U.S. Application Data
(63) Continuation of application No. PCT/CN2024/086288, filed on Apr. 6, 2024.

(30) Foreign Application Priority Data
Apr. 6, 2023 (WO) PCT/CN2023/086556
Apr. 14, 2023 (WO) PCT/CN2023/088532

(51) Int. Cl. H04N 19/117; H04N 19/136; H04N 19/172; H04N 19/184; H04N 19/42; H04N 19/80; H04N 19/85

(52) U.S. Cl. CPC H04N 19/117; H04N 19/136; H04N 19/172; H04N 19/184; H04N 19/42; H04N 19/80; H04N 19/85

(57) ABSTRACT

Embodiments of the present disclosure provide a solution for video processing. A method for video processing is proposed. The method comprises: performing a conversion between a video and a bitstream of the video, wherein a neural-network post-processing filter (NNPF) is applied on a first picture associated with the video, the bitstream comprises a first indication indicating a purpose of the NNPF, a first candidate of a plurality of candidates for the purpose is generating a second picture corresponding to the first picture, and a type of information comprised in the second picture is different from the first picture.

### CROSS REFERENCE TO RELATED APPLICATIONS

This application is a continuation of International Application No. PCT/CN2024/086288, filed on Apr. 6, 2024, which claims the benefit of International Application No. PCT/CN2023/086556, filed on Apr. 6, 2023, and International Application No. PCT/CN2023/088532, filed on Apr. 14, 2023. The entire contents of these applications are hereby incorporated by reference in their entireties.

### FIELDS

Embodiments of the present disclosure relates generally to video processing techniques, and more particularly, to a neural-network post-processing filter (NNPF).

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, the functionality of video coding techniques is generally expected to be further improved.

### SUMMARY

Embodiments of the present disclosure provide a solution for video processing.

In a first aspect, a method for video processing is proposed. The method comprises: performing a conversion between a video and a bitstream of the video, wherein a neural-network post-processing filter (NNPF) is applied on a first picture associated with the video, the bitstream comprises a first indication indicating a purpose of the NNPF, a first candidate of a plurality of candidates for the purpose is generating a second picture corresponding to the first picture, and a type of information comprised in the second picture is different from the first picture.

Based on the method in accordance with the first aspect of the present disclosure, candidates for a purpose of NNPF comprises generating a second picture corresponding to a first picture, and a type of information comprised in the second picture is different from the first picture. Compared with the conventional solution, the proposed method can advantageously make it possible for the NNPF to support generate a picture that is of a type different from the input picture of the NNPF. Thereby, the functionality of NNPF may be extended and enhanced.

In a second aspect, another method for video processing is proposed. The method comprises: performing a conversion between a video and a bitstream of the video, wherein a neural-network post-processing filter (NNPF) is applied on a first picture associated with the video, the bitstream comprises a second indication indicating whether a second picture corresponding to the first picture is inputted to the NNPF, and a type of information comprised in the second picture is different from the first picture.

Based on the method in accordance with the second aspect of the present disclosure, the bitstream comprises an indication indicating whether a second picture corresponding to a first picture is inputted to the NNPF, and a type of information comprised in the second picture is different from the first picture. Compared with the conventional solution, the proposed method can advantageously make it possible for the NNPF use a picture that is of a type different from an input picture of the NNPF as an additional input. Thereby, the functionality of NNPF may be extended and enhanced.

In a third aspect, an apparatus for video processing is proposed. The apparatus comprises a processor and a non-transitory memory with instructions thereon. The instructions upon execution by the processor, cause the processor to perform a method in accordance with the first aspect or the second aspect of the present disclosure.

In a fourth aspect, a non-transitory computer-readable storage medium is proposed. The non-transitory computer-readable storage medium stores instructions that cause a processor to perform a method in accordance with the first aspect or the second aspect of the present disclosure.

In a fifth aspect, another non-transitory computer-readable recording medium is proposed. The non-transitory computer-readable recording medium stores a bitstream of a video which is generated by a method performed by an apparatus for video processing. The method comprises: performing a conversion between a video and a bitstream of the video, wherein a neural-network post-processing filter (NNPF) is applied on a first picture associated with the video, the bitstream comprises a first indication indicating a purpose of the NNPF, a first candidate of a plurality of candidates for the purpose is generating a second picture corresponding to the first picture, and a type of information comprised in the second picture is different from the first picture.

In a sixth aspect, a method for storing a bitstream of a video is proposed. The method comprises: performing a conversion between a video and a bitstream of the video, wherein a neural-network post-processing filter (NNPF) is applied on a first picture associated with the video, the bitstream comprises a first indication indicating a purpose of the NNPF, a first candidate of a plurality of candidates for the purpose is generating a second picture corresponding to the first picture, and a type of information comprised in the second picture is different from the first picture; and storing the bitstream in a non-transitory computer-readable recording medium.

In a seventh aspect, another non-transitory computer-readable recording medium is proposed. The non-transitory computer-readable recording medium stores a bitstream of a video which is generated by a method performed by an apparatus for video processing. The method comprises: performing a conversion between a video and a bitstream of the video, wherein a neural-network post-processing filter (NNPF) is applied on a first picture associated with the video, the bitstream comprises a second indication indicating whether a second picture corresponding to the first picture is inputted to the NNPF, and a type of information comprised in the second picture is different from the first picture.

In an eighth aspect, a method for storing a bitstream of a video is proposed. The method comprises: performing a conversion between a video and a bitstream of the video, wherein a neural-network post-processing filter (NNPF) is applied on a first picture associated with the video, the bitstream comprises a second indication indicating whether a second picture corresponding to the first picture is inputted to the NNPF, and a type of information comprised in the second picture is different from the first picture; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 illustrates an illustration of luma data channels;

FIG. 5 illustrates a flowchart of a method for video processing in accordance with embodiments of the present disclosure;

FIG. 6 illustrates a flowchart of another method for video processing in accordance with embodiments of the present disclosure; and

FIG. 7 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

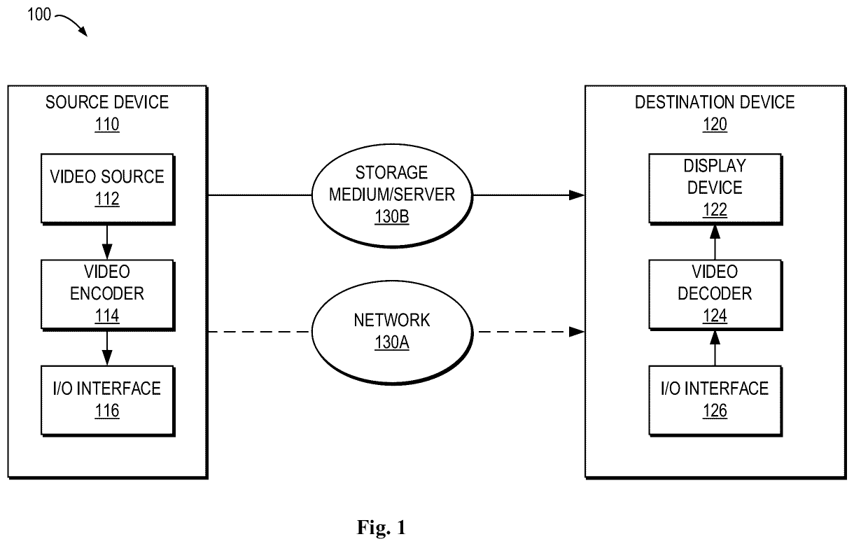

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

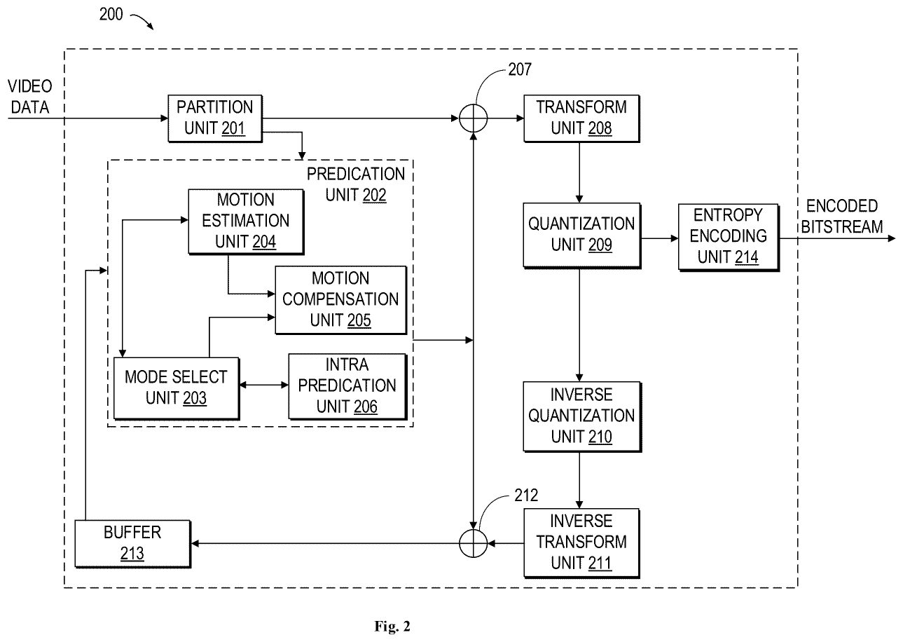

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a predication unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the predication unit 202 may include an intra block copy (IBC) unit. The IBC unit may perform predication in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter predication (CIIP) mode in which the predication is based on an inter predication signal and an intra predication signal. The mode select unit 203 may also select a resolution for a motion vector (e.g., a sub-pixel or integer pixel precision) for the block in the case of inter-predication.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector predication (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block(s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the predication unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

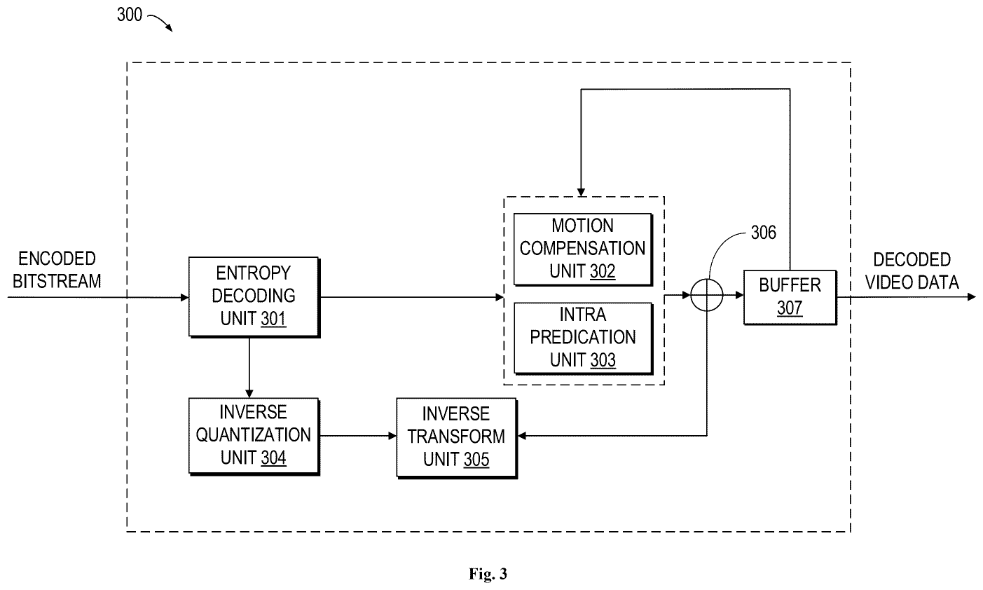

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra predication and also produces decoded video for presentation on a display device.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. Initial Discussion

This document is related to image/video coding technologies. Specifically, this disclosure is related to the definition and signalling of neural-network post filter (NNPF) purposes, with depth picture generation and/or usage of depth picture as extra input to an NNPF. The ideas may be applied individually or in various combinations, for video bitstreams coded by any codec, e.g., the versatile video coding (VVC) standard and/or the versatile supplemental enhancement information (SEI) messages for coded video bitstreams (VSEI) standard.

### 2. Abbreviations

adaptation parameter set (APS), access unit (AU), coded layer video sequence (CLVS), coded layer video sequence start (CLVSS), cyclic redundancy check (CRC), coded video sequence (CVS), finite impulse response (FIR), intra random access point (IRAP), network abstraction layer (NAL), picture parameter set (PPS), picture unit (PU), random access skipped leading (RASL) picture, supplemental enhancement information (SEI), step-wise temporal sublayer access (STSA), video coding layer (VCL), versatile supplemental enhancement information as described in Rec. ITU-T H.274|ISO/IEC 23002-7 (VSEI), video usability information (VUI), versatile video coding as described in Rec. ITU-T H.266|ISO/IEC 23090-3 (VVC).

### 3. Further Discussion

### 3.1 Video Coding Standards

Video coding standards have evolved primarily through the development of International Telecommunication Union (ITU) telecommunication standardization sector (ITU-T) and International Organization for Standardization (ISO)/International Electrotechnical Commission (IEC) standards. The ITU-T produced H.261 and H.263, ISO/IEC produced motion picture experts group (MPEG)-1 and MPEG-4 Visual, and the two organizations jointly produced the H.262/MPEG-2 Video and H.264/MPEG-4 Advanced Video Coding (AVC) and H.265/high efficiency video coding (HEVC) standards. Since H.262, the video coding standards are based on the hybrid video coding structure wherein temporal prediction plus transform coding are utilized. To explore video coding technologies beyond high efficiency video coding (HEVC), the Joint Video Exploration Team (JVET) was founded by video coding experts group (VCEG) and motion picture experts group (MPEG). Further, methods have been adopted by JVET and put into the reference software named Joint Exploration Model (JEM). The JVET was later renamed to be the Joint Video Experts Team (JVET) when the Versatile Video Coding (VVC) project officially started. VVC is a coding standard targeting at 50% bitrate reduction as compared to HEVC.

The Versatile Video Coding (VVC) standard (ITU-T H.266|ISO/IEC 23090-3) and the associated Versatile Supplemental Enhancement Information for coded video bitstreams (VSEI) standard (ITU-T H.274|ISO/IEC 23002-7) are designed for use in a maximally broad range of applications, including both the simple uses such as television broadcast, video conferencing, or playback from storage media, and also more advanced use cases such as adaptive bit rate streaming, video region extraction, composition and merging of content from multiple coded video bitstreams, multiview video, scalable layered coding, and viewport-adaptive 360° immersive media.

The Essential Video Coding (EVC) standard (ISO/IEC 23094-1) is another video coding standard under development by MPEG.

### 3.2 SEI Messages in General and in VVC and VSEI

SEI messages assist in processes related to decoding, display or other purposes. However, SEI messages are not required for constructing the luma or chroma samples by the decoding process. Conforming decoders are not required to process this information for output order conformance. Some SEI messages are required for checking bitstream conformance and for output timing decoder conformance. Other SEI messages are not required for check bitstream conformance.

Annex D of VVC specifies syntax and semantics for SEI message payloads for some SEI messages, and specifies the use of the SEI messages and VUI parameters for which the syntax and semantics are specified in ITU-T H.274|ISO/IEC 23002-7.

### 3.3 Signalling of Neural-Network Post Filters

An excerpt from the specification of two SEI messages for signalling of neural-network post-filters, as follows.

### 8.28 Neural-Network Post-Filter Characteristics SEI Message

### 8.28.1 Neural-Network Post-Filter Characteristics SEI Message Syntax

| | De- |
|---|---|
| | scriptor |
| nn_post_filter_characteristics( payloadSize ) { | |
| nnpfc_purpose | u(16) |
| nnpfc_id | ue(v) |
| nnpfc_mode_idc | ue(v) |
| if( nnpfc_mode_idc = = 1 ) { | |
| while( !byte_aligned( ) ) | |
| nnpfc_reserved_zero_bit_a | u(1) |
| nnpfc_tag_uri | st(v) |
| nnpfc_uri | st(v) |
| } | |
| nnpfc_property_present_flag | u(1) |
| if( nnpfc_property_present_flag ) { | |
| nnpfc_base_flag | u(1) |
| /* input and output formatting */ | |
| nnpfc_num_input_pics_minus1 | ue(v) |
| if( ( nnpfc_purpose & 0x02 ) != 0 ) | |
| nnpfc_out_sub_c_flag | u(1) |
| if( ( nnpfc_purpose & 0x20 ) != 0 ) | |
| nnpfc_out_colour_format_idc | u(2) |
| if( ( nnpfc_purpose & 0x04 ) != 0 ) { | |
| nnpfc_pic_width_in_luma_samples | ue(v) |
| nnpfc_pic_height_in_luma_samples | ue(v) |
| } | |
| if( ( nnpfc_purpose & 0x08 ) != 0 ) { | |
| for( i = 0; i < nnpfc_num_input_pics_minus1; i++ ) | |
| nnpfc_interpolated_pics[ i ] | ue(v) |
| for( i = 0; i <= nnpfc_num_input_pics_minus1; i++ ) | |
| nnpfc_input_pic_output_flag[ i ] | u(1) |
| } | |
| nnpfc_component_last_flag | u(1) |
| nnpfc_inp_format_idc | ue(v) |
| if( nnpfc_inp_format_idc = = 1 ) { | |
| nnpfc_inp_tensor_luma_bitdepth_minus8 | ue(v) |
| nnpfc_inp_tensor_chroma_bitdepth_minus8 | ue(v) |
| } | |
| nnpfc_inp_order_idc | ue(v) |
| nnpfc_auxiliary_inp_idc | ue(v) |
| nnpfc_separate_colour_description_present_flag | u(1) |
| if( nnpfc_separate_colour_description_present_flag ) { | |
| nnpfc_colour_primaries | u(8) |
| nnpfc_transfer_characteristics | u(8) |
| nnpfc_matrix_coeffs | u(8) |
| } | |
| nnpfc_out_format_idc | ue(v) |
| if( nnpfc_out_format_idc = = 1 ) { | |
| nnpfc_out_tensor_luma_bitdepth_minus8 | ue(v) |
| nnpfc_out_tensor_chroma_bitdepth_minus8 | ue(v) |
| } | |
| nnpfc_out_order_idc | ue(v) |
| nnpfc_overlap | ue(v) |
| nnpfc_constant_patch_size_flag | u(1) |
| if( nnpfc_constant_patch_size_flag ) { | |
| nnpfc_patch_width_minus1 | ue(v) |
| nnpfc_patch_height_minus1 | ue(v) |
| } else { | |
| nnpfc_extended_patch_width_cd_delta_minus1 | ue(v) |
| nnpfc_extended_patch_height_cd_delta_minus1 | ue(v) |
| } | |
| nnpfc_padding_type | ue(v) |
| if( nnpfc_padding_type = = 4 ) { | |
| nnpfc_luma_padding_val | ue(v) |
| nnpfc_cb_padding_val | ue(v) |
| nnpfc_cr_padding_val | ue(v) |
| } | |
| nnpfc_complexity_info_present_flag | u(1) |
| if( nnpfc_complexity_info_present_flag ) { | |
| nnpfc_parameter_type_idc | u(2) |
| if( nnpfc_parameter_type_idc != 2 ) | |
| nnpfc_log2_parameter_bit_length_minus3 | u(2) |
| nnpfc_num_parameters_idc | u(6) |
| nnpfc_num_kmac_operations_idc | ue(v) |
| nnpfc_total_kilobyte_size | ue(v) |
| } | |
| } | |
| /* ISO/IEC 15938-17 bitstream */ | |
| if( nnpfc_mode_idc = = 0 ) { | |
| while( !byte_aligned( ) ) | |
| nnpfc_reserved_zero_bit_b | u(1) |
| for( i = 0; more_data_in_payload( ); i++ ) | |
| nnpfc_payload_byte[ i ] | b(8) |
| } | |
| } | |

### 8.28.2 Neural-Network Post-Filter Characteristics SEI Message Semantics

The neural-network post-filter characteristics (NNPFC) SEI message specifies a neural network that may be used as a post-processing filter. The use of specified neural-network post-processing filters (NNPFs) for specific pictures is indicated with neural-network post-filter activation (NNPFA) SEI messages.

Use of this SEI message requires the definition of the following variables:
Input picture width and height in units of luma samples, denoted herein by CroppedWidth and CroppedHeight, respectively.
Luma sample array CroppedYPic[idx] and chroma sample arrays CroppedCbPic[idx] and CroppedCrPic[idx], when present, of the input pictures with index idx in the range of 0 to numInputPics−1, inclusive, that are used as input for the NNPF.
Bit depth BitDepth_{Y} for the luma sample array of the input pictures.
Bit depth BitDepth_{C} for the chroma sample arrays, if any, of the input pictures.
A chroma format indicator, denoted herein by ChromaFormatIdc, as described in subclause 7.3.
When nnpfc_auxiliary_inp_idc is equal to 1, a filtering strength control value StrengthControlVal that shall be a real number in the range of 0 to 1, inclusive.

Input picture with index 0 corresponds to the picture for which the NNPFdefined by this NNPFC SEI message is activated by an NNPFA SEI message. Input picture with index i in the range of 1 to numInputPics−1, inclusive, precedes the input picture with index i−1 in output order.

When nnpfc_purpose & 0x08 is not equal to 0 and the input picture with index 0 is associated with a frame packing arrangement SEI message with fp_arrangement_type equal to 5, all input pictures are associated with a frame packing arrangement SEI message with fp_arrangement_type equal to 5 and the same value of fp_current_frame_is_frame0_flag.

The variables SubWidthC and SubHeightC are derived from ChromaFormatIdc.

NOTE 1—More than one NNPFC SEI message can be present for the same picture. When more than one NNPFC SEI message with different values of nnpfc_id is present or activated for the same picture, they can have the same or different values of nnpfc_purpose and nnpfc_mode_idc.

nnpfc_purpose indicates the purpose of the NNPF as specified in Table 1.

The value of nnpfc_purpose shall be in the range of 0 to 63, inclusive, in bitstreams conforming to this edition of this document. Values of 64 to 65 535, inclusive, for nnpfc_purpose are reserved for future use by ITU-T|ISO/IEC and shall not be present in bitstreams conforming to this edition of this document. Decoders conforming to this edition of this document shall ignore NNPFC SEI messages with nnpfc_purpose in the range of 64 to 65 535, inclusive.

TABLE 1
Definition of nnpfc_purpose

| Value | Interpretation |
|---|---|
| nnpfc_purpose = = 0 | May be used as determined by the application |
| nnpfc_purpose > 0 && | No general visual quality improvement |
| ( nnpfc_purpose & | |
| 0x01 ) = = 0 | |
| ( nnpfc_purpose & | With general visual quality improvement |
| 0x01 ) != 0 | |
| nnpfc_purpose > 0 && | No chroma upsampling (from the 4:2:0 chroma format to the 4:2:2 or 4:4:4 |
| ( nnpfc_purpose & | chroma format, or from the 4:2:2 chroma format to the 4:4:4 chroma format) |
| 0x02 ) = = 0 | |
| ( nnpfc_purpose & | With chroma upsampling |
| 0x02 ) != 0 | |
| nnpfc_purpose > 0 && | No resolution upsampling (increasing the width or height) |
| ( nnpfc_purpose & | |
| 0x04 ) = = 0 | |
| ( nnpfc_purpose & | With resolution upsampling |
| 0x04 ) != 0 | |
| nnpfc_purpose > 0 && | No picture rate upsampling |
| ( nnpfc_purpose & | |
| 0x08 ) = = 0 | |
| ( nnpfc_purpose & | With picture rate upsampling |
| 0x08 ) != 0 | |
| nnpfc_purpose > 0 && | No bit depth upsampling (increasing the luma bit depth or the chroma bit |
| ( nnpfc_purpose & | depth) |
| 0x10 ) = = 0 | |
| ( nnpfc_purpose & | With bit depth upsampling |
| 0x10 ) != 0 | |
| nnpfc_purpose > 0 && | No colourization (from the 4:0:0 chroma format to the 4:2:0, 4:2:2, or 4:4:4 |
| ( nnpfc_purpose & | chroma format) |
| 0x20 ) = = 0 | |
| ( nnpfc_purpose & | With colourization |
| 0x20 ) != 0 | |

NOTE 2—When a reserved value of nnpfc_purpose is taken into use in the future by ITU-T| ISO/IEC, the syntax of this SEI message could be extended with syntax elements whose presence is conditioned by nnpfc_purpose being equal to that value.

When ChromaFormatIdc is equal to 3, nnpfc_purpose & 0x02 shall be equal to 0.

When ChromaFormatIdc or nnpfc_purpose & 0x02 is not equal to 0, nnpfc_purpose & 0x20 shall be equal to 0.

nnpfc_id contains an identifying number that may be used to identify an NNPF. The value of nnpfc_id shall be in the range of 0 to 232-2, inclusive. Values of nnpfc_id from 256 to 511, inclusive, and from 231 to 232−2, inclusive, are reserved for future use by ITU-T|ISO/IEC. Decoders conforming to this edition of this document encountering an NNPFC SEI message with nnpfc_id in the range of 256 to 511, inclusive, or in the range of 231 to 232-2, inclusive, shall ignore the SEI message.

When an NNPFC SEI message is the first NNPFC SEI message, in decoding order, that has a particular nnpfc_id value within the current CLVS, the following applies:
This SEI message specifies a base NNPF.
This SEI message pertains to the current decoded picture and all subsequent decoded pictures of the current layer, in output order, until the end of the current CLVS.

nnpfc_mode_idc equal to 0 indicates that this SEI message contains an ISO/IEC 15938-17 bitstream that specifies a base NNPF or is an update relative to the base NNPF with the same nnpfc_id value.

When an NNPFC SEI message is the first NNPFC SEI message, in decoding order, that has a particular nnpfc_id value within the current CLVS, nnpfc_mode_idc equal to 1 specifies that the base NNPF associated with the nnpfc_id value is a neural network identified by the URI indicated by nnpfc_uri with the format identified by the tag URI nnpfc_tag_uri.

When an NNPFC SEI message is neither the first NNPFC SEI message, in decoding order, nor a repetition of the first NNPFC SEI message, in decoding order, that has a particular nnpfc_id value within the current CLVS, nnpfc_mode_idc equal to 1 specifies that an update relative to the base NNPF with the same nnpfc_id value is defined by the URI indicated by nnpfc_uri with the format identified by the tag URI nnpfc_tag_uri.

The value of nnpfc_mode_idc shall be in the range of 0 to 1, inclusive, in bitstreams conforming to this edition of this document. Values of 2 to 255, inclusive, for nnpfc_mode_idc are reserved for future use by ITU-T|ISO/IEC and shall not be present in bitstreams conforming to this edition of this document. Decoders conforming to this edition of this document shall ignore NNPFC SEI messages with nnpfc_mode_idc in the range of 2 to 255, inclusive. Values of nnpfc_mode_idc greater than 255 shall not be present in bitstreams conforming to this edition of this document and are not reserved for future use.

When this SEI message is the first NNPFC SEI message, in decoding order, that has a particular nnpfc_id value within the current CLVS, the NNPF PostProcessingFilter( ) is assigned to be the same as the base NNPF.

When this SEI message is neither the first NNPFC SEI message, in decoding order, nor a repetition of the first NNPFC SEI message, in decoding order, that has a particular nnpfc_id value within the current CLVS, an NNPF PostProcessingFilter( ) is obtained by applying the update defined by this SEI message to the base NNPF.

Updates are not cumulative but rather each update is applied on the base NNPF, which is the NNPF specified by the first NNPFC SEI message, in decoding order, that has a particular nnpfc_id value within the current CLVS.

nnpfc_reserved_zero_bit_a shall be equal to 0 in bitstreams conforming to this edition of this document. Decoders shall ignore NNPFC SEI messages in which nnpfc_reserved_zero_bit_a is not equal to 0.

nnpfc_tag_uri contains a tag URI with syntax and semantics as specified in IETF RFC 4151 identifying the format and associated information about the neural network used as a base NNPF or an update relative to the base NNPF with the same nnpfc_id value specified by nnpfc_uri.

NOTE 3—nnpfc_tag_uri enables uniquely identifying the format of neural network data specified by nnrpf_uri without needing a central registration authority.

nnpfc_tag_uri equal to “tag: iso.org, 2023:15938-17” indicates that the neural network data identified by nnpfc_uri conforms to ISO/IEC 15938-17.

nnpfc_uri contains a URI with syntax and semantics as specified in IETF Internet Standard 66 identifying the neural network used as a base NNPF or an update relative to the base NNPF with the same nnpfc_id value.

nnpfc_property_present_flag equal to 1 specifies that syntax elements related to the filter purpose, input formatting, output formatting, and complexity are present. nnpfc_property_present_flag equal to 0 specifies that no syntax elements related to the filter purpose, input formatting, output formatting, and complexity are present.

When this SEI message is the first NNPFC SEI message, in decoding order, that has a particular nnpfc_id value within the current CLVS, nnpfc_property_present_flag shall be equal to 1.

When nnpfc_property_present_flag is equal to 0, the values of all syntax elements that may be present only when nnpfc_property_present_flag is equal to 1 and for which inference values for each of them is not specified are inferred to be equal to their corresponding syntax elements, respectively, in the NNPFC SEI message that contains the base NNPF for which this SEI provides an update.

nnpfc_base_flag equal to 1 specifies that the SEI message specifies the base NNPF. nnpf_base_flag equal to 0 specifies that the SEI message specifies an update relative to the base NNPF. When not present, the value of nnpfc_base_flag is inferred to be equal to 0.

The following constraints apply to the value of nnpfc_base_flag:
When an NNPFC SEI message is the first NNPFC SEI message, in decoding order, that has a particular nnpfc_id value within the current CLVS, the value of nnpfc_base_flag shall be equal to 1.
When an NNPFC SEI message nnpfcB is not the first NNPFC SEI message, in decoding order, that has a particular nnpfc_id value within the current CLVS and the value nnpfc_base_flag is equal to 1, the NNPFC SEI message shall be a repetition of the first NNPFC SEI message nnpfcA with the same nnpfc_id, in decoding order, i.e., the payload content of nnpfcB shall be the same as that of nnpfcA.

When an NNPFC SEI message is not the first NNPFC SEI message, in decoding order, that has a particular nnpfc_id value within the current CLVS and not a repetition of the first NNPFC SEI message with that particular nnpfc_id, the following applies:
This SEI message defines an update relative to the preceding base NNPF in decoding order with the same nnpfc_id value.
This SEI message pertains to the current decoded picture and all subsequent decoded pictures of the current layer, in output order, until the end of the current CLVS or up to but excluding the decoded picture that follows the current decoded picture in output order within the current CLVS and is associated with a subsequent NNPFC SEI message, in decoding order, having that particular nnpfc_id value within the current CLVS, whichever is earlier.

When an NNPFC SEI message nnpfcCurr is not the first NNPFC SEI message, in decoding order, that has a particular nnpfc_id value within the current CLVS, is not a repetition of the first NNPFC SEI message with that particular nnpfc_id (i.e., the value of nnpfc_base_flag is equal to 0), and the value of nnpfc_property_present_flag is equal to 1, the following constraints apply:
The value of nnpfc_purpose in the NNPFC SEI message shall be the same as the value of nnpfc_purpose in the first NNPFC SEI message, in decoding order, that has that particular nnpfc_id value within the current CLVS.
The values of syntax elements following nnpfc_base_flag and preceding nnpfc_complexity_info_present_flag, in decoding order, in the NNPFC SEI message shall be the same as the values of corresponding syntax elements in the first NNPFC SEI message, in decoding order, that has that particular nnpfc_id value within the current CLVS.
Either nnpfc_complexity_info_present_flag shall be equal to 0 or both nnpfc_complexity_info_present_flag shall be equal to 1 in the first NNPFC SEI message, in decoding order, that has that particular nnpfc_id value within the current CLVS (denoted as nnpfcBase below) and all the following apply:
nnpfc_parameter_parameter_type_idc in nnpfcCurr shall be equal to nnpfc_parameter_parameter_type_idc in nnpfcBase.
nnpfc_log 2_parameter_bit_length_minus3 in nnpfcCurr, when present, shall be less than or equal to nnpfc_log 2_parameter_bit_length_minus3 in nnpfcBase.
If nnpfc_num_parameters_idc in nnpfcBase is equal to 0, nnpfc_num_parameters_idc in nnpfcCurr shall be equal to 0.
Otherwise (nnpfc_num_parameters_idc in nnpfcBase is greater than 0), nnpfc_num_parameters_idc in nnpfcCurr shall be greater than 0 and less than or equal to nnpfc_num_parameters_idc in nnpfcBase.
If nnpfc_num_kmac_operations_idc in nnpfcBase is equal to 0, nnpfc_num_kmac_operations_idc in nnpfcCurr shall be equal to 0.
Otherwise (nnpfc_num_kmac_operations_idc in nnpfcBase is greater than 0), nnpfc_num_kmac_operations_idc in nnpfcCurr shall be greater than 0 and less than or equal to nnpfc_num_kmac_operations_idc in nnpfcBase.
If nnpfc_total_kilobyte_size in nnpfcBase is equal to 0, nnpfc_total_kilobyte_size in nnpfcCurr shall be equal to 0.
Otherwise (nnpfc_total_kilobyte_size in nnpfcBase is greater than 0), nnpfc_total_kilobyte_size in nnpfcCurr shall be greater than 0 and less than or equal to nnpfc_total_kilobyte_size in nnpfcBase.

nnpfc_out_sub_c_flag specifies the values of the variables outSubWidthC and outSubHeightC when nnpfc_purpose & 0x02 is not equal to 0. nnpfc_out_sub_c_flag equal to 1 specifies that outSubWidthC is equal to 1 and outSubHeightC is equal to 1. nnpfc_out_sub_c_flag equal to 0 specifies that outSubWidthC is equal to 2 and outSubHeightC is equal to 1. When ChromaFormatIdc is equal to 2 and nnpfc_out_sub_c_flag is present, the value of nnpfc_out_sub_c_flag shall be equal to 1.

nnpfc_out_colour_format_idc, when nnpfc_purpose & 0x20 is not equal to 0, specifies the colour format of the NNPF output and consequently the values of the variables outSubWidthC and outSubHeightC. nnpfc_out_colour_format_idc equal to 1 specifies that the colour format of the NNPF output is the 4:2:0 format and outSubWidthC and outSubHeightC are both equal to 2. nnpfc_out_colour_format_idc equal to 2 specifies that the colour format of the NNPF output is the 4:2:2 format and outSubWidthC is equal to 2 and outSubHeightC is equal to 1. nnpfc_out_colour_format_idc equal to 3 specifies that the colour format of the NNPF output is the 4:2:4 format and outSubWidthC and outSubHeightC are both equal to 1. The value of nnpfc_out_colour_format_idc shall not be equal to 0.

When nnpfc_purpose & 0x02 and nnpfc_purpose & 0x20 are both equal to 0, outSubWidthC and outSubHeightC are inferred to be equal to SubWidthC and SubHeightC, respectively.

nnpfc_pic_width_in_luma_samples and nnpfc_pic_height_in_luma_samples specify the width and height, respectively, of the luma sample array of the picture resulting from applying the NNPF identified by nnpfc_id to a cropped decoded output picture. When nnpfc_pic_width_in_luma_samples and nnpfc_pic_height_in_luma_samples are not present, they are inferred to be equal to CroppedWidth and

CroppedHeight, respectively. The value of nnpfc_pic_width_in_luma_samples shall be in the range of CroppedWidth to CroppedWidth*16−1, inclusive. The value of nnpfc_pic_height_in_luma_samples shall be in the range of CroppedHeight to CroppedHeight*16−1, inclusive.

nnpfc_num_input_pics_minus1 plus 1 specifies the number of decoded output pictures used as input for the NNPF. The value of nnpfc_num_input_pics_minus1 shall be in the range of 0 to 63, inclusive. When nnpfc_purpose & 0x08 is not equal to 0, the value of nnpfc_num_input_pics_minus1 shall be greater than 0.

nnpfc_interpolated_pics[i] specifies the number of interpolated pictures generated by the NNPF between the i-th and the (i+1)-th picture used as input for the NNPF. The value of nnpfc_interpolated_pics[i] shall be in the range of 0 to 63, inclusive. The value of nnpfc_interpolated_pics[i] shall be greater than 0 for at least one i in the range of 0 to nnpfc_num_input_pics_minus1-1, inclusive.

nnpfc_input_pic_output_flag[i] equal to 1 indicates that for the i-th input picture the NNPF generates a corresponding output picture. nnpfc_input_pic_output_flag[i] equal to 0 indicates that for the i-th input picture the NNPF does not generate a corresponding output picture.

The variables numInputPics, specifying the number of pictures used as input for the NNPF, and numOutputPics, specifying the total number of pictures resulting from the NNPF, are derived as follows.

```
numInputPics = nnpfc_num_input_pics_minus1 + 1
if( ( nnpfc_purpose & 0x08 ) != 0 ) {
for( i = 0, numOutputPics = 0; i < numInputPics; i++ )
  if( nnpfc_input_pic_output_flag[ i ] )
    numOutputPics++
for( i = 0; i <= numInputPics − 2; i++ ) (76)
  numOutputPics += nnpfc_interpolated_pics[ i ]
} else
numOutputPics = 1
```

nnpfc_component_last_flag equal to 1 indicates that the last dimension in the input tensor inputTensor to the NNPF and the output tensor outputTensor resulting from the NNPF is used for a current channel. nnpfc_component_last_flag equal to 0 indicates that the third dimension in the input tensor inputTensor to the NNPF and the output tensor outputTensor resulting from the NNPF is used for a current channel.

NOTE 4—The first dimension in the input tensor and in the output tensor is used for the batch index, which is a practice in some neural network frameworks. While formulae in the semantics of this SEI message use the batch size corresponding to the batch index equal to 0, it is up to the post-processing implementation to determine the batch size used as input to the neural network inference.

NOTE 5—For example, when nnpfc_inp_order_idc is equal to 3 and nnpfc_auxiliary_inp_idc is equal to 1, there are 7 channels in the input tensor, including four luma matrices, two chroma matrices, and one auxiliary input matrix. In this case, the process DeriveInputTensors( ) would derive each of these 7 channels of the input tensor one by one, and when a particular channel of these channels is processed, that channel is referred to as the current channel during the process.

nnpfc_inp_format_idc indicates the method of converting a sample value of the cropped decoded output picture to an input value to the NNPF. When nnpfc_inp_format_idc is equal to 0, the input values to the NNPF are real numbers and the functions InpY( ) and InpC( ) are specified as follows.

$$InpY ( x ) = x \div ( ( 1 ≪ {BitDepth}_{Y} ) - 1 ) \qquad ( 77 )$$

$$InpC ( x ) = x \div ( ( 1 ≪ {BitDepth}_{C} ) - 1 ) \qquad ( 78 )$$

When nnpfc_inp_format_idc is equal to 1, the input values to the NNPF are unsigned integer numbers and the functions InpY( ) and InpC( ) are specified as follows.

shiftY = BitDepthY − inpTensorBitDepthY
if( inpTensorBitDepthY >= BitDepthY)

| | |
|---|---|
| InpY( x ) = x << ( inpTensorBitDepthY − BitDepthY ) | (79) |

else
InpY( x ) = Clip3(0, ( 1 << inpTensorBitDepthY ) − 1, ( x + ( 1 << (
shiftY − 1 ) ) ) >> shiftY )
shiftC = BitDepthC − inpTensorBitDepthC
if( inpTensorBitDepthC >= BitDepthC )

| | |
|---|---|
| InpC( x ) = x << ( inpTensorBitDepthC − BitDepthC ) | (80) |

else
InpC( x ) = Clip3(0, ( 1 << inpTensorBitDepthC ) − 1, ( x + ( 1 << (
shiftC − 1 ) ) ) >> shiftC )

The variable inpTensorBitDepthY is derived from the syntax element nnpfc_inp_tensor_luma_bitdepth_minus8 as specified below. The variable inpTensorBitDepthC is derived from the syntax element nnpfc_inp_tensor_chroma_bitdepth_minus8 as specified below.

Values of nnpfc_inp_format_idc greater than 1 are reserved for future specification by ITU-T|ISO/IEC and shall not be present in bitstreams conforming to this edition of this document. Decoders conforming to this edition of this document shall ignore NNPFC SEI messages that contain reserved values of nnpfc_inp_format_idc.

nnpfc_inp_tensor_luma_bitdepth_minus8 plus 8 specifies the bit depth of luma sample values in the input integer tensor. The value of inpTensorBitDepthY is derived as follows.

$${inpTensorBitDepth}_{Y} = nnpfc\_inp \_tensor \_luma \_bitdepth \_minus8 + 8 \qquad ( 81 )$$

It is a requirement of bitstream conformance that the value of nnpfc_inp_tensor_luma_bitdepth_minus8 shall be in the range of 0 to 24, inclusive.

nnpfc_inp_tensor_chroma_bitdepth_minus8 plus 8 specifies the bit depth of chroma sample values in the input integer tensor. The value of inpTensorBitDepthC is derived as follows:

$${inpTensorBitDepth}_{C} = nnpfc\_inp \_tensor \_chroma \_bitdepth \_minus8 + 8 \qquad ( 82 )$$

It is a requirement of bitstream conformance that the value of nnpfc_inp_tensor_chroma_bitdepth_minus8 shall be in the range of 0 to 24, inclusive.

nnpfc_inp_order_idc indicates the method of ordering the sample arrays of a cropped decoded output picture as one of the input pictures to the NNPF.

The value of nnpfc_inp_order_idc shall be in the range of 0 to 3, inclusive, in bitstreams conforming to this edition of this document. Values of 4 to 255, inclusive, for nnpfc_inp_order_idc are reserved for future use by ITU-T|ISO/IEC and shall not be present in bitstreams conforming to this edition of this document. Decoders conforming to this edition of this document shall ignore NNPFC SEI messages with nnpfc_inp_order_idc in the range of 4 to 255, inclusive. Values of nnpfc_inp_order_idc greater than 255 shall not be present in bitstreams conforming to this edition of this document and are not reserved for future use.

When ChromaFormatIdc is not equal to 1, nnpfc_inp_order_idc shall not be equal to 3.

Table 2 contains an informative description of nnpfc_inp_order_idc values.

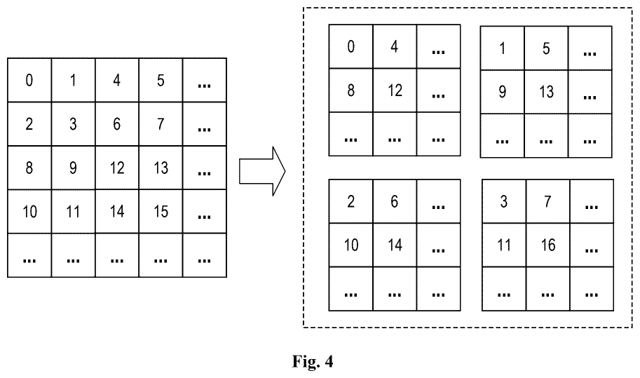

TABLE 2
Description of nnpfc_inp_order_idc values

| nnpfc_inp_{—} | |
|---|---|
| order_idc | Description |
| 0 | If nnpfc_auxiliary_inp_idc is equal to 0, one luma matrix is present in the input tensor |
| | for each input picture, and the number of channels is 1. Otherwise when |
| | nnpfc_auxiliary_inp_idc is equal to 1, one luma matrix and one auxiliary input matrix are |
| | present, and the number of channels is 2. |
| 1 | If nnpfc_auxiliary_inp_idc is equal to 0, two chroma matrices are present in the input |
| | tensor, and the number of channels is 2. Otherwise when nnpfc_auxiliary_inp_idc is |
| | equal to 1, two chroma matrices and one auxiliary input matrix are present, and the |
| | number of channels is 3. |
| 2 | If nnpfc_auxiliary_inp_idc is equal to 0, one luma and two chroma matrices are present |
| | in the input tensor, and the number of channels is 3. Otherwise when |
| | nnpfc_auxiliary_inp_idc is equal to 1, one luma matrix, two chroma matrices and one |
| | auxiliary input matrix are present, and the number of channels is 4. |
| 3 | If nnpfc_auxiliary_inp_idc is equal to 0, four luma matrices and two chroma matrices are |
| | present in the input tensor, and the number of channels is 6. Otherwise when |
| | nnpfc_auxiliary_inp_idc is equal to 1, four luma matrices, two chroma matrices, and one |
| | auxiliary input matrix are present in the input tensor, and the number of channels is 7. |
| | The luma channels are derived in an interleaved manner as illustrated in FIG. 4. This |
| | nnpfc_inp_order_idc can only be used when the input chroma format is 4:2:0. |
| 4 . . . 255 | Reserved |

FIG. 4 illustrates an example of deriving luma channels from a luma component.

A patch is a rectangular array of samples from a component (e.g., a luma or chroma component) of a picture.

nnpfc_auxiliary_inp_idc greater than 0 indicates that auxiliary input data is present in the input tensor of the NNPF. nnpfc_auxiliary_inp_idc equal to 0 indicates that auxiliary input data is not present in the input tensor. nnpfc_auxiliary_inp_idc equal to 1 specifies that auxiliary input data is derived as specified in Formula 84.

The value of nnpfc_auxiliary_inp_idc shall be in the range of 0 to 1, inclusive, in bitstreams conforming to this edition of this document. Values of 2 to 255, inclusive, for nnpfc_inp_order_idc are reserved for future use by ITU-T|ISO/IEC and shall not be present in bitstreams conforming to this edition of this document. Decoders conforming to this edition of this document shall ignore NNPFC SEI messages with nnpfc_inp_order_idc in the range of 2 to 255, inclusive. Values of nnpfc_inp_order_idc greater than 255 shall not be present in bitstreams conforming to this edition of this document and are not reserved for future use.

When nnpfc_auxiliary_inp_idc is equal to 1, the variable strengthControlScaledVal is derived as follows.

if( nnpfc_inp_format_idc = = 1 )
strengthControlScaledVal = Floor ( StrengthControlVal * ( ( 1 <<
inpTensorBitDepthY ) − 1 ) ) (83)
else
strengthControlScaledVal = StrengthControlVal

The process DeriveInputTensors( ) for deriving the input tensor inputTensor for a given vertical sample coordinate cTop and a horizontal sample coordinate cLeft specifying the top-left sample location for the patch of samples included in the input tensor, is specified as follows.

```
for( i = 0; i < numInputPics; i++ ) {
if( nnpfc_inp_order_idc = = 0 )
  for( yP = −nnpfc_overlap; yP < inpPatchHeight + nnpfc_overlap; yP++)
    for( xP = −nnpfc_overlap; xP < inpPatchWidth + nnpfc_overlap; xP++ ) {
      inpVal = InpY( InpSampleVal( cTop + yP, cLeft + xP, CroppedHeight,
              CroppedWidth, CroppedYPic[ i ] ) )
      yPovlp = yP + nnpfc_overlap
      xPovlp = xP + nnpfc_overlap
      if( !nnpfc_component_last_flag )
        inputTensor[ 0 ][ i ][ 0 ][ yPovlp ][ xPovlp ] = inpVal
      else
        inputTensor[ 0 ][ i ][ yPovlp ][ xPovlp ][ 0 ] = inpVal
      if( nnpfc_auxiliary_inp_idc = = 1 )
        if( !nnpfc_component_last_flag )
        inputTensor[ 0 ][ i ][ 1 ][ yPovlp ][ xPovlp ] = strengthControlScaledVal
        else
        inputTensor[ 0 ][ i ][ yPovlp ][ xPovlp ][ 1 ] = strengthControlScaledVal
    }
else if( nnpfc_inp_order_idc = = 1 ) (84)
  for( yP = −nnpfc_overlap; yP < inpPatchHeight + nnpfc_overlap; yP++)
    for( xP = −nnpfc_overlap; xP < inpPatchWidth + nnpfc_overlap; xP++ ) {
      inpCbVal = InpC( InpSampleVal( cTop + yP, cLeft + xP, CroppedHeight /
SubHeightC,
          CroppedWidth / SubWidthC, CroppedCbPic[ i ] ) )
      inpCrVal = InpC( InpSampleVal( cTop + yP, cLeft + xP, CroppedHeight /
SubHeightC,
          CroppedWidth / SubWidthC, CroppedCrPic[ i ] ) )
      yPovlp = yP + nnpfc_overlap
      xPovlp = xP + nnpfc_overlap
      if( !nnpfc_component_last_flag ) {
        inputTensor[ 0 ][ i ][ 0 ][ yPovlp ][ xPovlp ] = inpCbVal
        inputTensor[ 0 ][ i ][ 1 ][ yPovlp ][ xPovlp ] = inpCrVal
      } else {
        inputTensor[ 0 ][ i ][ yPovlp ][ xPovlp ][ 0 ] = inpCbVal
        inputTensor[ 0 ][ i ][ yPovlp ][ xPovlp ][ 1 ] = inpCrVal
      }
      if( nnpfc_auxiliary_inp_idc = = 1 )
        if( !nnpfc_component_last_flag )
        inputTensor[ 0 ][ i ][ 2 ][ yPovlp ][ xPovlp ] = strengthControlScaledVal
        else
        inputTensor[ 0 ][ i ][ yPovlp ][ xPovlp ][ 2 ] = strengthControlScaledVal
    }
else if( nnpfc_inp_order_idc = = 2 )
  for( yP = −nnpfc_overlap; yP < inpPatchHeight + nnpfc_overlap; yP++)
    for( xP = −nnpfc_overlap; xP < inpPatchWidth + nnpfc_overlap; xP++ ) {
      yY = cTop + yP
      xY = cLeft + xP
      yC = yY / SubHeightC
      xC = xY / SubWidthC
      inpYVal = InpY( InpSampleVal( yY, xY, CroppedHeight,
              CroppedWidth, CroppedYPic[ i ] ) )
      inpCbVal = InpC( InpSampleVal( yC, xC, CroppedHeight / SubHeightC,
          CroppedWidth / SubWidthC, CroppedCbPic[ i ] ) )
      inpCrVal = InpC( InpSampleVal( yC, xC, CroppedHeight / SubHeightC,
          CroppedWidth / SubWidthC, CroppedCrPic[ i ] ) )
      yPovlp = yP + nnpfc_overlap
      xPovlp = xP + nnpfc_overlap
      if( !nnpfc_component_last_flag ) {
        inputTensor[ 0 ][ i ][ 0 ][ yPovlp ][ xPovlp ] = inpYVal
        inputTensor[ 0 ][ i ][ 1 ][ yPovlp ][ xPovlp ] = inpCbVal
        inputTensor[ 0 ][ i ][ 2 ][ yPovlp ][ xPovlp ] = inpCrVal
      } else {
        inputTensor[ 0 ][ i ][ yPovlp ][ xPovlp ][ 0 ] = inpYVal
        inputTensor[ 0 ][ i ][ yPovlp ][ xPovlp ][ 1 ] = inpCbVal
        inputTensor[ 0 ][ i ][ yPovlp ][ xPovlp ][ 2 ] = inpCrVal
      }
      if( nnpfc_auxiliary_inp_idc = = 1 )
        if( !nnpfc_component_last_flag )
        inputTensor[ 0 ][ i ][ 3 ][ yPovlp ][ xPovlp ] = strengthControlScaledVal
        else
        inputTensor[ 0 ][ i ][ yPovlp ][ xPovlp ][ 3 ] = strengthControlScaledVal
    }
else if( nnpfc_inp_order_idc = = 3 )
  for( yP = −nnpfc_overlap; yP < inpPatchHeight + nnpfc_overlap; yP++)
    for( xP = −nnpfc_overlap; xP < inpPatchWidth + nnpfc_overlap; xP++ ) {
      yTL = cTop + yP * 2
      xTL = cLeft + xP * 2
      yBR = yTL + 1
      xBR = xTL + 1
      yC = cTop / 2 + yP
      xC = cLeft / 2 + xP
      inpTLVal = InpY( InpSampleVal( yTL, xTL, CroppedHeight,
              CroppedWidth, CroppedYPic[ i ] ) )
      inpTRVal = InpY( InpSampleVal( yTL, xBR, CroppedHeight,
              CroppedWidth, CroppedYPic[ i ] ) )
      inpBLVal = InpY( InpSampleVal( yBR, xTL, CroppedHeight,
              CroppedWidth, CroppedYPic[ i ] ) )
      inpBRVal = InpY( InpSampleVal( yBR, xBR, CroppedHeight,
              CroppedWidth, CroppedYPic[ i ] ) )
      inpCbVal = InpC( InpSampleVal( yC, xC, CroppedHeight / 2,
            CroppedWidth / 2, CroppedCbPic[ i ] ) )
      inpCrVal = InpC( InpSampleVal( yC, xC, CroppedHeight / 2,
            CroppedWidth / 2, CroppedCrPic[ i ] ) )
      yPovlp = yP + nnpfc_overlap
      xPovlp = xP + nnpfc_overlap
      if( !nnpfc_component_last_flag ) {
        inputTensor[ 0 ][ i ][ 0 ][ yPovlp ][ xPovlp ] = inpTLVal
        inputTensor[ 0 ][ i ][ 1 ][ yPovlp ][ xPovlp ] = inpTRVal
        inputTensor[ 0 ][ i ][ 2 ][ yPovlp ][ xPovlp ] = inpBLVal
        inputTensor[ 0 ][ i ][ 3 ][ yPovlp ][ xPovlp ] = inpBRVal
        inputTensor[ 0 ][ i ][ 4 ][ yPovlp ][ xPovlp ] = inpCbVal
        inputTensor[ 0 ][ i ][ 5 ][ yPovlp ][ xPovlp ] = inpCrVal
      } else {
        inputTensor[ 0 ][ i ][ yPovlp ][ xPovlp ][ 0 ] = inpTLVal
        inputTensor[ 0 ][ i ][ yPovlp ][ xPovlp ][ 1 ] = inpTRVal
        inputTensor[ 0 ][ i ][ yPovlp ][ xPovlp ][ 2 ] = inpBLVal
        inputTensor[ 0 ][ i ][ yPovlp ][ xPovlp ][ 3 ] = inpBRVal
        inputTensor[ 0 ][ i ][ yPovlp ][ xPovlp ][ 4 ] = inpCbVal
        inputTensor[ 0 ][ i ][ yPovlp ][ xPovlp ][ 5 ] = inpCrVal
      }
      if( nnpfc_auxiliary_inp_idc = = 1 )
        if( !nnpfc_component_last_flag )
        inputTensor[ 0 ][ i ][ 6 ][ yPovlp ][ xPovlp ] = strengthControlScaledVal
        else
        inputTensor[ 0 ][ i ][ yPovlp ][ xPovlp ][ 6 ] = strengthControlScaledVal
    }
}
```

nnpfc_separate_colour_description_present_flag equal to 1 indicates that a distinct combination of colour primaries, transfer characteristics, and matrix coefficients for the picture resulting from the NNPF is specified in the SEI message syntax structure. nnpfc_separate_colour_description_present_flag equal to 0 indicates that the combination of colour primaries, transfer characteristics, and matrix coefficients for the picture resulting from the NNPF is the same as indicated in VUI parameters for the CLVS.

nnpfc_colour_primaries has the same semantics as specified in subclause 7.3 for the vui_colour_primaries syntax element, except as follows:
nnpfc_colour_primaries specifies the colour primaries of the picture resulting from applying the NNPF specified in the SEI message, rather than the colour primaries used for the CLVS.
When nnpfc_colour_primaries is not present in the NNPFC SEI message, the value of nnpfc_colour_primaries is inferred to be equal to vui_colour_primaries.

nnpfc_transfer_characteristics has the same semantics as specified in subclause 7.3 for the vui_transfer_characteristics syntax element, except as follows:
nnpfc_transfer_characteristics specifies the transfer characteristics of the picture resulting from applying the NNPF specified in the SEI message, rather than the transfer characteristics used for the CLVS.
When nnpfc_transfer_characteristics is not present in the NNPFC SEI message, the value of nnpfc_transfer_characteristics is inferred to be equal to vui_transfer_characteristics.

nnpfc_matrix_coeffs has the same semantics as specified in subclause 7.3 for the vui_matrix_coeffs syntax element, except as follows:
nnpfc_matrix_coeffs specifies the matrix coefficients of the picture resulting from applying the NNPF specified in the SEI message, rather than the matrix coefficients used for the CLVS.
When nnpfc_matrix_coeffs is not present in the NNPFC SEI message, the value of nnpfc_matrix_coeffs is inferred to be equal to vui_matrix_coeffs.
The values allowed for nnpfc_matrix_coeffs are not constrained by the chroma format of the decoded video pictures that is indicated by the value of ChromaFormatIdc for the semantics of the VUI parameters.
When nnpfc_matrix_coeffs is equal to 0, nnpfc_out_order_idc shall not be equal to 1 or 3.

nnpfc_out_format_idc equal to 0 indicates that the sample values output by the NNPF are real numbers where the value range of 0 to 1, inclusive, maps linearly to the unsigned integer value range of 0 to (1<<bitDepth)−1, inclusive, for any desired bit depth bitDepth for subsequent post-processing or displaying.

nnpfc_out_format_idc equal to 1 indicates that the luma sample values output by the NNPF are unsigned integer numbers in the range of 0 to (1<<(nnpfc_out_tensor_luma_bitdepth_minus8+8))−1, inclusive, and the chroma sample values output by the NNPF are unsigned integer numbers in the range of 0 to (1<<(nnpfc_out_tensor_chroma_bitdepth_minus8+8))−1, inclusive.

Values of nnpfc_out_format_idc greater than 1 are reserved for future specification by ITU-T|ISO/IEC and shall not be present in bitstreams conforming to this edition of this document. Decoders conforming to this edition of this document shall ignore NNPFC SEI messages that contain reserved values of nnpfc_out_format_idc.

nnpfc_out_tensor_luma_bitdepth_minus8 plus 8 specifies the bit depth of luma sample values in the output integer tensor. The value of nnpfc_out_tensor_luma_bitdepth_minus8 shall be in the range of 0 to 24, inclusive.

nnpfc_out_tensor_chroma_bitdepth_minus8 plus 8 specifies the bit depth of chroma sample values in the output integer tensor. The value of nnpfc_out_tensor_chroma_bitdepth_minus8 shall be in the range of 0 to 24, inclusive.

When nnpfc_purpose & 0x10 is not equal to 0, the value of nnpfc_out_format_idc shall be equal to 1 and at least one of the following conditions shall be true:
nnpfc_out_tensor_luma_bitdepth_minus8+8 is greater than BitDepth_{Y}.
nnpfc_out_tensor_chroma_bitdepth_minus8+8 is greater than BitDepth_{C}.

nnpfc_out_order_idc indicates the output order of samples resulting from the NNPF.

The value of nnpfc_out_order_idc shall be in the range of 0 to 3, inclusive, in bitstreams conforming to this edition of this document. Values of 4 to 255, inclusive, for nnpfc_out_order_idc are reserved for future use by ITU-T|ISO/IEC and shall not be present in bitstreams conforming to this edition of this document. Decoders conforming to this edition of this document shall ignore NNPFC SEI messages with nnpfc_out_order_idc in the range of 4 to 255, inclusive. Values of nnpfc_out_order_idc greater than 255 shall not be present in bitstreams conforming to this edition of this document and are not reserved for future use.

When nnpfc_purpose & 0x02 is not equal to 0, nnpfc_out_order_idc shall not be equal to 3.

Table 3 contains an informative description of nnpfc_out_order_idc values.

TABLE 3
Description of nnpfc_out_order_idc values

| nnpfc_out_{—} | |
|---|---|
| order_idc | Description |
| 0 | Only the luma matrix is present in the output tensor, thus the number of channels is 1. |
| 1 | Only the chroma matrices are present in the output tensor, thus the number of channels is 2. |
| 2 | The luma and chroma matrices are present in the output tensor, thus the number of channels is |
| | 3. |
| 3 | Four luma matrices and two chroma matrices are present in the output tensor, thus the number |
| | of channels is 6. This nnpfc_out_order_idc can only be used when the output chroma format |
| | is 4:2:0. |
| 4 . . . 255 | Reserved |

The process StoreOutputTensors( ) for deriving sample values in the filtered output sample arrays FilteredYPic, FilteredCbPic, and FilteredCrPic from the output tensor outputTensor for a given vertical sample coordinate cTop and a horizontal sample coordinate cLeft specifying the top-left sample location for the patch of samples included in the input tensor, is specified as follows.

```
for( i = 0; i < numOutputPics; i++ ) {
  if( nnpfc_out_order_idc = = 0 )
    for( yP = 0; yP < outPatchHeight; yP++)
      for( xP = 0; xP < outPatchWidth; xP++ ) {
        yY = cTop * outPatchHeight / inpPatchHeight + yP
        xY = cLeft * outPatchWidth / inpPatchWidth + xP
        if ( yY < nnpfc_pic_height_in_luma_samples && xY < nnpfc_pic_width_in_luma_samples )
          if( !nnpfc_component_last_flag )
            FilteredYPic[ i ][ xY ][yY ] = outputTensor[ 0 ][ i ][ 0 ][ yP ][ xP ]
          else
            FilteredYPic[ i ][ xY ][ yY ] = outputTensor[ 0 ][ i ][ yP ][ xP ][ 0 ]
      }
  else if( nnpfc_out_order_idc = = 1 ) (85)
    for( yP = 0; yP < outPatchCHeight; yP++)
      for( xP = 0; xP < outPatchCWidth; xP++ ) {
        xSrc = cLeft * horCScaling + xP
        ySrc = cTop * verCScaling + yP
        if ( ySrc < nnpfc_pic_height_in_luma_samples / outSubHeightC &&
            xSrc < nnpfc_pic_width_in_luma_samples / outSubWidthC )
          if( !nnpfc_component_last_flag ) {
            FilteredCbPic[ i ][ xSrc ][ ySrc ] = outputTensor[ 0 ][ i ][ 0 ][ yP ][ xP ]
            FilteredCrPic[ i ][ xSrc ][ ySrc ] = outputTensor[ 0 ][ i ][ 1 ][ yP ][ xP ]
          } else {
            FilteredCbPic[ i ][ xSrc ][ ySrc ] = outputTensor[ 0 ][ i ][ yP ][ xP ][ 0 ]
            FilteredCrPic[ i ][ xSrc ][ ySrc ] = outputTensor[ 0 ][ i ][ yP ][ xP ][ 1 ]
          }
      }
  else if( nnpfc_out_order_idc = = 2 )
    for( yP = 0; yP < outPatchHeight; yP++)
      for( xP = 0; xP < outPatchWidth; xP++ ) {
        yY = cTop * outPatchHeight / inpPatchHeight + yP
        xY = cLeft * outPatchWidth / inpPatchWidth + xP
        yC = yY / outSubHeightC
        xC = xY / outSubWidthC
        yPc = ( yP / outSubHeightC ) * outSubHeightC
        xPc = ( xP / outSubWidthC ) * outSubWidthC
          if ( yY < nnpfc_pic_height_in_luma_samples && xY < nnpfc_pic_width_in_luma_samples)
            if( !nnpfc_component_last_flag ) {
            FilteredYPic[ i ][ xY ][ yY ] = outputTensor[ 0 ][ i ][ 0 ][ yP ][ xP ]
            FilteredCbPic[ i ][ xC ][ yC ] = outputTensor[ 0 ][ i ][ 1 ][ yPc ][ xPc ]
            FilteredCrPic[ i ][ xC ][ yC ] = outputTensor[ 0 ][ i ][ 2 ][ yPc ][ xPc ]
          } else {
            FilteredYPic[ i ][ xY ][ yY ] = outputTensor[ 0 ][ i ][ yP ][ xP ][ 0 ]
            FilteredCbPic[ i ][ xC ][ yC ] = outputTensor[ 0 ][ i ][ yPc ][ xPc ][ 1 ]
            FilteredCrPic[ i ][ xC ][ yC ] = outputTensor[ 0 ][ i ][ yPc ][ xPc ][ 2 ]
          }
      }
  else if( nnpfc_out_order_idc = = 3 )
    for( yP = 0; yP < outPatchHeight; yP++ )
      for( xP = 0; xP < outPatchWidth; xP++ ) {
        ySrc = cTop / 2 * outPatchHeight / inpPatchHeight + yP
        xSrc = cLeft / 2 * outPatchWidth / inpPatchWidth + xP
        if ( ySrc < nnpfc_pic_height_in_luma_samples / 2 &&
            xSrc < nnpfc_pic_width_in_luma_samples / 2 )
          if( !nnpfc_component_last_flag ) {
            FilteredYPic[ i ][ xSrc * 2 ][ ySrc * 2 ] = outputTensor[ 0 ][ i ][ 0 ][ yP ][ xP ]
            FilteredYPic[ i ][ xSrc * 2 + 1 ][ ySrc * 2 ] = outputTensor[ 0 ][ i ][ 1 ][ yP ][ xP ]
            FilteredYPic[ i ][ xSrc * 2 ][ ySrc * 2 + 1 ] = outputTensor[ 0 ][ i ][ 2 ][ yP ][ xP ]
            FilteredYPic[ i ][ xSrc * 2 + 1][ ySrc * 2 + 1 ] = outputTensor[ 0 ][ i ][ 3 ][ yP ][ xP ]
            FilteredCbPic[ i ][ xSrc ][ ySrc ] = outputTensor[ 0 ][ i ][ 4 ][ yP ][ xP ]
            FilteredCrPic[ i ][ xSrc ][ ySrc ] = outputTensor[ 0 ][ i ][ 5 ][ yP ][ xP ]
          } else {
            FilteredYPic[ i ][ xSrc * 2 ][ ySrc * 2 ] = outputTensor[ 0 ][ i ][ yP ][ xP ][ 0 ]
            FilteredYPic[ i ][ xSrc * 2 + 1 ][ ySrc * 2 ] = outputTensor[ 0 ][ i ][ yP ][ xP ][ 1 ]
            FilteredYPic[ i ][ xSrc * 2 ][ ySrc * 2 + 1 ] = outputTensor[ 0 ][ i ][ yP ][ xP ][ 2 ]
            FilteredYPic[ i ][ xSrc * 2 + 1][ ySrc * 2 + 1 ] = outputTensor[ 0 ][ i ][ yP ][ xP ][ 3 ]
            FilteredCbPic[ i ][ xSrc ][ ySrc ] = outputTensor[ 0 ][ i ][ yP ][ xP ][ 4 ]
            FilteredCrPic[ i ][ xSrc ][ ySrc ] = outputTensor[ 0 ][ i ][ yP ][ xP ][ 5 ]
          }
      }
}
```

nnpfc_overlap indicates the overlapping horizontal and vertical sample counts of adjacent input tensors of the NNPF. The value of nnpfc_overlap shall be in the range of 0 to 16 383, inclusive.

nnpfc_constant_patch_size_flag equal to 1 indicates that the NNPF accepts exactly the patch size indicated by nnpfc_patch_width_minus1 and nnpfc_patch_height_minus1 input. nnpfc_constant_patch_size_flag equal to 0 indicates that the NNPF accepts as input any patch size with width inpPatchWidth and height inpPatchHeight such that the width of an extended patch (i.e., a patch plus the overlapping area), which is equal to inpPatchWidth+2*nnpfc_overlap, is a positive integer multiple of nnpfc_extended_patch_width_cd_delta_minus1+1+2*nnpfc_overlap, and the height of the extended patch, which is equal to inpPatchHeight+2*nnpfc_overlap, is a positive integer multiple of nnpfc_extended_patch_height_cd_delta_minus1+1+2*nnpfc_overlap.

nnpfc_patch_width_minus1 plus 1, when nnpfc_constant_patch_size_flag equal to 1, indicates the horizontal sample counts of the patch size required for the input to the NNPF. The value of nnpfc_patch_width_minus1 shall be in the range of 0 to Min (32 766, CroppedWidth−1), inclusive.

nnpfc_patch_height_minus1 plus 1, when nnpfc_constant_patch_size_flag equal to 1, indicates the vertical sample counts of the patch size required for the input to the NNPF. The value of nnpfc_patch_height_minus1 shall be in the range of 0 to Min (32 766, CroppedHeight−1), inclusive.

nnpfc_extended_patch_width_cd_delta_minus1 plus 1 plus 2*nnpfc_overlap, when nnpfc_constant_patch_size_flag equal to 0, indicates a common divisor of all allowed values of the width of an extended patch required for the input to the NNPF. The value of nnpfc_extended_patch_width_cd_delta_minus1 shall be in the range of 0 to Min (32 766, CroppedWidth−1), inclusive.

nnpfc_extended_patch_height_cd_delta_minus1 plus 1 plus 2*nnpfc_overlap, when nnpfc_constant_patch_size_flag equal to 0, indicates a common divisor of all allowed values of the height of an extended patch required for the input to the NNPF. The value of nnpfc_extended_patch_height_cd_delta_minus1 shall be in the range of 0 to Min (32 766, CroppedHeight−1), inclusive.

Let the variables inpPatchWidth and inpPatchHeight be the patch size width and the patch size height, respectively.

If nnpfc_constant_patch_size_flag is equal to 0, the following applies:
The values of inpPatchWidth and inpPatchHeight are either provided by external means not specified in this document or set by the post-processor itself.
The value of inpPatchWidth+2*nnpfc_overlap shall be a positive integer multiple of nnpfc_extended_patch_width_cd_delta_minus1+1+2*nnpfc_overlap and inpPatchWidth shall be less than or equal to CroppedWidth. The value of inpPatchHeight+2*nnpfc_overlap shall be a positive integer multiple of nnpfc_extended_patch_height_cd_delta_minus1+1+2*nnpfc_overlap and inpPatchHeight shall be less than or equal to CroppedHeight.

Otherwise (nnpfc_constant_patch_size_flag is equal to 1), the value of inpPatchWidth is set equal to nnpfc_patch_width_minus1+1 and the value of inpPatchHeight is set equal to nnpfc_patch_height_minus1+1.

The variables outPatchWidth, outPatchHeight, horCScaling, verCScaling, outPatchCWidth, and outPatchCHeight are derived as follows.

$$outPatchWidth = ( nnpfc\_pic \_width \_in \_luma \_samples * inpPatchWidth ) / CroppedWith \qquad ( 86 )$$

$$outPatchHeight = ( nnpfc\_pic \_height \_in \_luma \_samples * inpPatchHeight ) / CroppedHeight \qquad ( 87 )$$

$$horCScaling = SubWidthC / outSubWidthC \qquad ( 88 )$$

$$verCScaling = SubHeightC / outSubHeightC \qquad ( 89 )$$

$$outPatchCWidth = outPatchWidth * horCScaling \qquad ( 90 )$$

$$outPatchCHeight = outPatchHeight * verCScaling \qquad ( 91 )$$

It is a requirement of bitstream conformance that outPatchWidth*CroppedWidth shall be equal to nnpfc_pic_width_in_luma_samples*inpPatchWidth and outPatchHeight*CroppedHeight shall be equal to nnpfc_pic_height_in_luma_samples*inpPatchHeight.

nnpfc_padding_type indicates the process of padding when referencing sample locations outside the boundaries of the cropped decoded output picture as described in Table 4. The value of nnpfc_padding_type shall be in the range of 0 to 15, inclusive.

TABLE 4
Informative description of nnpfc_padding_type values

| nnpfc_padding_type | Description |
|---|---|
| 0 | zero padding |
| 1 | replication padding |
| 2 | reflection padding |
| 3 | wrap-around padding |
| 4 | fixed padding |
| 5 . . . 15 | Reserved |

nnpfc_luma_padding_val indicates the luma value to be used for padding when nnpfc_padding_type is equal to 4.

nnpfc_cb_padding_val indicates the Cb value to be used for padding when nnpfc_padding_type is equal to 4.

nnpfc_cr_padding_val indicates the Cr value to be used for padding when nnpfc_padding_type is equal to 4.

The function InpSampleVal(y, x, picHeight, picWidth, croppedPic) with inputs being a vertical sample location y, a horizontal sample location x, a picture height picHeight, a picture width picWidth, and sample array croppedPic returns the value of sample Val derived as follows.

NOTE 6—For the inputs to the function InpSampleVal ( ) the vertical location is listed before the horizontal location for compatibility with input tensor conventions of some inference engines.

```
if( nnpfc_padding_type = = 0 )
  if( y < 0 || x < 0 || y >= picHeight || x >= picWidth )
    sampleVal = 0
  else
    sampleVal = croppedPic[ x ][ y ] (92)
else if( nnpfc_padding_type = = 1 )
  sampleVal = croppedPic[ Clip3( 0, picWidth − 1, x ) ][ Clip3( 0,
  picHeight − 1, y ) ]
else if( nnpfc_padding_type = = 2 )
  sampleVal = croppedPic[ Reflect( picWidth − 1, x ) ][ Reflect(
  picHeight − 1, y ) ]
else if( nnpfc_padding_type = = 3 )
  if( y >= 0 && y < picHeight )
    sampleVal = croppedPic[ Wrap( picWidth − 1, x ) ][ y ]
else if( nnpfc_padding_type = = 4 )
  if( y < 0 || x < 0 | y >= picHeight || x >= picWidth )
    sampleVal[ 0 ] = nnpfc_luma_padding_val
    sampleVal[ 1 ] = nnpfc_cb_padding_val
    sampleVal[ 2 ] = nnpfc_cr_padding_val
  else
    sampleVal = croppedPic[ x ][ y ]
```

The following example process may be used, with the NNPF PostProcessingFilter( ) to generate, in a patch-wise manner, the filtered and/or interpolated picture(s), which contain Y, Cb, and Cr sample arrays FilteredYPic, FilteredCbPic, and FilteredCrPic, respectively, as indicated by nnpfc_out_order_idc.

```
if( nnpfc_inp_order_idc = = 0 || nnpfc_inp_order_idc = = 2 )
  for( cTop = 0; cTop < CroppedHeight; cTop += inpPatchHeight )
    for( cLeft = 0; cLeft < CroppedWidth; cLeft += inpPatchWidth ) {
      DeriveInputTensors( )
      outputTensor = PostProcessingFilter( inputTensor )
      StoreOutputTensors( )
    }
else if( nnpfc_inp_order_idc = = 1 )
  for( cTop = 0; cTop < CroppedHeight / SubHeightC; cTop += inpPatchHeight )
    for( cLeft = 0; cLeft < CroppedWidth / SubWidthC; cLeft += inpPatchWidth ) {
                                                                      (93)
      DeriveInputTensors( )
      outputTensor = PostProcessingFilter( inputTensor )
      StoreOutputTensors( )
    }
else if( nnpfc_inp_order_idc = = 3 )
  for( cTop = 0; cTop < CroppedHeight; cTop += inpPatchHeight * 2 )
    for( cLeft = 0; cLeft < CroppedWidth; cLeft += inpPatchWidth * 2 ) {
      DeriveInputTensors( )
      outputTensor = PostProcessingFilter( inputTensor )
      StoreOutputTensors( )
    }
```

The order of the pictures in the stored output tensor is in output order, and the output order generated by applying the NNPF in output order is interpreted to be in output order (and not conflicting with the output order of the input pictures).

nnpfc_complexity_info_present_flag equal to 1 specifies that one or more syntax elements that indicate the complexity the NNPF associated with the nnpfc_id are present. nnpfc_complexity_info_present_flag equal to 0 specifies that no syntax elements that indicates the complexity of the NNPF associated with the nnpfc_id are present.

nnpfc_parameter_type_idc equal to 0 indicates that the neural network uses only integer parameters. nnpfc_parameter_type_flag equal to 1 indicates that the neural network may use floating point or integer parameters. nnpfc_parameter_type_idc equal to 2 indicates that the neural network uses only binary parameters. nnpfc_parameter_type_idc equal to 3 is reserved for future use by ITU-T|ISO/IEC and shall not be present in bitstreams conforming to this edition of this document. Decoders conforming to this edition of this document shall ignore NNPFC SEI messages with nnpfc_parameter_type_idc equal to 3.

nnpfc_log 2_parameter_bit_length_minus3 equal to 0, 1, 2, and 3 indicates that the neural network does not use parameters of bit length greater than 8, 16, 32, and 64, respectively. When nnpfc_parameter_type_idc is present and nnpfc_log 2_parameter_bit_length_minus3 is not present the neural network does not use parameters of bit length greater than 1.

nnpfc_num_parameters_idc indicates the maximum number of neural network parameters for the NNPF in units of a power of 2 048. nnpfc_num_parameters_idc equal to 0 indicates that the maximum number of neural network parameters is unknown. The value nnpfc_num_parameters_idc shall be in the range of 0 to 52, inclusive. Values of nnpfc_num_parameters_idc greater than 52 are reserved for future use by ITU-T|ISO/IEC and shall not be present in bitstreams conforming to this edition of this document. Decoders conforming to this edition of this document shall ignore NNPFC SEI messages with nnpfc_num_parameters_idc greater than 52.

If the value of nnpfc_num_parameters_idc is greater than zero, the variable maxNumParameters is derived as follows.

$$max NumParameters = ( 2048 ≪ nnpfc\_num \_parameters \_idc ) - 1 \qquad ( 94 )$$

It is a requirement of bitstream conformance that the number of neural network parameters of the NNPF shall be less than or equal to maxNumParameters.

nnpfc_num_kmac_operations_idc greater than 0 indicates that the maximum number of multiply-accumulate operations per sample of the NNPF is less than or equal to nnpfc_num_kmac_operations_idc*1 000. nnpfc_num_kmac_operations_idc equal to 0 indicates that the maximum number of multiply-accumulate operations of the network is unknown. The value of nnpfc_num_kmac_operations_idc shall be in the range of 0 to 232-2, inclusive.

nnpfc_total_kilobyte_size greater than 0 indicates a total size in kilobytes required to store the uncompressed parameters for the neural network. The total size in bits is a number equal to or greater than the sum of bits used to store each parameter. nnpfc_total_kilobyte_size is the total size in bits divided by 8 000, rounded up. nnpfc_total_kilobyte_size equal to 0 indicates that the total size required to store the parameters for the neural network is unknown. The value of nnpfc_total_kilobyte_size shall be in the range of 0 to 232-2, inclusive.

nnpfc_reserved_zero_bit_b shall be equal to 0 in bitstreams conforming to this edition of this document. Decoders shall ignore NNPFC SEI messages in which nnpfc_reserved_zero_bit_b is not equal to 0.

nnpfc_payload_byte[i] contains the i-th byte of a bitstream conforming to ISO/IEC 15938-17. The byte sequence nnpfc_payload_byte[i] for all present values of i shall be a complete bitstream that conforms to ISO/IEC 15938-17.

### 8.29 Neural-Network Post-Filter Activation SEI Message

### 8.29.1 Neural-Network Post-Filter Activation SEI Message Syntax

| | Descriptor |
|---|---|
| nn_post_filter_activation( payloadSize ) { | |
| nnpfa_{—}target_{—}id | ue(v) |
| nnpfa_{—}cancel_{—}flag | u(1) |
| if( !nnpfa_cancel_flag ) | |
| nnpfa_{—}persistence_{—}flag | u(1) |
| } | |

### 8.29.2 Neural-Network Post-Filter Activation SEI Message Semantics

The neural-network post-filter activation (NNPFA) SEI message activates or de-activates the possible use of the target neural-network post-processing filter (NNPF), identified by nnpfa_target_id, for post-processing filtering of a set of pictures. For a particular picture for which the NNPF is activated, the target NNPF is the NNPF specified by the last NNPFC SEI message with nnpfc_id equal to nnpfa_target_id, that precedes the first VCL NAL unit of the current picture in decoding order that is not a repetition of the NNPFC SEI message that contains the base NNPF.

NOTE 1—There can be several NNPFA SEI messages present for the same picture, for example, when the NNPFs are meant for different purposes or for filtering of different colour components.

nnpfa_target_id indicates the target NNPF, which is specified by one or more NNPFC SEI messages that pertain to the current picture and have nnpfc_id equal to nnpfa_target_id.

The value of nnpfa_target_id shall be in the range of 0 to 232-2, inclusive. Values of nnpfa_target_id from 256 to 511, inclusive, and from 231 to 232-2, inclusive, are reserved for future use by ITU-T|ISO/IEC. Decoders conforming to this edition of this document encountering an NNPFA SEI message with nnpfa_target_id in the range of 256 to 511, inclusive, or in the range of 231 to 232-2, inclusive, shall ignore the SEI message.

An NNPFA SEI message with a particular value of nnpfa_target_id shall not be present in a current PU unless one or both of the following conditions are true:
Within the current CLVS there is an NNPFC SEI message with nnpfc_id equal to the particular value of nnpfa_target_id present in a PU preceding the current PU in decoding order.
There is an NNPFC SEI message with nnpfc_id equal to the particular value of nnpfa_target_id in the current PU.

When a PU contains both an NNPFC SEI message with a particular value of nnpfc_id and an NNPFA SEI message with nnpfa_target_id equal to the particular value of nnpfc_id, the NNPFC SEI message shall precede the NNPFA SEI message in decoding order.

nnpfa_cancel_flag equal to 1 indicates that the persistence of the target NNPF established by any previous NNPFA SEI message with the same nnpfa_target_id as the current SEI message is cancelled, i.e., the target NNPF is no longer used unless it is activated by another NNPFA SEI message with the same nnpfa_target_id as the current SEI message and nnpfa_cancel_flag equal to 0. nnpfa_cancel_flag equal to 0 indicates that the nnpfa_persistence_flag follows.

nnpfa_persistence_flag specifies the persistence of the target NNPF for the current layer.

nnpfa_persistence_flag equal to 0 specifies that the target NNPF may be used for post-processing filtering for the current picture only.

nnpfa_persistence_flag equal to 1 specifies that the target NNPF may be used for post-processing filtering for the current picture and all subsequent pictures of the current layer in output order until one or more of the following conditions are true:
A new CLVS of the current layer begins.
The bitstream ends.
A picture in the current layer associated with a NNPFA SEI message with the same nnpfa_target_id as the current SEI message and nnpfa_cancel_flag equal to 1 is output that follows the current picture in output order.

NOTE 2—The target NNPF is not applied for this subsequent picture in the current layer associated with a NNPFA SEI message with the same nnpfa_target_id as the current SEI message and nnpfa_cancel_flag equal to 1.

Let the nnpfcTargetPictures be the set of pictures to which the last NNPFC SEI message with nnpfc_id equal to nnpfa_target_id that precedes the current NNPFA SEI message in decoding order pertains. Let nnpfaTargetPictures be the set of pictures for which the target NNPF is activated by the current NNPFA SEI message. It is a requirement of bitstream conformance that any picture included in nnpfaTargetPictures shall also be included in nnpfcTargetPictures.

### 4. Technical Problems Solved by Disclosed Technical Solutions

An example design for the neural-network post-filter characteristics (NNPFC) SEI message has the following problems:

First, depth picture generation is an important task of computer vision, which can be used in a variety of applications, such as three-dimensional (3D) scene modeling and virtual reality (VR). The depth pictures can be generated from decoded output texture pictures by an NNPF. However, an example NNPFC SEI message does not explicitly support an NNPF purpose with depth picture generation.

Second, depth pictures can be used as extra NNPF inputs to assistant other NNPFC purposes, such as picture rate upsampling, general visual quality improvement, and colourization. In addition, the depth picture generation task could also get benefits from the extra depth pictures input. However, it does not support using depth pictures as extra NNPF inputs in an example NNPFC SEI message.

### 5. A Listing of Solutions and Embodiments

To solve the above-described problems, methods as summarized below are disclosed. The aspects should be considered as examples to explain the general concepts and should not be interpreted in a narrow way. Furthermore, these examples can be applied individually or combined in any manner.

1) To solve problem 1, a new NNPF purpose is defined for depth picture generation.
a. In one example, the NNPF purpose is for depth picture generation only.
b. In one example, the depth picture generation may be combined with other NNPF purposes.
   i. In one example, the NNPF purpose includes depth picture generation as well as some types of upsampling such as picture rate upsampling, general visual quality improvement, and colourization.
      1. In one example, the bit masking method may be used to combine depth picture generation with some types of upsampling.
c. In one example, furthermore, the bit depth of the depth sample values in the output integer tensor may be determined, specified, or signalled.
   i. In one example, a syntax element is signalled to specify the bit depth of the depth sample values in the output integer tensor.
   ii. In one example, the bit depth of the depth sample values in the output integer tensor may be pre-defined.
      1. In one example, the bit depth of the generated depth pictures is defined to be the same as the bit depth of the luma sample values in the output integer tensor.
      2. In one example, the bit depth of the generated depth pictures is defined to be the same as the bit depth of the chroma sample values in the output integer tensor.
d. In one example, furthermore, one or both of the width and height of the depth sample array in the output tensor may be determined, specified, or signalled.
   i. In one example, it is specified that one or both of the width and height of the depth sample array in the output tensor are the same as that of the luma sample array in the output tensor, respectively.
   ii. In one example, one or both of the width and height of the depth sample array in the output tensor are explicitly signalled.
   iii. In one example, the width or the height may be explicitly signalled and the other may be derived given the constraint that the aspect ratio of the depth picture is the same as the cropped decoded output picture.
2) To solve problem 2, one or more of the following syntax elements may be defined:
   a. In one example, the depth pictures are used as input to the NNPF to assist the following tasks: general visual quality improvements, chroma upsampling, resolution upsampling, picture rate upsampling, bit depth upsampling, depth picture generation, or any combination of above tasks.
   b. In one example, an indication is signalled to indicate whether depth pictures associated with the cropped decoded output picture are used as input to the NNPF.
      i. In one example, furthermore, when depth pictures associated with the cropped decoded output picture are used as input to the NNPF, the bit depth of the depth sample values in the input integer tensor may be determined, specified, or signalled.
         1. In one example, furthermore, the bit depth of the depth sample values in the input integer tensor minus 8 is signalled.
         2. In one example, furthermore, the bit depth of the depth sample values in the input integer tensor may be pre-defined.
         a. In one example, the bit depth of the depth sample values in the input integer tensor is defined to be the same as the bit depth of the luma sample values in the input integer tensor.
         b. In one example, the bit depth of the depth sample values in the input integer tensor is defined to be the same as the bit depth of the chroma sample values in the input integer tensor.
      ii. In one example, furthermore, when depth pictures associated with the cropped decoded output picture are used as input to the NNPF, the depth values to be used for padding the input depth pictures may be signalled when the type of padding is fixed padding.
         1. In one example, the depth values used for padding is in the range of 0 to 2^{input_bitdepth_of_depth_picture}−1, inclusive.
   c. In one example, the depth pictures may be specified as auxiliary input data.
      i. In one example, the depth pictures may be accessed in a sample-wise manner.
      ii. In one example, the depth pictures may be passed from the decoder via the depth layer, e.g. AuxId euqal to AUX_DEPTH.
3) Above bullets and sub-bullets may be applied to alpha channel pictures, disparity pictures and/or geometry pictures.

### 6. Embodiments

Below are some example embodiments for the aspects summarized above in Section 5.

Most relevant parts that have been added or modified are in bold, and some of the deleted parts are in bold and italic fonts. There may be some other changes that are editorial in nature and thus not indicated.

### 6.1 Embodiment 1

This embodiment is for items 1 and all their subitems as summarized above in Section 5.

### 8.28.1 Neural-Network Post-Filter Characteristics SEI Message Syntax

| | Descriptor |
|---|---|
| nn_post_filter_characteristics( payloadSize ) { | |
| ... | |
| nnpfc_out_format_idc | ue(v) |
| if( nnpfc_out_format_idc = = 1 ) { | |
| nnpfc_out_tensor_luma_bitdepth_minus8 | ue(v) |
| nnpfc_out_tensor_chroma_bitdepth_minus8 | ue(v) |
| if( ( nnpfc_{—}purpose & 0x40 ) != 0 ) | |
| nnpfc_{—}out_{—}tensor_{—}depth_{—}bitdepth_{—}minus8 | ue(v) |
| } | |
| nnpfc_out_order_idc | ue(v) |
| ... | |
| } | |

### 8.28.2 Neural-Network Post-Filter Characteristics SEI Message Semantics

nnpfc_purpose indicates the purpose of the NNPF as specified in Table 5.

The value of nnpfc_purpose shall be in the range of 0 to 63 127, inclusive, in bitstreams conforming to this edition of this document. Values of 64 128 to 65 535, inclusive, for nnpfc_purpose are reserved for future use by ITU-T|ISO/IEC and shall not be present in bitstreams conforming to this edition of this document. Decoders conforming to this edition of this document shall ignore NNPFC SEI messages with nnpfc_purpose in the range of 64 128 to 65 535, inclusive.

TABLE 5
Definition of nnpfc_purpose

| Value | Interpretation |
|---|---|
| nnpfc_purpose = = 0 | May be used as determined by the application |
| nnpfc_purpose > 0 && | No general visual quality improvement |
| ( nnpfc_purpose & | |
| 0x01 ) = = 0 | |
| ( nnpfc_purpose & | With general visual quality improvement |
| 0x01 ) != 0 | |
| nnpfc_purpose > 0 && | No chroma upsampling (from the 4:2:0 chroma format to the 4:2:2 or 4:4:4 |
| ( nnpfc_purpose & | chroma format, or from the 4:2:2 chroma format to the 4:4:4 chroma format) |
| 0x02 ) = = 0 | |
| ( nnpfc_purpose & | With chroma upsampling |
| 0x02 ) != 0 | |
| nnpfc_purpose > 0 && | No resolution upsampling (increasing the width or height) |
| ( nnpfc_purpose & | |
| 0x04 ) = = 0 | |
| ( nnpfc_purpose & | With resolution upsampling |
| 0x04 ) != 0 | |
| nnpfc_purpose > 0 && | No picture rate upsampling |
| ( nnpfc_purpose & | |
| 0x08 ) = = 0 | |
| ( nnpfc_purpose & | With picture rate upsampling |
| 0x08 ) != 0 | |
| nnpfc_purpose > 0 && | No bit depth upsampling (increasing the luma bit depth or the chroma bit |
| ( nnpfc_purpose & | depth) |
| 0x10 ) = = 0 | |
| ( nnpfc_purpose & | With bit depth upsampling |
| 0x10 ) != 0 | |
| nnpfc_purpose > 0 && | No colourization (from the 4:0:0 chroma format to the 4:2:0, 4:2:2, or 4:4:4 |
| ( nnpfc_purpose & | chroma format) |
| 0x20 ) = = 0 | |
| ( nnpfc_purpose & | With colourization |
| 0x20 ) != 0 | |
| nnpfc_purpose > 0 && | No depth picture generation |
| ( nnpfc_purpose & | |
| 0x40 ) = = 0 | |
| ( nnpfc_purpose & | With depth picture generation |
| 0x40 ) != 0 | |

NOTE 2—When a reserved value of nnpfc_purpose is taken into use in the future by ITU-T|ISO/IEC, the syntax of this SEI message could be extended with syntax elements whose presence is conditioned by nnpfc_purpose being equal to that value.

When ChromaFormatIdc is equal to 3, nnpfc_purpose & 0x02 shall be equal to 0.

When ChromaFormatIdc or nnpfc_purpose & 0x02 is not equal to 0, nnpfc_purpose & 0x20 shall be equal to 0.

nnpfc_pic_width_in_luma_samples and nnpfc_pic_height_in_luma_samples specify the width and height, respectively, of the luma sample array of the picture resulting from applying the NNPF identified by nnpfc_id to a cropped decoded output picture. When nnpfc_pic_width_in_luma_samples and nnpfc_pic_height_in_luma_samples are not present, they are inferred to be equal to CroppedWidth and CroppedHeight, respectively. The value of nnpfc_pic_width_in_luma_samples shall be in the range of CroppedWidth to CroppedWidth*16-1, inclusive. The value of nnpfc_pic_height_in_luma_samples shall be in the range of CroppedHeight to CroppedHeight*16-1, inclusive.

When nnpfc_purpose & 0x40 is not equal to 0, nnpfc_pic_width_in_luma_samples and nnpfc_pic_height_in_luma_samples also specify the width and height, respectively, of the depth sample array of the picture resulting from applying the NNPF identified by nnpfc_id to a cropped decoded output depth picture.

nnpfc_out_format_idc equal to 0 indicates that the sample values output by the NNPF are real numbers where the value range of 0 to 1, inclusive, maps linearly to the unsigned integer value range of 0 to (1<<bitDepth)−1, inclusive, for any desired bit depth bitDepth for subsequent post-processing or displaying. nnpfc_out_format_idc equal to 1 indicates that the luma sample values output by the NNPF are unsigned integer numbers in the range of 0 to (1<<(nnpfc_out_tensor_luma_bitdepth_minus8+8))−1, inclusive, and the chroma sample values output by the NNPF are unsigned integer numbers in the range of 0 to (1<<(nnpfc_out_tensor_chroma_bitdepth_minus8+8))−1, inclusive, and when nnpfc_purpose & 0x40 is not equal to 0, the depth sample values output by the NNPF are unsigned integer numbers in the range of 0 to (1<<(nnpfc_out_tensor_depth_bitdepth_minus8+8))−1, inclusive.

Values of nnpfc_out_format_idc greater than 1 are reserved for future specification by ITU-T|ISO/IEC and shall not be present in bitstreams conforming to this edition of this document. Decoders conforming to this edition of this document shall ignore NNPFC SEI messages that contain reserved values of nnpfc_out_format_idc. nnpfc_out_tensor_luma_bitdepth_minus8 plus 8 specifies the bit depth of luma sample values in the output integer tensor. The value of nnpfc_out_tensor_luma_bitdepth_minus8 shall be in the range of 0 to 24, inclusive. nnpfc_out_tensor_chroma_bitdepth_minus8 plus 8 specifies the bit depth of chroma sample values in the output integer tensor. The value of nnpfc_out_tensor_chroma_bitdepth_minus8 shall be in the range of 0 to 24, inclusive.

When nnpfc_purpose & 0x10 is not equal to 0, the value of nnpfc_out_format_idc shall be equal to 1 and at least one of the following conditions shall be true:
nnpfc_out_tensor_luma_bitdepth_minus8+8 is greater than BitDepth_{Y}.
nnpfc_out_tensor_chroma_bitdepth_minus8+8 is greater than BitDepth_{C}.

nnpfc_out_tensor_depth_bitdepth_minus8 plus 8 specifies the bit depth of depth sample values in the output integer tensor. The value of nnpfc_out_tensor_depth_bitdepth_minus8 shall be in the range of 0 to 24, inclusive.

nnpfc_out_order_idc indicates the output order of samples resulting from the NNPF.

The value of nnpfc_out_order_idc shall be in the range of 0 to 3 4, inclusive, in bitstreams conforming to this edition of this document. Values of 4 5 to 255, inclusive, for nnpfc_out_order_idc are reserved for future use by ITU-T|ISO/IEC and shall not be present in bitstreams conforming to this edition of this document. Decoders conforming to this edition of this document shall ignore NNPFC SEI messages with nnpfc_out_order_idc in the range of 4 5 to 255, inclusive. Values of nnpfc_out_order_idc greater than 255 shall not be present in bitstreams conforming to this edition of this document and are not reserved for future use.

When nnpfc_purpose & 0x02 is not equal to 0, nnpfc_out_order_idc shall not be equal to 3.

Table 6 contains an informative description of nnpfc_out_order_idc values.

TABLE 6
Description of nnpfc_out_order_idc values

| nnpfc_out_{—} | |
|---|---|
| order_idc | Description |
| 0 | If nnpfc_purpose & 0x40 is equal to 0, only the luma matrix is present in the output tensor, |
| | thus the number of channels is 1. Otherwise (nnpfc_purpose & 0x40 is not equal to 0), the |
| | luma and depth matrices are present in the output tensor, thus the number of channels |
| | is 2. |
| 1 | If nnpfc_purpose & 0x40 is equal to 0, only the chroma matrices are present in the output |
| | tensor, thus the number of channels is 2. Otherwise (nnpfc_purpose & 0x40 is not equal to |
| | 0), the chroma and depth matrices are present in the output tensor, thus the number of |
| | channels is 3. |
| 2 | If nnpfc_purpose & 0x40 is equal to 0, the luma and chroma matrices are present in the |
| | output tensor, thus the number of channels is 3. Otherwise (nnpfc_purpose & 0x40 is not |
| | equal to 0), the luma, chroma, and depth matrices are present in the output tensor, thus |
| | the number of channels is 4. |
| 3 | If nnpfc_purpose & 0x40 is equal to 0, four luma matrices and two chroma matrices are |
| | present in the output tensor, thus the number of channels is 6. Otherwise (nnpfc_purpose & |
| | 0x40 is not equal to 0), four luma matrices and two chroma matrices and four depth |
| | matrices are present in the output tensor, thus the number of channels is 10. |
| | nnpfc_out_order_idc equal to 3 can only be used when the output chroma format is 4:2:0. |
| 4 | Only the depth matrix is present in the output tensor, thus the number of channels is 1. |
| | nnpfc_out_order_idc equal to 4 can only be used when nnpfc_purpose & 0x40 is not |
| | equal to 0. |
| 4 5 . . . 255 | Reserved |

The process StoreOutputTensors ( ) for deriving sample values in the filtered output sample arrays FilteredYPic. FilteredCbPic. and FilteredCrPic from the output tensor outputTensor for a given vertical sample coordinate cTop and a horizontal sample coordinate cLeft specifying the top-left sample location for the patch of samples included in the input tensor, is specified as follows:

```
  for( i = 0; i < numOutputPics; i++ ) {
    if( nnpfc_out_order_idc = = 0 )
      for( yP = 0; yP < outPatchHeight; yP++)
        for( xP = 0; xP < outPatchWidth; xP++ ) {
          yY = cTop * outPatchHeight / inpPatchHeight + yP
          xY = cLeft * outPatchWidth / inpPatchWidth + xP
          if ( yY < nnpfc_pic_height_in_luma_samples && xY < nnpfc_pic_width_in_luma_samples )
            if( !nnpfc_component_last_flag ) {
              FilteredYPic[ i ][ xY ][yY ] = outputTensor[ 0 ][ i ][ 0 ][ yP ][ xP ]
              if( ( nnpfc_{—}purpose & 0x40 ) != 0 )
                FilteredDPic[ i ][ xY ][yY ] = outputTensor[ 0 ][ i ][ 1 ][ yP ][ xP ]
            } else {
              FilteredYPic[ i ][ xY ][ yY ] = outputTensor[ 0 ][ i ][ yP ][ xP ][ 0 ]
              if( ( nnpfc_{—}purpose & 0x40 ) != 0 )
                FilteredDPic[ i ][ xY ][yY ] = outputTensor[ 0 ][ i ][ yP ][ xP ][ 1 ]
            }
        }
    else if( nnpfc_out_order_idc = = 1 ) { (85)
      for( yP = 0; yP < outPatchCHeight; yP++)
        for( xP = 0; xP < outPatchCWidth; xP++ ) {
          xSrc = cLeft * horCScaling + xP
          ySrc = cTop * verCScaling + yP
          if ( ySrc < nnpfc_pic_height_in_luma_samples / outSubHeightC &&
              xSrc < nnpfc_pic_width_in_luma_samples / outSubWidthC )
            if( !nnpfc_component_last_flag ) {
              FilteredCbPic[ i ][ xSrc ][ ySrc ] = outputTensor[ 0 ][ i ][ 0 ][ yP ][ xP ]
              FilteredCrPic[ i ][ xSrc ][ ySrc ] = outputTensor[ 0 ][ i ][ 1 ][ yP ][ xP ]
            } else {
              FilteredCbPic[ i ][ xSrc ][ ySrc ] = outputTensor[ 0 ][ i ][ yP ][ xP ][ 0 ]
              FilteredCrPic[ i ][ xSrc ][ ySrc ] = outputTensor[ 0 ][ i ][ yP ][ xP ][ 1 ]
            }
        }
      if( ( nnpfc_{—}purpose & 0x40 ) != 0 ) {
        for( yP = 0; yP < outPatchHeight; yP++)
          for( xP = 0; xP < outPatchWidth; xP++ ) {
            yY = cTop * outPatchHeight / inpPatchHeight + yP
            xY = cLeft * outPatchWidth / inpPatchWidth + xP
            if ( yY < nnpfc_{—}pic_{—}height_{—}in_{—}luma_{—}samples && xY <
  nnpfc_{—}pic_{—}width_{—}in_{—}luma_{—}samples )
              if( !nnpfc_{—}component_{—}last_{—}flag )
                FilteredDPic[ i ][ xY ][yY ] = outputTensor[ 0 ][ i ][ 2 ][ yP ][ xP ]
              else
                FilteredDPic[ i ][ xY ][yY ] = outputTensor[ 0 ][ i ][ yP ][ xP ][ 2 ]
      }
    }
    else if( nnpfc_out_order_idc = = 2 )
      for( yP = 0; yP < outPatchHeight; yP++)
        for( xP = 0; xP < outPatchWidth; xP++ ) {
          yY = cTop * outPatchHeight / inpPatchHeight + yP
          xY = cLeft * outPatchWidth / inpPatchWidth + xP
          yC = yY / outSubHeightC
          xC = xY / outSubWidthC
          yPc = ( yP / outSubHeightC ) * outSubHeightC
          xPc = ( xP / outSubWidthC ) * outSubWidthC
          if ( yY < nnpfc_pic_height_in_luma_samples && xY < nnpfc_pic_width_in_luma_samples)
            if( !nnpfc_component_last_flag ) {
              FilteredYPic[ i ][ xY ][ yY ] = outputTensor[ 0 ][ i ][ 0 ][ yP ][ xP ]
              FilteredCbPic[ i ][ xC ][ yC ] = outputTensor[ 0 ][ i ][ 1 ][ yPc ][ xPc ]
              FilteredCrPic[ i ][ xC ][ yC ] = outputTensor[ 0 ][ i ][ 2 ][ yPc ][ xPc ]
              if( ( nnpfc_{—}purpose & 0x40 ) != 0 )
                FilteredDPic[ i ][ xY ][ yY ] = outputTensor[ 0 ][ i ][ 3 ][ yP ][ xP ]
            } else {
              FilteredYPic[ i ][ xY ][ yY ] = outputTensor[ 0 ][ i ][ yP ][ xP ][ 0 ]
              FilteredCbPic[ i ][ xC ][ yC ] = outputTensor[ 0 ][ i ][ yPc ][ xPc ][ 1 ]
              FilteredCrPic[ i ][ xC ][ yC ] = outputTensor[ 0 ][ i ][ yPc ][ xPc ][ 2 ]
              if( ( nnpfc_{—}purpose & 0x40 ) != 0 )
                FilteredDPic[ i ][ xY ][ yY ] = outputTensor[ 0 ][ i ][ yP ][ xP ][ 3 ]
            }
      }
    else if( nnpfc_out_order_idc = = 3 )
      for( yP = 0; yP < outPatchHeight; yP++ )
        for( xP = 0; xP < outPatchWidth; xP++ ) {
          ySrc = cTop / 2 * outPatchHeight / inpPatchHeight + yP
          xSrc = cLeft / 2 * outPatchWidth / inpPatchWidth + xP
          if ( ySrc < nnpfc_pic_height_in_luma_samples / 2 &&
              xSrc < nnpfc_pic_width_in_luma_samples / 2 )
            if( !nnpfc_component_last_flag ) {
              FilteredYPic[ i ][ xSrc * 2 ][ ySrc * 2 ] = outputTensor[ 0 ][ i ][ 0 ][ yP ][ xP ]
              FilteredYPic[ i ][ xSrc * 2 + 1 ][ ySrc * 2 ] = outputTensor[ 0 ][ i ][ 1 ][ yP ][ xP ]
              FilteredYPic[ i ][ xSrc * 2 ][ ySrc * 2 + 1 ] = outputTensor[ 0 ][ i ][ 2 ][ yP ][ xP ]
              FilteredYPic[ i ][ xSrc * 2 + 1][ ySrc * 2 + 1 ] = outputTensor[ 0 ][ i ][ 3 ][ yP ][ xP ]
              FilteredCbPic[ i ][ xSrc ][ ySrc ] = output Tensor[ 0 ][ i ][ 4 ][ yP ][ xP ]
              FilteredCrPic[ i ][ xSrc ][ ySrc ] = outputTensor[ 0 ][ i ][ 5 ][ yP ][ xP ]
              if( ( nnpfc_{—}purpose & 0x40 ) != 0 ) {
                FilteredDPic[ i ][ xSrc * 2 ][ ySrc * 2 ] = outputTensor[ 0 ][ i ][ 6 ][ yP ][ xP ]
                FilteredDPic[ i ][ xSrc * 2 + 1 ][ ySrc * 2 ] = outputTensor[ 0 ][ i ][ 7 ][ yP ][ xP ]
                FilteredDPic[ i ][ xSrc * 2 ][ ySrc * 2 + 1 ] = outputTensor[ 0 ][ i ][ 8 ][ yP ][ xP ]
                FilteredDPic[ i ][ xSrc * 2 + 1][ ySrc * 2 + 1 ] = outputTensor[ 0 ][ i ][ 9 ][ yP ][ xP ]
              }
            } else {
              FilteredYPic[ i ][ xSrc * 2 ][ ySrc * 2 ] = outputTensor[ 0 ][ i ][ yP ][ xP ][ 0 ]
              FilteredYPic[ i ][ xSrc * 2 + 1 ][ ySrc * 2 ] = outputTensor[ 0 ][ i ][ yP ][ xP ][ 1 ]
              FilteredYPic[ i ][ xSrc * 2 ][ ySrc * 2 + 1 ] = outputTensor[ 0 ][ i ][ yP ][ xP ][ 2 ]
              FilteredYPic[ i ][ xSrc * 2 + 1][ ySrc * 2 + 1 ] = outputTensor[ 0 ][ i ][ yP ][ xP ][ 3 ]
              FilteredCbPic[ i ][ xSrc ][ ySrc ] = outputTensor[ 0 ][ i ][ yP ][ xP ][ 4 ]
              FilteredCrPic[ i ][ xSrc ][ ySrc ] = outputTensor[ 0 ][ i ][ yP ][ xP ][ 5 ]
              if( ( nnpfc_{—}purpose & 0x40 ) != 0 ) {
                FilteredDPic[ i ][ xSrc * 2 ][ ySrc * 2 ] = outputTensor[ 0 ][ i ][ yP ][ xP ][ 6 ]
                FilteredDPic[ i ][ xSrc * 2 + 1 ][ ySrc * 2 ] = outputTensor[ 0 ][ i ][ yP ][ xP ][ 7]
                FilteredDPic[ i ][ xSrc * 2 ][ ySrc * 2 + 1 ] = outputTensor[ 0 ][ i ][ yP ][ xP ][ 8 ]
                FilteredDPic[ i ][ xSrc * 2 + 1][ ySrc * 2 + 1 ] = outputTensor[ 0 ][ i ][ yP ][ xP ][ 9 ]
              }
            }
        }
    else if( nnpfc_{—}out_{—}order_{—}idc = = 4 )
      for( yP = 0; yP < outPatchHeight; yP++)
        for( xP = 0; xP < outPatchWidth; xP++ ) {
          yY = cTop * outPatchHeight / inpPatch Height + yP
          xY = cLeft * outPatchWidth / inpPatchWidth + xP
          if (yY < nnpfc_{—}pic_{—}height_{—}in_{—}luma_{—}samples && xY <
  nnpfc_{—}pic_{—}width_{—}in_{—}luma_{—}samples )
            if( !nnpfc_{—}component_{—}last_{—}flag )
              FilteredDPic[ i ][ xY ][yY ] = outputTensor[ 0 ][ i ][ 0 ][ yP ][ xP ]
            else
              FilteredDPic[ i ][ xY ][ yY ] = outputTensor[ 0 ][ i ][ yP ][ xP ][ 0 ]
        }
  }
...
```

### 6.2 Embodiment 2

This embodiment is for items 1, 2, and all their subitems as summarized above in Section 5.

8.28.1 Neural-network post-filter characteristics SEI message syntax

| | Descriptor |
|---|---|
| nn_post_filter_characteristics( payloadSize ) { | |
| ... | |
| nnpfc_{—}input_{—}depth_{—}flag | u(1) |
| nnpfc_component_last_flag | u(1) |
| nnpfc_inp_format_idc | ue(v) |
| if( nnpfc_inp_format_idc = = 1 ) { | |
| nnpfc_inp_tensor_luma_bitdepth_minus8 | ue(v) |
| nnpfc_inp_tensor_chroma_bitdepth_minus8 | ue(v) |
| if( nnpfc_{—}input_{—}depth_{—}flag ) | |
| nnpfc_{—}inp_{—}tensor_{—}depth_{—}bitdepth_{—}minus8 | ue(v) |
| } | |
| nnpfc_inp_order_idc | ue(v) |
| ... | |
| nnpfc_out_format_idc | ue(v) |
| if( nnpfc_out_format_idc = = 1 ) { | |
| nnpfc_out_tensor_luma_bitdepth_minus8 | ue(v) |
| nnpfc_out_tensor_chroma_bitdepth_minus8 | ue(v) |
| if( ( nnpfc_{—}purpose & 0x40 ) != 0 ) | |
| nnpfc_{—}out_{—}tensor_{—}depth_{—}bitdepth_{—}minus8 | ue(v) |
| } | |
| nnpfc_out_order_idc | ue(v) |
| ... | |
| nnpfc_padding_type | ue(v) |
| if( nnpfc_padding_type = = 4 ) { | |
| nnpfc_luma_padding_val | ue(v) |
| nnpfc_cb_padding_val | ue(v) |
| nnpfc_cr_padding_val | ue(v) |
| if( nnpfc_{—}input_{—}depth_{—}flag ) | |
| nnpfc_{—}depth_{—}padding_{—}val | ue(v) |
| } | |
| ... | |
| } | |

### 8.28.2 Neural-Network Post-Filter Characteristics SEI Message Semantics

The neural-network post-filter characteristics (NNPFC) SEI message specifies a neural network that may be used as a post-processing filter. The use of specified neural-network post-processing filters (NNPFs) for specific pictures is indicated with neural-network post-filter activation (NNPFA) SEI messages.

Use of this SEI message requires the definition of the following variables:
Input picture width and height in units of luma samples, denoted herein by CroppedWidth and CroppedHeight, respectively.
Luma sample array CroppedYPic[idx], and chroma sample arrays CroppedCbPic[idx] and CroppedCrPic[idx], and depth sample array CroppedDPic[idx], when present, of the input pictures with index idx in the range of 0 to numInputPics−1, inclusive, that are used as input for the NNPF.
Bit depth BitDepth_{Y} for the luma sample array of the input pictures.
Bit depth BitDepth_{C} for the chroma sample arrays, if any, of the input pictures.
Bit depth BitDepth_{D} for the depth sample arrays, if any, of the input pictures.
A chroma format indicator, denoted herein by ChromaFormatIdc, as described in subclause 7.3.
When nnpfc_auxiliary_inp_idc is equal to 1, a filtering strength control value StrengthControlVal that shall be a real number in the range of 0 to 1, inclusive.

Input picture with index 0 corresponds to the picture for which the NNPFdefined by this NNPFC SEI message is activated by an NNPFA SEI message. Input picture with index i in the range of 1 to numInputPics−1, inclusive, precedes the input picture with index i−1 in output order.

When nnpfc_purpose & 0x08 is not equal to 0 and the input picture with index 0 is associated with a frame packing arrangement SEI message with fp_arrangement_type equal to 5, all input pictures are associated with a frame packing arrangement SEI message with fp_arrangement_type equal to 5 and the same value of fp_current_frame_is_frame0_flag.

The variables SubWidthC and SubHeightC are derived from ChromaFormatIdc.
NOTE 1—More than one NNPFC SEI message can be present for the same picture. When more than one NNPFC SEI message with different values of nnpfc_id is present or activated for the same picture, they can have the same or different values of nnpfc_purpose and nnpfc_mode_idc.

nnpfc_purpose indicates the purpose of the NNPF as specified in Table 7.

The value of nnpfc_purpose shall be in the range of 0 to 63 127, inclusive, in bitstreams conforming to this edition of this document. Values of 64 128 to 65 535, inclusive, for nnpfc_purpose are reserved for future use by ITU-T|ISO/IEC and shall not be present in bitstreams conforming to this edition of this document. Decoders conforming to this edition of this document shall ignore NNPFC SEI messages with nnpfc_purpose in the range of 64 128 to 65 535, inclusive.

TABLE 7
Definition of nnpfc_purpose

| Value | Interpretation |
|---|---|
| nnpfc_purpose = = 0 | May be used as determined by the application |
| nnpfc_purpose > 0 && | No general visual quality improvement |
| ( nnpfc_purpose & | |
| 0x01 ) = = 0 | |
| ( nnpfc_purpose & | With general visual quality improvement |
| 0x01 ) != 0 | |
| nnpfc_purpose > 0 && | No chroma upsampling (from the 4:2:0 chroma format to the 4:2:2 or 4:4:4 |
| ( nnpfc_purpose & | chroma format, or from the 4:2:2 chroma format to the 4:4:4 chroma format) |
| 0x02 ) = = 0 | |
| ( nnpfc_purpose & | With chroma upsampling |
| 0x02 ) != 0 | |
| nnpfc_purpose > 0 && | No resolution upsampling (increasing the width or height) |
| ( nnpfc_purpose & | |
| 0x04 ) = = 0 | |
| ( nnpfc_purpose & | With resolution upsampling |
| 0x04 ) != 0 | |
| nnpfc_purpose > 0 && | No picture rate upsampling |
| ( nnpfc_purpose & | |
| 0x08 ) = = 0 | |
| ( nnpfc_purpose & | With picture rate upsampling |
| 0x08 ) != 0 | |
| nnpfc_purpose > 0 && | No bit depth upsampling (increasing the luma bit depth or the chroma bit |
| ( nnpfc_purpose & | depth) |
| 0x10 ) = = 0 | |
| ( nnpfc_purpose & | With bit depth upsampling |
| 0x10 ) != 0 | |
| nnpfc_purpose > 0 && | No colourization (from the 4:0:0 chroma format to the 4:2:0, 4:2:2, or 4:4:4 |
| ( nnpfc_purpose & | chroma format) |
| 0x20 ) = = 0 | |
| ( nnpfc_purpose & | With colourization |
| 0x20 ) != 0 | |
| nnpfc_purpose > 0 && | No depth picture generation |
| ( nnpfc_purpose & | |
| 0x40 ) = = 0 | |
| ( nnpfc_purpose & | With depth picture generation |
| 0x40 ) != 0 | |

NOTE 2—When a reserved value of nnpfc_purpose is taken into use in the future by ITU-T|ISO/IEC, the syntax of this SEI message could be extended with syntax elements whose presence is conditioned by nnpfc_purpose being equal to that value.

When ChromaFormatIdc is equal to 3, nnpfc_purpose & 0x02 shall be equal to 0.

When ChromaFormatIdc or nnpfc_purpose & 0x02 is not equal to 0, nnpfc_purpose & 0x20 shall be equal to 0.

nnpfc_pic_width_in_luma_samples and nnpfc_pic_height_in_luma_samples specify the width and height, respectively, of the luma sample array of the picture resulting from applying the NNPF identified by nnpfc_id to a cropped decoded output picture. When nnpfc_pic_width_in_luma_samples and nnpfc_pic_height_in_luma_samples are not present, they are inferred to be equal to CroppedWidth and CroppedHeight, respectively. The value of nnpfc_pic_width_in_luma_samples shall be in the range of

CroppedWidth to CroppedWidth*16−1, inclusive. The value of nnpfc_pic_height_in_luma_samples shall be in the range of CroppedHeight to CroppedHeight*16−1, inclusive.

When nnpfc_purpose & 0x40 is not equal to 0, nnpfc_pic_width_in_luma_samples and nnpfc_pic_height_in_luma_samples also specify the width and height, respectively, of the depth sample array of the picture resulting from applying the NNPF identified by nnpfc_id to a cropped decoded output depth picture.

nnpfc_input_depth_flag equal to 1 indicates that depth pictures associated with the cropped decoded output picture are used as input to the NNPF. nnpfc_input_depth_flag equal to 0 indicates that no depth picture is used as input to the NNPF. nnpfc_component_last_flag equal to 1 indicates that the last dimension in the input tensor inputTensor to the NNPF and the output tensor outputTensor resulting from the NNPF is used for a current channel. nnpfc_component_last_flag equal to 0 indicates that the third dimension in the input tensor inputTensor to the NNPF and the output tensor outputTensor resulting from the NNPF is used for a current channel.
NOTE 4—The first dimension in the input tensor and in the output tensor is used for the batch index, which is a practice in some neural network frameworks. While formulae in the semantics of this SEI message use the batch size corresponding to the batch index equal to 0, it is up to the post-processing implementation to determine the batch size used as input to the neural network inference.
NOTE 5—For example, when nnpfc_inp_order_idc is equal to 3 and nnpfc_auxiliary_inp_idc is equal to 1, there are 7 channels in the input tensor, including four luma matrices, two chroma matrices, and one auxiliary input matrix. In this case, the process DeriveInputTensors ( ) would derive each of these 7 channels of the input tensor one by one, and when a particular channel of these channels is processed, that channel is referred to as the current channel during the process.

nnpfc_inp_format_idc indicates the method of converting a sample value of the cropped decoded output picture to an input value to the NNPF. When nnpfc_inp_format_idc is equal to 0, the input values to the NNPF are real numbers and the functions InpY( ) and, InpC( ) and InpD( ) are specified as follows:

$$InpY ( x ) = x \div ( ( 1 ≪ {BitDepth}_{Y} ) - 1 ) \qquad ( 77 )$$

$$InpC ( x ) = x \div ( ( 1 ≪ {BitDepth}_{C} ) - 1 ) \qquad ( 78 )$$

$$InpD ( x ) = x \div ( ( 1 ≪ {BitDepth}_{D} ) - 1 ) \qquad ( xx )$$

When nnpfc_inp_format_idc is equal to 1, the input values to the NNPF are unsigned integer numbers and the functions InpY( ) and, InpC( ) and InpD( ) are specified as follows:

shiftY = BitDepth_{Y} − inpTensorBitDepth_{Y}
if( inpTensorBitDepth_{Y} >= BitDepth_{Y})

| | |
|---|---|
| InpY( x ) = x << ( inpTensorBitDepth_{Y} − BitDepth_{Y} ) | (79) |

else
InpY( x ) = Clip3(0, ( 1 << inpTensorBitDepth_{Y} ) − 1, ( x + ( 1 << ( shiftY − 1 ) ) ) >> shiftY )
shiftC = BitDepth_{C} − inpTensorBitDepth_{C}
if( inpTensorBitDepth_{C} >= BitDepth_{C} )

| | |
|---|---|
| InpC( x ) = x << ( inpTensorBitDepth_{C} − BitDepth_{C} ) | (80) |

else
InpC( x ) = Clip3(0, ( 1 << inpTensorBitDepth_{C} ) − 1, ( x + ( 1 << ( shiftC − 1 ) ) ) >> shiftC )
shiftD = BitDepth_{D} − inpTensorBitDepth_{D}
if( inpTensorBitDepth_{D} >= BitDepth_{D} )

| | |
|---|---|
| InpD( x ) = x << ( inpTensorBitDepth_{D} − BitDepth_{D} ) | (xx) |

else
InpD( x ) = Clip3(0, ( 1 << inpTensorBitDepth_{D} ) − 1, ( x + ( 1 << ( shiftD −
1 ) ) ) >> shiftD )

The variable inpTensorBitDepth_{Y} is derived from the syntax element nnpfc_inp_tensor_luma_bitdepth_minus8 as specified below. The variable inpTensorBitDepth_{C} is derived from the syntax element nnpfc_inp_tensor_chroma_bitdepth_minus8 as specified below. The variable inpTensorBitDepth_{D} is derived from the syntax element nnpfc_inp_tensor_depth_bitdepth_minus8 as specified below.

Values of nnpfc_inp_format_idc greater than 1 are reserved for future specification by ITU-T|ISO/IEC and shall not be present in bitstreams conforming to this edition of this document. Decoders conforming to this edition of this document shall ignore NNPFC SEI messages that contain reserved values of nnpfc_inp_format_idc. nnpfc_inp_tensor_luma_bitdepth_minus8 plus 8 specifies the bit depth of luma sample values in the input integer tensor. The value of inpTensorBitDepth_{Y} is derived as follows:

$${inpTensorBitDepth}_{Y} = nnpfc\_inp \_tensor \_luma \_bitdepth \_minus8 + 8 \qquad ( 81 )$$

It is a requirement of bitstream conformance that the value of nnpfc_inp_tensor_luma_bitdepth_minus8 shall be in the range of 0 to 24, inclusive.

nnpfc_inp_tensor_chroma_bitdepth_minus8 plus 8 specifies the bit depth of chroma sample values in the input integer tensor. The value of inpTensorBitDepth_{C} is derived as follows:

$${inpTensorBitDepth}_{C} = nnpfc\_inp \_tensor \_chroma \_bitdepth \_minus8 + 8 \qquad ( 82 )$$

It is a requirement of bitstream conformance that the value of nnpfc_inp_tensor_chroma_bitdepth_minus8 shall be in the range of 0 to 24, inclusive.

nnpfc_inp_tensor_depth_bitdepth_minus8 plus 8 specifies the bit depth of depth sample values in the input integer tensor. The value of inpTensorBitDepth_{D} is derived as follows:

$${inpTensorBitDepth}_{D} = nnpfc\_inp \_tensor \_depth \_bitdepth \_minus8 + 8 \qquad ( xx )$$

nnpfc_inp_order_idc indicates the method of ordering the sample arrays of a cropped decoded output picture as one of the input pictures to the NNPF.

The value of nnpfc_inp_order_idc shall be in the range of 0 to 3, inclusive, in bitstreams conforming to this edition of this document. Values of 4 to 255, inclusive, for nnpfc_inp_order_idc are reserved for future use by ITU-T|ISO/IEC and shall not be present in bitstreams conforming to this edition of this document. Decoders conforming to this edition of this document shall ignore NNPFC SEI messages with nnpfc_inp_order_idc in the range of 4 to 255, inclusive. Values of nnpfc_inp_order_idc greater than 255 shall not be present in bitstreams conforming to this edition of this document and are not reserved for future use.

When ChromaFormatIdc is not equal to 1, nnpfc_inp_order_idc shall not be equal to 3.

Table 8 contains an informative description of nnpfc_inp_order_idc values.

TABLE 8
Description of nnpfc_inp_order_idc values

| nnpfc_inp_{—} | |
|---|---|
| order_idc | Description |
| 0 | If nnpfc_input_depth_flag is equal to 0, the following applies: if If |
| | nnpfc_auxiliary_inp_idc is equal to 0, one luma matrix is present in the input tensor for |
| | each input picture, and the number of channels is 1; otherwise when |
| | nnpfc_auxiliary_inp_idc is equal to 1, one luma matrix and one auxiliary input matrix are |
| | present, and the number of channels is 2. |
| | Otherwise (nnpfc_input_depth_flag is equal to 1), the following applies: if |
| | nnpfc_auxiliary_inp_idc is equal to 0, one luma matrix and one depth matrix are |
| | present in the input tensor for each input picture, and the number of channels is 2; |
| | otherwise when nnpfc_auxiliary_inp_idc is equal to 1, one luma matrix, one depth |
| | matrix and one auxiliary input matrix are present, and the number of channels is 3. |
| 1 | If nnpfc_input_depth_flag is equal to 0, the following applies: if If |
| | nnpfc_auxiliary_inp_idc is equal to 0, two chroma matrices are present in the input |
| | tensor, and the number of channels is 2. Otherwise when nnpfc_auxiliary_inp_idc is |
| | equal to 1, two chroma matrices and one auxiliary input matrix are present, and the |
| | number of channels is 3. |
| | Otherwise (nnpfc_input_depth_flag is equal to 1), the following applies: if |
| | nnpfc_auxiliary_inp_idc is not equal to 0, two chroma matrices and one depth |
| | matrix are present in the input tensor, and the number of channels is 3. Otherwise |
| | when nnpfc_auxiliary_inp_idc is equal to 1, two chroma matrices, one depth |
| | matrix, and one auxiliary input matrix are present, and the number of channels is |
| | 4. |
| 2 | If nnpfc_input_depth_flag is equal to 0, the following applies: if If |
| | nnpfc_auxiliary_inp_idc is equal to 0, one luma and two chroma matrices are present in |
| | the input tensor, and the number of channels is 3. Otherwise when |
| | nnpfc_auxiliary_inp_idc is equal to 1, one luma matrix, two chroma matrices and one |
| | auxiliary input matrix are present, and the number of channels is 4. |
| | Otherwise (nnpfc_input_depth_flag is equal to 1), the following applies: if |
| | nnpfc_auxiliary_inp_idc is equal to 0, one luma, two chroma matrices, and one |
| | depth matrix are present in the input tensor, and the number of channels is 4. |
| | Otherwise when nnpfc_auxiliary_inp_idc is equal to 1, one luma matrix, two |
| | chroma matrices, one depth matrix and one auxiliary input matrix are present, and |
| | the number of channels is 5. |
| 3 | If nnpfc_input_depth_flag is equal to 0, the following applies: if If |
| | nnpfc_auxiliary_inp_idc is equal to 0, four luma matrices and two chroma matrices are |
| | present in the input tensor, and the number of channels is 6. Otherwise when |
| | nnpfc_auxiliary_inp_idc is equal to 1, four luma matrices, two chroma matrices, and one |
| | auxiliary input matrix are present in the input tensor, and the number of channels is 7. |
| | Otherwise (nnpfc_input_depth_flag is equal to 1), the following applies: if |
| | nnpfc_auxiliary_inp_idc is equal to 0, four luma matrices, two chroma matrices, |
| | and one depth matrix are present in the input tensor, and the number of channels is |
| | 10. Otherwise when nnpfc_auxiliary_inp_idc is equal to 1, four luma matrices, two |
| | chroma matrices, and one auxiliary input matrix are present in the input tensor, |
| | and the number of channels is 11. The luma channels are derived in an interleaved |
| | manner as illustrated in FIG. 4. This nnpfc_inp_order_idc can only be used when the |
| | input chroma format is 4:2:0. |
| 4 . . . 255 | Reserved |

FIG. 4 is an illustration of deriving the four luma channels (right) from the luma component (left) when nnpfc_inp_order_idc is equal to 3.

A patch is a rectangular array of samples from a component (e.g., a luma or chroma component) of a picture. nnpfc_auxiliary_inp_idc greater than 0 indicates that auxiliary input data is present in the input tensor of the NNPF. nnpfc_auxiliary_inp_idc equal to 0 indicates that auxiliary input data is not present in the input tensor. nnpfc_auxiliary_inp_idc equal to 1 specifies that auxiliary input data is derived as specified in Formula 84. The value of nnpfc_auxiliary_inp_idc shall be in the range of 0 to 1, inclusive, in bitstreams conforming to this edition of this document. Values of 2 to 255, inclusive, for nnpfc_inp_order_idc are reserved for future use by ITU-T|ISO/IEC and shall not be present in bitstreams conforming to this edition of this document. Decoders conforming to this edition of this document shall ignore NNPFC SEI messages with nnpfc_inp_order_idc in the range of 2 to 255, inclusive. Values of nnpfc_inp_order_idc greater than 255 shall not be present in bitstreams conforming to this edition of this document and are not reserved for future use.

When nnpfc_auxiliary_inp_idc is equal to 1, the variable strengthControlScaledVal is derived as follows:

```
if( nnpfc_inp_format_idc = = 1)
  strengthControlScaledVal = Floor ( StrengthControlVal * ( ( 1 << inpTensorBitDepth_{Y}) − 1 ) ) (83)
else
  strengthControlScaledVal = StrengthControlVal
```

The process DeriveInputTensors ( ) for deriving the input tensor inputTensor for a given vertical sample coordinate cTop and a horizontal sample coordinate cLeft specifying the top-left sample location for the patch of samples included in the input tensor, is specified as follows:

```
  for( i = 0; i < numInputPics; i++ ) {
    if( nnpfc_inp_order_idc = = 0)
      for( yP = −nnpfc_overlap; yP < inpPatchHeight + nnpfc_overlap; yP++)
        for( xP = −nnpfc_overlap; xP < inpPatch Width + nnpfc_overlap; xP++ ) {
          inp Val = InpY( InpSample Val( cTop + yP, cLeft + xP, CroppedHeight,
            CroppedWidth, CroppedYPic[ i ] ) )
          yPovlp = yP + nnpfc_overlap
          xPovlp = xP + nnpfc_overlap
          if( nnpfc_input_depth_flag ) {
            inpDVal = InpD( InpSampleVal( cTop + yP, cLeft + xP, CroppedHeight,
              Cropped Width, CroppedDPic[i ]) )
            if( !nnpfc_component_last_flag ) {
              inputTensor[0 ][i ][0 ][yPovlp ][xPovlp ]= inpVal
              inputTensor[0 ][i ][1 ][yPovlp ][xPovlp ]= inpDVal
            } else {
              inputTensor[0 ][i ][yPovlp ][xPovlp ][0 ]= inp Val
              inputTensor[0 ][i ][yPovlp ][xPovlp ][1 ]= inpDVal
            }
            if( nnpfc_auxiliary_inp_idc = = 1)
              if( !nnpfc_component_last_flag )
                inputTensor[0 ][i ][2 ][yPovlp ][xPovlp ]= strength ControlScaledVal
              else
                inputTensor[0 ][i ][yPovlp ][xPovlp ][2 ]= strengthControlScaledVal
          } else {
            if( !nnpfc_component_last_flag )
              inputTensor[ 0 ][ i ][ 0 ][ yPovlp ][ xPovlp ] = inpVal
            else
              inputTensor[ 0 ][ i ][ yPovlp ][ xPovlp ][ 0 ] = inpVal
            if( nnpfc_auxiliary_inp_idc = = 1)
              if( !nnpfc_component_last_flag )
                inputTensor[ 0 ][ i ][ 1 ][ yPovlp ][ xPovlp ] = strengthControlScaledVal
              else
                inputTensor[ 0 ][ i ][ yPovlp ][ xPovlp ][ 1 ] = strengthControlScaledVal
          }
        }
    else if( nnpfc_inp_order_idc = = 1 ) (84)
      for( yP = −nnpfc_overlap; yP < inpPatchHeight + nnpfc_overlap; yP++)
        for( xP = −nnpfc_overlap; xP < inpPatch Width + nnpfc_overlap; xP++ ) {
          inpCbVal = InpC( InpSample Val( cTop + yP, cLeft +xP, CroppedHeight / SubHeightC,
              CroppedWidth / Sub WidthC, CroppedCbPic[i ]) )
          inpCrVal = InpC( InpSampleVal( cTop + yP, cLeft + xP, CroppedHeight / SubHeightC,
              CroppedWidth / Sub WidthC, CroppedCrPic[i ]) )
          yPovlp = yP + nnpfc_overlap
          xPovlp = xP + nnpfc_overlap
          if( nnpfc_input_depth_flag ) {
            yY = cTop + yP
            xY = cLeft + xP
            yC = yY / SubHeightC
            xC = xY / Sub Width C
            inpCbVal = InpC( InpSample Val( yC, xC, CroppedHeight / SubHeightC,
                CroppedWidth / Sub WidthC, CroppedCbPic[i ]) )
            inpCrVal = InpC( InpSampleVal( yC, xC, CroppedHeight / SubHeightC,
                CroppedWidth / Sub WidthC, CroppedCrPic[i ]) )
            inpDVal = InpD( InpSampleVal( yY, xY, CroppedHeight,
              CroppedWidth, CroppedDPic[i ]) )
            yPovlp = yP + nnpfc_overlap
            xPovlp = xP + nnpfc_overlap
            if( !nnpfc_component_last_flag ) {
              inputTensor[0 ][i ][0 ][yPovlp ][xPovlp ]= inpCbVal
              inputTensor[0 ][i ][1 ][yPovlp ][xPovlp ]= inpCrVal
              inputTensor[0 ][i ][2 ][yPovlp ][xPovlp ]= inpDVal
            } else {
              inputTensor[0 ][i ][yPovlp ][xPovlp ][0 ]= inpCbVal
              inputTensor[0 ][i ][yPovlp ][xPovlp ][1 ]= inpCrVal
              inputTensor[0 ][i ][yPovlp ][xPovlp ][2 ]= inpDVal
            }
            if( nnpfc_auxiliary_inp_idc = = 1)
              if( !nnpfc_component_last_flag )
                inputTensor[0 ][i ][3 ][yPovlp ][xPovlp ]= strength ControlScaledVal
              else
                inputTensor[0 ][i ][yPovlp ][xPovlp ][3 ]= strengthControlScaledVal
          } else {
            inpCbVal = InpC( InpSample Val( cTop + yP, cLeft + xP, CroppedHeight /
SubHeightC,
                CroppedWidth / Sub WidthC, CroppedCbPic[i ]) )
            inpCrVal = InpC( InpSampleVal( cTop + yP, cLeft + xP, CroppedHeight / SubHeightC,
                CroppedWidth / Sub WidthC, CroppedCrPic[i ]) )
            yPovlp = yP + nnpfc_overlap
            xPovlp = xP + nnpfc_overlap
            if( !nnpfc_component_last_flag ) {
              inputTensor[ 0 ][ i ][ 0 ][ yPovlp ][ xPovlp ] = inpCbVal
              inputTensor[ 0 ][ i ][ 1 ][ yPovlp ][ xPovlp ] = inpCrVal
            } else {
              inputTensor[ 0 ][ i ][ yPovlp ][ xPovlp ][ 0 ] = inpCbVal
              inputTensor[ 0 ][ i ][ yPovlp ][ xPovlp ][ 1 ] = inpCrVal
            }
            if( nnpfc_auxiliary_inp_idc = = 1)
            if( !nnpfc_component_last_flag )
              inputTensor[ 0 ][ i ][ 2 ][ yPovlp ][ xPovlp ] = strengthControlScaledVal
            else
              inputTensor[ 0 ][ i ][ yPovlp ][ xPovlp ][ 2 ] = strengthControlScaledVal
          }
        }
    else if( nnpfc_inp_order_idc = = 2)
      for( yP = −nnpfc_overlap; yP < inpPatchHeight + nnpfc_overlap; yP++)
        for( xP = −nnpfc_overlap; xP < inpPatch Width + nnpfc_overlap; xP++ ) {
          yY = cTop + yP
          xY = cLeft + xP
          yC = yY / SubHeightC
          xC = xY / SubWidthC
          inpYVal = InpY( InpSampleVal( yY, xY, CroppedHeight,
              CroppedWidth, CroppedYPic[ i ] ) )
          inpCbVal = InpC( InpSampleVal( yC, xC, CroppedHeight / SubHeightC,
              CroppedWidth / SubWidthC, CroppedCbPic[ i ] ) )
          inpCrVal = InpC( InpSampleVal( yC, xC, CroppedHeight / SubHeightC,
              CroppedWidth / SubWidthC, CroppedCrPic[ i ] ) )
          yPovlp = yP + nnpfc_overlap
          xPovlp = xP + nnpfc_overlap
          if( nnpfc_input_depth_flag ) {
            inpDVal = InpD( InpSampleVal( yY, xY, CroppedHeight,
                CroppedWidth, CroppedDPic[i ]) )
            if( !nnpfc_component_last_flag ) {
              inputTensor[0 ][i ][0 ][yPovlp ][xPovlp ]= inpYVal
              inputTensor[0 ][i ][1 ][yPovlp ][xPovlp ]= inpCbVal
              inputTensor[0 ][i ][2 ][yPovlp ][xPovlp ]= inpCrVal
              inputTensor[0 ][i ][3 ][yPovlp ][xPovlp ]= inpDVal
            } else {
              inputTensor[0 ][i ][yPovlp ][xPovlp ][0 ]= inpYVal
              inputTensor[0 ][i ][yPovlp ][xPovlp ][1 ]= inpCbVal
              inputTensor[0 ][i ][yPovlp ][xPovlp ][2 ]= inpCrVal
              inputTensor[0 ][i ][yPovlp ][xPovlp ][3 ]= inpDVal
            }
            if( nnpfc_auxiliary_inp_idc = = 1)
              if( !nnpfc_component_last_flag )
                inputTensor[0 ][i ][4 ][yPovlp ][xPovlp ]= strength ControlScaledVal
              else
                inputTensor[0 ][i ][yPovlp ][xPovlp ][4 ]= strengthControlScaledVal
          } else {
            if( !nnpfc_component_last_flag ) {
              inputTensor[ 0 ][ i ][ 0 ][ yPovlp ][ xPovlp ] = inpYVal
              inputTensor[ 0 ][ i ][ 1 ][ yPovlp ][ xPovlp ] = inpCbVal
              inputTensor[ 0 ][ i ][ 2 ][ yPovlp ][ xPovlp ] = inpCrVal
            } else {
              inputTensor[ 0 ][ i ][ yPovlp ][ xPovlp ][ 0 ] = inpYVal
              inputTensor[ 0 ][ i ][ yPovlp ][ xPovlp ][ 1 ] = inpCbVal
              inputTensor[ 0 ][ i ][ yPovlp ][ xPovlp ][ 2 ] = inpCrVal
            }
            if( nnpfc_auxiliary_inp_idc = = 1)
              if( !nnpfc_component_last_flag )
                inputTensor[ 0 ][ i ][ 3 ][ yPovlp ][ xPovlp ] = strengthControlScaledVal
              else
                inputTensor[ 0 ][ i ][ yPovlp ][ xPovlp ][ 3 ] = strengthControlScaledVal
          }
        }
    else if( nnpfc_inp_order_idc = = 3 )
      for( yP = −nnpfc_overlap; yP < inpPatchHeight + nnpfc_overlap; yP++)
        for( xP = −nnpfc_overlap; xP < inpPatch Width + nnpfc_overlap; xP++ ) {
          yTL = cTop + yP * 2
          xTL = cLeft + xP * 2
          yBR = yTL + 1
          xBR = xTL + 1
          yC = cTop / 2 + yP
          xC = cLeft / 2 + xP
          inpTLVal = InpY( InpSampleVal( yTL, xTL, CroppedHeight,
              CroppedWidth, CroppedYPic[ i ] ) )
          inpTRVal = InpY( InpSample Val( yTL, xBR, CroppedHeight,
              CroppedWidth, CroppedYPic[ i] ) )
          inpBLVal = InpY( InpSampleVal( yBR, xTL, CroppedHeight,
              CroppedWidth, CroppedYPic[ i]) )
          inpBRVal = InpY( InpSample Val( yBR, xBR, CroppedHeight,
              CroppedWidth, CroppedYPic[ i ] ) )
          inpCbVal = InpC( InpSample Val( yC, xC, CroppedHeight / 2,
              CroppedWidth / 2, CroppedCbPic[ i ] ) )
          inpCrVal = InpC( InpSampleVal( yC, xC, CroppedHeight / 2,
              CroppedWidth / 2, CroppedCrPic[ i ] ) )
          yPovlp = yP + nnpfc_overlap
          xPovlp = xP + nnpfc_overlap
          if( nnpfc_input_depth_flag ) {
              inpDTLVal = InpD( InpSampleVal( yTL, xTL, CroppedHeight,
        Cropped Width, CroppedDPic[i ]) )
              inpDTRVal = InpD( InpSampleVal( yTL, xBR, CroppedHeight,
        Cropped Width, CroppedDPic[i ]) )
              inpDBLVal = InpD( InpSample Val( yBR, xTL, CroppedHeight,
        Cropped Width, CroppedDPic[i ]) )
              inpDBRVal = InpD( InpSampleVal( yBR, xBR, CroppedHeight,
        CroppedWidth, CroppedDPic[i ]) )
                    if( !nnpfc_component_last_flag ) {
```

| | |
|---|---|
| | inputTensor[0 ][i ][0 ][yPovlp ][xPovlp ]= |
| inpTL Val | |
| | inputTensor[0 ][i ][1 ][yPovlp ][xPovlp ]= |
| inpTRVal | |
| | inputTensor[0 ][i ][2 ][yPovlp ][xPovlp ]= |
| inpBL Val | |
| | inputTensor[0 ][i ][3 ][yPovlp ][xPovlp ]= |
| inpBRVal | |
| | inputTensor[0 ][i ][4 ][yPovlp ][xPovlp ]= |
| inpCbVal | |
| | inputTensor[0 ][i ][5 ][yPovlp ][xPovlp ]= |
| inpCrVal | |
| | inputTensor[0 ][i ][ 6 ][yPovlp ][xPovlp ]= |
| inpDTLVal | |
| | inputTensor[0 ][i ][7 ][yPovlp ][xPovlp ]= |
| inpDTRVal | |
| | inputTensor[0 ][i ][8 ][yPovlp ][xPovlp ]= |
| inpDBLVal | |
| | inputTensor[0 ][i ][9 ][yPovlp ][xPovlp ]= |
| inpDBRVal | |
| | } else { |
| | inputTensor[0 ][i ][yPovlp ][xPovlp ][0 ]= |
| inpTL Val | |
| | inputTensor[0 ][i ][yPovlp ][xPovlp ][1 ]= |
| inpTRVal | |
| | inputTensor[0 ][i ][yPovlp ][xPovlp ][2 ]= |
| inpBLVal | |
| | inputTensor[0 ][i ][yPovlp ][xPovlp ][3 ]= |
| inpBRVal | |
| | inputTensor[0 ][i ][yPovlp ][xPovlp ][4 ]= |
| inpCBVal | |
| | inputTensor[0 ][i ][yPovlp ][xPovlp ][5 ]= |
| inpBLVal | |
| | inputTensor[0 ][i ][yPovlp ][xPovlp ][6 ]= |
| inpDTLVal | |
| | input Tensor[0 ][i ][yPovlp ][xPovlp ][7 ]= |
| inpDTRVal | |
| | inputTensor[0 ][i ][yPovlp ][xPovlp ][8 ]= |
| inpDBLVal | |
| | inputTensor[0 ][i ][yPovlp ][xPovlp ][9 ]= |
| inpDBRVal | |
| | } |

if( nnpfc_auxiliary_inp_idc = = 1)

if( !nnpfc_component_last_flag )

inputTensor[0 ][i ][10 ][yPovlp ][xPovlp ]= strengthControlScaledVal

else

```
      inputTensor[0 ][i ][yPovlp ][xPovlp ][10 ]= strengthControlScaledVal
              } else {
                  if( !nnpfc_component_last_flag ) {
```

| | |
|---|---|
| | inputTensor[ 0 ][ i ][ 0 ][ yPovlp ][ xPovlp ] = |
| inpTLVal | |
| | inputTensor[ 0 ][ i ][ 1 ][ yPovlp ][ xPovlp ] = |
| inpTRVal | |
| | inputTensor[ 0 ][ i ][ 2 ][ yPovlp ][ xPovlp ] = |
| inpBLVal | |
| | inputTensor[ 0 ][ i ][ 3 ][ yPovlp ][ xPovlp ] = |
| inpBRVal | |
| | inputTensor[ 0 ][ i ][ 4 ][ yPovlp ][ xPovlp ] = |
| inpCbVal | |
| | inputTensor[ 0 ][ i ][ 5 ][ yPovlp ][ xPovlp ] = |
| inpCrVal | |
| } else { | |
| | inputTensor[ 0 ][ i ][ yPovlp ][ xPovlp ][ 0 ] = |
| inpTLVal | |
| | inputTensor[ 0 ][ i ][ yPovlp ][ xPovlp ][ 1 ] = |
| inpTRVal | |
| | inputTensor[ 0 ][ i ][ yPovlp ][ xPovlp ][ 2 ] = |
| inpBLVal | |
| | inputTensor[ 0 ][ i ][ yPovlp ][ xPovlp ][ 3 ] = |
| inpBRVal | |
| | inputTensor[ 0 ][ i ][ yPovlp ][ xPovlp ][ 4 ] = |
| inpCbVal | |
| | inputTensor[ 0 ][ i ][ yPovlp ][ xPovlp ][ 5 ] = |
| inpCrVal | |
| | } |

if( nnpfc_auxiliary_inp_idc = = 1)

if( !nnpfc_component_last_flag )

inputTensor[ 0 ][ i ][ 6 ][ yPovlp ][ xPovlp ] = strengthControlScaledVal

else

```
      inputTensor[ 0 ][ i ][ yPovlp ][ xPovlp ][ 6 ] = strengthControlScaledVal
              }
            }
        }
...
```

nnpfc_out_format_idc equal to 0 indicates that the sample values output by the NNPF are real numbers where the value range of 0 to 1, inclusive, maps linearly to the unsigned integer value range of 0 to (1<<bitDepth)−1, inclusive, for any desired bit depth bitDepth for subsequent post-processing or displaying. nnpfc_out_format_idc equal to 1 indicates that the luma sample values output by the NNPF are unsigned integer numbers in the range of 0 to (1<<(nnpfc_out_tensor_luma_bitdepth_minus8+8))−1, inclusive, and the chroma sample values output by the NNPF are unsigned integer numbers in the range of 0 to (1<<(nnpfc_out_tensor_chroma_bitdepth_minus8+8))−1, inclusive, and when nnpfc_purpose & 0x40 is not equal to 0, the depth sample values output by the NNPF are unsigned integer numbers in the range of 0 to (1<<(nnpfc_out_tensor_depth_bitdepth_minus8+8))−1, inclusive.

Values of nnpfc_out_format_idc greater than 1 are reserved for future specification by ITU-T|ISO/IEC and shall not be present in bitstreams conforming to this edition of this document. Decoders conforming to this edition of this document shall ignore NNPFC SEI messages that contain reserved values of nnpfc_out_format_idc.

nnpfc_out_tensor_luma_bitdepth_minus8 plus 8 specifies the bit depth of luma sample values in the output integer tensor. The value of nnpfc_out_tensor_luma_bitdepth_minus8 shall be in the range of 0 to 24, inclusive. nnpfc_out_tensor_chroma_bitdepth_minus8 plus 8 specifies the bit depth of chroma sample values in the output integer tensor. The value of nnpfc_out_tensor_chroma_bitdepth_minus8 shall be in the range of 0 to 24, inclusive.

When nnpfc_purpose & 0x10 is not equal to 0, the value of nnpfc_out_format_idc shall be equal to 1 and at least one of the following conditions shall be true:
nnpfc_out_tensor_luma_bitdepth_minus8+8 is greater than BitDepth_{Y}.
nnpfc_out_tensor_chroma_bitdepth_minus8+8 is greater than BitDepth_{C}.

nnpfc_out_tensor_depth_bitdepth_minus8 plus 8 specifies the bit depth of depth sample values in the output integer tensor. The value of nnpfc_out_tensor_depth_bitdepth_minus8 shall be in the range of 0 to 24, inclusive.

nnpfc_out_order_idc indicates the output order of samples resulting from the NNPF.

The value of nnpfc_out_order_idc shall be in the range of 0 to 3 4, inclusive, in bitstreams conforming to this edition of this document. Values of 4 5 to 255, inclusive, for nnpfc_out_order_idc are reserved for future use by ITU-T|ISO/IEC and shall not be present in bitstreams conforming to this edition of this document. Decoders conforming to this edition of this document shall ignore NNPFC SEI messages with nnpfc_out_order_idc in the range of 4 5 to 255, inclusive. Values of nnpfc_out_order_idc greater than 255 shall not be present in bitstreams conforming to this edition of this document and are not reserved for future use.

When nnpfc_purpose & 0x02 is not equal to 0, nnpfc_out_order_idc shall not be equal to 3.

Table 9 contains an informative description of nnpfc_out_order_idc values.

TABLE 9
Description of nnpfc_out_order_idc values

| nnpfc_out_{—} | |
|---|---|
| order_idc | Description |
| 0 | If nnpfc_purpose & 0x40 is equal to 0, only the luma matrix is present in the output tensor, |
| | thus the number of channels is 1. Otherwise (nnpfc_purpose & 0x40 is not equal to 0), the |
| | luma and depth matrices are present in the output tensor, thus the number of channels |
| | is 2. |
| 1 | If nnpfc_purpose & 0x40 is equal to 0, only the chroma matrices are present in the output |
| | tensor, thus the number of channels is 2. Otherwise (nnpfc_purpose & 0x40 is not equal to |
| | 0), the chroma and depth matrices are present in the output tensor, thus the number of |
| | channels is 3. |
| 2 | If nnpfc_purpose & 0x40 is equal to 0, the luma and chroma matrices are present in the |
| | output tensor, thus the number of channels is 3. Otherwise (nnpfc_purpose & 0x40 is not |
| | equal to 0), the luma, chroma, and depth matrices are present in the output tensor, thus |
| | the number of channels is 4. |
| 3 | If nnpfc_purpose & 0x40 is equal to 0, four luma matrices and two chroma matrices are |
| | present in the output tensor, thus the number of channels is 6. Otherwise (nnpfc_purpose & |
| | 0x40 is not equal to 0), four luma matrices and two chroma matrices and four depth |
| | matrices are present in the output tensor, thus the number of channels is 10. |
| | nnpfc_out_order_idc equal to 3 can only be used when the output chroma format is 4:2:0. |
| 4 | Only the depth matrix is present in the output tensor, thus the number of channels is 1. |
| | nnpfc_out_order_idc equal to 4 can only be used when nnpfc_purpose & 0x40 is not |
| | equal to 0. |
| 4 5 . . . 255 | Reserved |

The process StoreOutputTensors ( ) for deriving sample values in the filtered output sample arrays FilteredYPic. FilteredChPic. and FilteredCrPic from the output tensor outputTensor for a given vertical sample coordinate cTop and a horizontal sample coordinate cLeft specifying the top-left sample location for the patch of samples included in the input tensor, is specified as follows:

```
  for( i = 0; i < numOutputPics; i++ ) {
    if( nnpfc_out_order_idc = = 0 )
      for( yP = 0; yP < outPatchHeight; yP++)
        for( xP = 0; xP < outPatchWidth; xP++ ) {
          yY = cTop * outPatchHeight / inpPatchHeight + yP
          xY = cLeft * outPatchWidth / inpPatchWidth + xP
          if ( yY < nnpfc_pic_height_in_luma_samples && xY < nnpfc_pic_width_in_luma_samples )
            if( !nnpfc_component_last_flag ) {
              FilteredYPic[ i ][ xY ][yY ] = outputTensor[ 0 ][ i ][ 0 ][ yP ][ xP ]
              if( ( nnpfc_{—}purpose & 0x40 ) != 0 )
                FilteredDPic[ i ][ xY ][yY ] = outputTensor[ 0 ][ i ][ 1 ][ yP ][ xP ]
            } else {
              FilteredYPic[ i ][ xY ][ yY ] = outputTensor[ 0 ][ i ][ yP ][ xP ][ 0 ]
              if( ( nnpfc_{—}purpose & 0x40 ) != 0 )
                FilteredDPic[ i ][ xY ][yY ] = outputTensor[ 0 ][ i ][ yP ][ xP ][ 1 ]
            }
        }
    else if( nnpfc_out_order_idc = = 1 ) { (85)
      for( yP = 0; yP < outPatchCHeight; yP++)
        for( xP = 0; xP < outPatchCWidth; xP++ ) {
          xSrc = cLeft * horCScaling + xP
          ySrc = cTop * verCScaling + yP
          if ( ySrc < nnpfc_pic_height_in_luma_samples / outSubHeightC &&
              xSrc < nnpfc_pic_width_in_luma_samples / outSubWidthC )
            if( !nnpfc_component_last_flag ) {
              FilteredCbPic[ i ][ xSrc ][ ySrc ] = outputTensor[ 0 ][ i ][ 0 ][ yP ][ xP ]
              FilteredCrPic[ i ][ xSrc ][ ySrc ] = outputTensor[ 0 ][ i ][ 1 ][ yP ][ xP ]
            } else {
              FilteredCbPic[ i ][ xSrc ][ ySrc ] = outputTensor[ 0 ][ i ][ yP ][ xP ][ 0 ]
              FilteredCrPic[ i ][ xSrc ][ ySrc ] = outputTensor[ 0 ][ i ][ yP ][ xP ][ 1 ]
            }
        }
      if( ( nnpfc_{—}purpose & 0x40 ) != 0 ) {
        for( yP = 0; yP < outPatchHeight; yP++)
          for( xP = 0; xP < outPatchWidth; xP++ ) {
            yY = cTop * outPatchHeight / inpPatchHeight + yP
            xY = cLeft * outPatchWidth / inpPatchWidth + xP
            if ( yY < nnpfc_{—}pic_{—}height_{—}in_{—}luma_{—}samples && xY <
  nnpfc_{—}pic_{—}width_{—}in_{—}luma_{—}samples )
              if( !nnpfc_{—}component_{—}last_{—}flag )
                FilteredDPic[ i ][ xY ][yY ] = outputTensor[ 0 ][ i ][ 2 ][ yP ][ xP ]
              else
                FilteredDPic[ i ][ xY ][yY ] = outputTensor[ 0 ][ i ][ yP ][ xP ][ 2 ]
      }
    }
    else if( nnpfc_out_order_idc = = 2 )
      for( yP = 0; yP < outPatchHeight; yP++)
        for( xP = 0; xP < outPatchWidth; xP++ ) {
          yY = cTop * outPatchHeight / inpPatchHeight + yP
          xY = cLeft * outPatchWidth / inpPatchWidth + xP
          yC = yY / outSubHeightC
          xC = xY / outSubWidthC
          yPc = ( yP / outSubHeightC ) * outSubHeightC
          xPc = ( xP / outSubWidthC ) * outSubWidthC
          if ( yY < nnpfc_pic_height_in_luma_samples && xY < nnpfc_pic_width_in_luma_samples)
            if( !nnpfc_component_last_flag ) {
              FilteredYPic[ i ][ xY ][ yY ] = outputTensor[ 0 ][ i ][ 0 ][ yP ][ xP ]
              FilteredCbPic[ i ][ xC ][ yC ] = outputTensor[ 0 ][ i ][ 1 ][ yPc ][ xPc ]
              FilteredCrPic[ i ][ xC ][ yC ] = outputTensor[ 0 ][ i ][ 2 ][ yPc ][ xPc ]
              if( ( nnpfc_{—}purpose & 0x40 ) != 0 )
                FilteredDPic[ i ][ xY ][ yY ] = outputTensor[ 0 ][ i ][ 3 ][ yP ][ xP ]
            } else {
              FilteredYPic[ i ][ xY ][ yY ] = outputTensor[ 0 ][ i ][ yP ][ xP ][ 0 ]
              FilteredCbPic[ i ][ xC ][ yC ] = outputTensor[ 0 ][ i ][ yPc ][ xPc ][ 1 ]
              FilteredCrPic[ i ][ xC ][ yC ] = outputTensor[ 0 ][ i ][ yPc ][ xPc ][ 2 ]
              if( ( nnpfc_{—}purpose & 0x40 ) != 0 )
                FilteredDPic[ i ][ xY ][ yY ] = outputTensor[ 0 ][ i ][ yP ][ xP ][ 3 ]
            }
        }
    else if( nnpfc_out_order_idc = = 3 )
      for( yP = 0; yP < outPatchHeight; yP++ )
        for( xP = 0; xP < outPatchWidth; xP++ ) {
          ySrc = cTop / 2 * outPatchHeight / inpPatchHeight + yP
          xSrc = cLeft / 2 * outPatchWidth / inpPatchWidth + xP
          if ( ySrc < nnpfc_pic_height_in_luma_samples / 2 &&
              xSrc < nnpfc_pic_width_in_luma_samples / 2 )
            if( !nnpfc_component_last_flag ) {
              FilteredYPic[ i ][ xSrc * 2 ][ ySrc * 2 ] = outputTensor[ 0 ][ i ][ 0 ][ yP ][ xP ]
              FilteredYPic[ i ][ xSrc * 2 + 1 ][ ySrc * 2 ] = outputTensor[ 0 ][ i ][ 1 ][ yP ][ xP ]
              FilteredYPic[ i ][ xSrc * 2 ][ ySrc * 2 + 1 ] = outputTensor[ 0 ][ i ][ 2 ][ yP ][ xP ]
              FilteredYPic[ i ][ xSrc * 2 + 1][ ySrc * 2 + 1 ] = outputTensor[ 0 ][ i ][ 3 ][ yP ][ xP ]
              FilteredCbPic[ i ][ xSrc ][ ySrc ] = outputTensor[ 0 ][ i ][ 4 ][ yP ][ xP ]
              FilteredCrPic[ i ][ xSrc ][ ySrc ] = outputTensor[ 0 ][ i ][ 5 ][ yP ][ xP ]
              if( ( nnpfc_{—}purpose & 0x40 ) != 0 ) {
                FilteredDPic[ i ][ xSrc * 2 ][ ySrc * 2 ] = outputTensor[ 0 ][ i ][ 6 ][ yP ][ xP ]
                FilteredDPic[ i ][ xSrc * 2 + 1 ][ ySrc * 2 ] = outputTensor[ 0 ][ i ][ 7 ][ yP ][ xP ]
                FilteredDPic[ i ][ xSrc * 2 ][ ySrc * 2 + 1 ] = outputTensor[ 0 ][ i ][ 8 ][ yP ][ xP ]
                FilteredDPic[ i ][ xSrc * 2 + 1][ ySrc * 2 + 1 ] = outputTensor[ 0 ][ i ][ 9 ][ yP ][ xP ]
              }
            } else {
              FilteredYPic[ i ][ xSrc * 2 ][ ySrc * 2 ] = outputTensor[ 0 ][ i ][ yP ][ xP ][ 0 ]
              FilteredYPic[ i ][ xSrc * 2 + 1 ][ ySrc * 2 ] = outputTensor[ 0 ][ i ][ yP ][ xP ][ 1 ]
              FilteredYPic[ i ][ xSrc * 2 ][ ySrc * 2 + 1 ] = outputTensor[ 0 ][ i ][ yP ][ xP ][ 2 ]
              FilteredYPic[ i ][ xSrc * 2 + 1][ ySrc * 2 + 1 ] = outputTensor[ 0 ][ i ][ yP ][ xP ][ 3 ]
              FilteredCbPic[ i ][ xSrc ][ ySrc ] = outputTensor[ 0 ][ i ][ yP ][ xP ][ 4 ]
              FilteredCrPic[ i ][ xSrc ][ ySrc ] = outputTensor[ 0 ][ i ][ yP ][ xP ][ 5 ]
              if( ( nnpfc_{—}purpose & 0x40 ) != 0 ) {
                FilteredDPic[ i ][ xSrc * 2 ][ ySrc * 2 ] = outputTensor[ 0 ][ i ][ yP ][ xP ][ 6 ]
                FilteredDPic[ i ][ xSrc * 2 + 1 ][ ySrc * 2 ] = outputTensor[ 0 ][ i ][ yP ][ xP ][ 7 ]
                FilteredDPic[ i ][ xSrc * 2 ][ ySrc * 2 + 1 ] = outputTensor[ 0 ][ i ][ yP ][ xP ][ 8 ]
                FilteredDPic[ i ][ xSrc * 2 + 1][ ySrc * 2 + 1 ] = outputTensor[ 0 ][ i ][ yP ][ xP ][ 9 ]
              }
            }
        }
    else if( nnpfc_{—}out_{—}order_{—}idc = = 4 )
      for( yP = 0; yP < outPatchHeight; yP++)
        for( xP = 0; xP < outPatchWidth; xP++ ) {
          yY = cTop * outPatchHeight / inpPatch Height + yP
          xY = cLeft * outPatchWidth / inpPatchWidth + xP
          if ( yY < nnpfc_{—}pic_{—}height_{—}in_{—}luma_{—}samples && xY <
  nnpfc_{—}pic_{—}width_{—}in_{—}luma_{—}samples )
            if( !nnpfc_{—}component_{—}last_{—}flag )
              FilteredDPic[ i ][ xY ][yY ] = outputTensor[ 0 ][ i ][ 0 ][ yP ][ xP ]
            else
              FilteredDPic[ i ][ xY ][ yY ] = outputTensor[ 0 ][ i ][ yP ][ xP ][ 0 ]
        }
  }
...
```

nnpfc_padding_type indicates the process of padding when referencing sample locations outside the boundaries of the cropped decoded output picture as described in Table 10. The value of nnpfc_padding_type shall be in the range of 0 to 15, inclusive.

TABLE 10
Informative description of nnpfc_padding_type values

| nnpfc_padding_type | Description |
|---|---|
| 0 | zero padding |
| 1 | replication padding |
| 2 | reflection padding |
| 3 | wrap-around padding |
| 4 | fixed padding |
| 5 . . . 15 | Reserved |

nnpfc_luma_padding_val indicates the luma value to be used for padding when nnpfc_padding_type is equal to 4.

nnpfc_cb_padding_val indicates the Cb value to be used for padding when nnpfc_padding_type is equal to 4.

nnpfc_cr_padding_val indicates the Cr value to be used for padding when nnpfc_padding_type is equal to 4.

nnpfc_depth_padding_val indicates the depth value to be used for padding when nnpfc_padding_type is equal to 4.

The value of nnpfc_depth_padding_val shall be in the range of 0 to 2^{nnpfc_inp_tensor_depth_bitdepth_minus8+8}−1, inclusive.

The function InpSampleVal (y, x, picHeight, picWidth, croppedPic) with inputs being a vertical sample location y, a horizontal sample location x, a picture height picHeight, a picture width picWidth, and sample array croppedPic returns the value of sample Val derived as follows:
NOTE 6—For the inputs to the function InpSampleVal( ) the vertical location is listed before the horizontal location for compatibility with input tensor conventions of some inference engines.

```
  If( nnpfc_padding_type = = 0 )
    if( y < 0 || x < 0 || y >= picHeight || x >= picWidth )
      sampleVal = 0
    else
      sampleVal = croppedPic[ x ][ y ] (92)
  else if( nnpfc_padding_type = = 1 )
    sampleVal = croppedPic[ Clip3( 0, picWidth − 1, x) ][ Clip3( 0,
    picHeight − 1, y) ]
  else if( nnpfc_padding_type = = 2 )
    sampleVal = croppedPic[ Reflect( picWidth − 1, x ) ][ Reflect(
    picHeight − 1, y ) ]
  else if( nnpfc_padding_type = = 3 )
    if( y >= 0 && y < picHeight )
      sampleVal = croppedPic[ Wrap( picWidth − 1, x ) ][ y ]
  else if( nnpfc_padding_type = = 4 )
    if( y < 0 || x < 0 || y >= picHeight || x >= picWidth ) {
      sampleVal[ 0 ] = nnpfc_luma_padding_val
      sampleVal[ 1 ] = nnpfc_cb_padding_val
      sampleVal[ 2 ] = nnpfc_cr_padding_val
      if( nnpfc_{—}depth_{—}input_{—}flag )
        sampleVal[ 3 ] = nnpfc_{—}depth_{—}padding_{—}val
    } else
      sampleVal = croppedPic[ x ][ y ]
...
```

### 6.3 Embodiment 3

This embodiment is for the items 2 and all their subitems, summarized above in Section 5.

### 8.28.1 Neural-Network Post-Filter Characteristics SEI Message Syntax

| | Descriptor |
|---|---|
| nn_post_filter_characteristics( payloadSize ) { | |
| ... | |
| nnpfc_{—}input_{—}depth_{—}flag | u(1) |
| nnpfc_component_last_flag | u(1) |
| nnpfc_inp_format_idc | ue(v) |
| if( nnpfc_inp_format_idc = = 1 ) { | |
| nnpfc_inp_tensor_luma_bitdepth_minus8 | ue(v) |
| nnpfc_inp_tensor_chroma_bitdepth_minus8 | ue(v) |
| if( nnpfc_{—}input_{—}depth_{—}flag ) | |
| nnpfc_{—}inp_{—}tensor_{—}depth_{—}bitdepth_{—}minus8 | ue(v) |
| } | |
| nnpfc_inp_order_idc | ue(v) |
| ... | |
| nnpfc_out_format_idc | ue(v) |
| if( nnpfc_out_format_idc = = 1 ) { | |
| nnpfc_out_tensor_luma_bitdepth_minus8 | ue(v) |
| nnpfc_out_tensor_chroma_bitdepth_minus8 | ue(v) |
| } | |
| nnpfc_out_order_idc | ue(v) |
| ... | |
| nnpfc_padding_type | ue(v) |
| if( nnpfc_padding_type = = 4 ) { | |
| nnpfc_luma_padding_val | ue(v) |
| nnpfc_cb_padding_val | ue(v) |
| nnpfc_cr_padding_val | ue(v) |
| if( nnpfc_{—}input_{—}depth_{—}flag ) | |
| nnpfc_{—}depth_{—}padding_{—}val | ue(v) |
| } | |
| ... | |
| } | |

### 8.28.2 Neural-Network Post-Filter Characteristics SEI Message Semantics

The neural-network post-filter characteristics (NNPFC) SEI message specifies a neural network that may be used as a post-processing filter. The use of specified neural-network post-processing filters (NNPFs) for specific pictures is indicated with neural-network post-filter activation (NNPFA) SEI messages.

Use of this SEI message requires the definition of the following variables:
Input picture width and height in units of luma samples, denoted herein by CroppedWidth and CroppedHeight, respectively.
Luma sample array CroppedYPic[idx], and chroma sample arrays CroppedCbPic[idx] and CroppedCrPic[idx], and depth sample array CroppedDPic[idx], when present, of the input pictures with index idx in the range of 0 to numInputPics−1, inclusive, that are used as input for the NNPF.
Bit depth BitDepth_{Y} for the luma sample array of the input pictures.
Bit depth BitDepth_{C} for the chroma sample arrays, if any, of the input pictures.
Bit depth BitDepth for the depth sample arrays, if any, of the input pictures.
A chroma format indicator, denoted herein by ChromaFormatIdc, as described in subclause 7.3.
When nnpfc_auxiliary_inp_idc is equal to 1, a filtering strength control value StrengthControlVal that shall be a real number in the range of 0 to 1, inclusive.

Input picture with index 0 corresponds to the picture for which the NNPFdefined by this NNPFC SEI message is activated by an NNPFA SEI message. Input picture with index i in the range of 1 to numInputPics−1, inclusive, precedes the input picture with index i−1 in output order.

When nnpfc_purpose & 0x08 is not equal to 0 and the input picture with index 0 is associated with a frame packing arrangement SEI message with fp_arrangement_type equal to 5, all input pictures are associated with a frame packing arrangement SEI message with fp_arrangement_type equal to 5 and the same value of fp_current_frame_is_frame0_flag.

nnpfc_input_depth_flag equal to 1 indicates that depth pictures associated with the cropped decoded output picture are used as input to the NNPF. nnpfc_input_depth_flag equal to 0 indicates that no depth picture is used as input to the NNPF.

nnpfc_component_last_flag equal to 1 indicates that the last dimension in the input tensor inputTensor to the NNPF and the output tensor outputTensor resulting from the NNPF is used for a current channel. nnpfc_component_last_flag equal to 0 indicates that the third dimension in the input tensor inputTensor to the NNPF and the output tensor outputTensor resulting from the NNPF is used for a current channel.
NOTE 4—The first dimension in the input tensor and in the output tensor is used for the batch index, which is a practice in some neural network frameworks. While formulae in the semantics of this SEI message use the batch size corresponding to the batch index equal to 0, it is up to the post-processing implementation to determine the batch size used as input to the neural network inference.
NOTE 5—For example, when nnpfc_inp_order_idc is equal to 3 and nnpfc_auxiliary_inp_idc is equal to 1, there are 7 channels in the input tensor, including four luma matrices, two chroma matrices, and one auxiliary input matrix. In this case, the process DeriveInputTensors( ) would derive each of these 7 channels of the input tensor one by one, and when a particular channel of these channels is processed, that channel is referred to as the current channel during the process.

nnpfc_inp_format_idc indicates the method of converting a sample value of the cropped decoded output picture to an input value to the NNPF. When nnpfc_inp_format_idc is equal to 0, the input values to the NNPF are real numbers and the functions InpY( ) and, InpC( ) and InpD( ) are specified as follows:

$$InpY ( x ) = x \div ( ( 1 ≪ {BitDepth}_{Y} ) - 1 ) \qquad ( 77 )$$

$$InpC ( x ) = x \div ( ( 1 ≪ {BitDepth}_{C} ) - 1 ) \qquad ( 78 )$$

$$InpD ( x ) = x \div ( ( 1 ≪ {BitDepth}_{D} ) - 1 ) \qquad ( xx )$$

When nnpfc_inp_format_idc is equal to 1, the input values to the NNPF are unsigned integer numbers and the functions InpY( ) and, InpC( ) and InpD( ) are specified as follows:

| shiftY = BitDepth_{Y} − inpTensorBitDepth_{Y} | |
|---|---|
| if( inpTensorBitDepth_{Y} >= BitDepth_{Y} ) | |
| InpY( x ) = x << ( inpTensorBitDepth_{Y} − BitDepth_{Y} ) | (79) |
| else | |
| InpY( x ) = Clip3(0, ( 1 << inpTensorBitDepth_{Y} ) − 1, ( x + ( | |
| 1 << ( shiftY − 1 ) ) ) >> shiftY ) | |
| shiftC = BitDepth_{C} − inpTensorBitDepth_{C} | |
| if( inpTensorBitDepth_{C} >= BitDepth_{C} ) | |
| InpC( x ) = x << ( inpTensorBitDepth_{C} − BitDepth_{C} ) | (80) |
| else | |
| InpC( x ) = Clip3(0, ( 1 << inpTensorBitDepth_{C} ) − 1, ( x + ( | |
| 1 << (shiftC − 1 ) ) ) >> shiftC ) | |
| shiftD = BitDepth_{D} − inpTensorBitDepth_{D} | |
| if( inpTensorBitDepth_{D} >= BitDepth_{D} ) | |
| InpD( x ) = x << ( inpTensorBitDepth_{D} − BitDepth_{D} ) | (xx) |

else
InpD( x ) = Clip3(0, ( 1 << inpTensorBitDepth_{D} ) − 1, ( x + (
1 << ( shiftD − 1 ) ) ) >> shiftD )

The variable inpTensorBitDepth_{Y} is derived from the syntax element nnpfc_inp_tensor_luma_bitdepth_minus8 as specified below. The variable inpTensorBitDepth_{C} is derived from the syntax element nnpfc_inp_tensor_chroma_bitdepth_minus8 as specified below. The variable inpTensorBitDepth_{D} is derived from the syntax element nnpfc_inp_tensor_depth_bitdepth_minus8 as specified below.

Values of nnpfc_inp_format_idc greater than 1 are reserved for future specification by ITU-T|ISO/IEC and shall not be present in bitstreams conforming to this edition of this document. Decoders conforming to this edition of this document shall ignore NNPFC SEI messages that contain reserved values of nnpfc_inp_format_idc.

nnpfc_inp_tensor_luma_bitdepth_minus8 plus 8 specifies the bit depth of luma sample values in the input integer tensor. The value of inpTensorBitDepth_{Y} is derived as follows:

$${inpTensorBitDepth}_{Y} = nnpfc\_inp \_tensor \_luma \_bitdepth \_minus8 + 8 \qquad ( 81 )$$

It is a requirement of bitstream conformance that the value of nnpfc_inp_tensor_luma_bitdepth_minus8 shall be in the range of 0 to 24, inclusive.

nnpfc_inp_tensor_chroma_bitdepth_minus8 plus 8 specifies the bit depth of chroma sample values in the input integer tensor. The value of inpTensorBitDepth_{C} is derived as follows:

$${inpTensorBitDepth}_{C} = nnpfc\_inp \_tensor \_chroma \_bitdepth \_minus8 + 8 \qquad ( 82 )$$

It is a requirement of bitstream conformance that the value of nnpfc_inp_tensor_chroma_bitdepth_minus8 shall be in the range of 0 to 24, inclusive.

nnpfc_inp_tensor_depth_bitdepth_minus8 plus 8 specifies the bit depth of depth sample values in the input integer tensor. The value of inpTensorBitDepth_{D} is derived as follows:

$${inpTensorBitDepth}_{D} = nnpfc\_inp \_tensor \_depth \_bitdepth \_minus8 + 8 \qquad ( xx )$$

nnpfc_inp_order_idc indicates the method of ordering the sample arrays of a cropped decoded output picture as one of the input pictures to the NNPF.

The value of nnpfc_inp_order_idc shall be in the range of 0 to 3, inclusive, in bitstreams conforming to this edition of this document. Values of 4 to 255, inclusive, for nnpfc_inp_order_idc are reserved for future use by ITU-T|ISO/IEC and shall not be present in bitstreams conforming to this edition of this document. Decoders conforming to this edition of this document shall ignore NNPFC SEI messages with nnpfc_inp_order_idc in the range of 4 to 255, inclusive. Values of nnpfc_inp_order_idc greater than 255 shall not be present in bitstreams conforming to this edition of this document and are not reserved for future use.

When ChromaFormatIdc is not equal to 1, nnpfc_inp_order_idc shall not be equal to 3.

Table 11 contains an informative description of nnpfc_inp_order_idc values.

TABLE 11
Description of nnpfc_inp_order_idc values

| nnpfc_inp_{—} | |
|---|---|
| order_idc | Description |
| 0 | If nnpfc_input_depth_flag is equal to 0, the following applies: if If |
| | nnpfc_auxiliary_inp_idc is equal to 0, one luma matrix is present in the input tensor for |
| | each input picture, and the number of channels is 1; otherwise when |
| | nnpfc_auxiliary_inp_idc is equal to 1, one luma matrix and one auxiliary input matrix are |
| | present, and the number of channels is 2. |
| | Otherwise (nnpfc_input_depth_flag is equal to 1), the following applies: if |
| | nnpfc_auxiliary_inp_idc is equal to 0, one luma matrix and one depth matrix are |
| | present in the input tensor for each input picture, and the number of channels is 2; |
| | otherwise when nnpfc_auxiliary_inp_idc is equal to 1, one luma matrix, one depth |
| | matrix and one auxiliary input matrix are present, and the number of channels is 3. |
| 1 | If nnpfc_input_depth_flag is equal to 0, the following applies: if If |
| | nnpfc_auxiliary_inp_idc is equal to 0, two chroma matrices are present in the input |
| | tensor, and the number of channels is 2. Otherwise when nnpfc_auxiliary_inp_idc is |
| | equal to 1, two chroma matrices and one auxiliary input matrix are present, and the |
| | number of channels is 3. |
| | Otherwise (nnpfc_input_depth_flag is equal to 1), the following applies: if |
| | nnpfc_auxiliary_inp_idc is not equal to 0, two chroma matrices and one depth |
| | matrix are present in the input tensor, and the number of channels is 3. Otherwise |
| | when nnpfc_auxiliary_inp_idc is equal to 1, two chroma matrices, one depth |
| | matrix, and one auxiliary input matrix are present, and the number of channels is |
| | 4. |
| 2 | If nnpfc_input_depth_flag is equal to 0, the following applies: if If |
| | nnpfc_auxiliary_inp_idc is equal to 0, one luma and two chroma matrices are present in |
| | the input tensor, and the number of channels is 3. Otherwise when |
| | nnpfc_auxiliary_inp_idc is equal to 1, one luma matrix, two chroma matrices and one |
| | auxiliary input matrix are present, and the number of channels is 4. |
| | Otherwise (nnpfc_input_depth_flag is equal to 1), the following applies: if |
| | nnpfc_auxiliary_inp_idc is equal to 0, one luma, two chroma matrices, and one |
| | depth matrix are present in the input tensor, and the number of channels is 4. |
| | Otherwise when nnpfc_auxiliary_inp_idc is equal to 1, one luma matrix, two |
| | chroma matrices, one depth matrix and one auxiliary input matrix are present, and |
| | the number of channels is 5. |
| 3 | If nnpfc_input_depth_flag is equal to 0, the following applies: if If |
| | nnpfc_auxiliary_inp_idc is equal to 0, four luma matrices and two chroma matrices are |
| | present in the input tensor, and the number of channels is 6. Otherwise when |
| | nnpfc_auxiliary_inp_idc is equal to 1, four luma matrices, two chroma matrices, and one |
| | auxiliary input matrix are present in the input tensor, and the number of channels is 7. |
| | Otherwise (nnpfc_input_depth_flag is equal to 1), the following applies: if |
| | nnpfc_auxiliary_inp_idc is equal to 0, four luma matrices, two chroma matrices, |
| | and one depth matrix are present in the input tensor, and the number of channels is |
| | 10. Otherwise when nnpfc_auxiliary_inp_idc is equal to 1, four luma matrices, two |
| | chroma matrices, and one auxiliary input matrix are present in the input tensor, |
| | and the number of channels is 11. |
| | The luma channels are derived in an interleaved manner as illustrated in FIG. 4. This |
| | nnpfc_inp_order_idc can only be used when the input chroma format is 4:2:0. |
| 4 . . . 255 | Reserved |

FIG. 4 is an illustration of deriving the four luma channels (right) from the luma component (left) when nnpfc_inp_order_idc is equal to 3.

A patch is a rectangular array of samples from a component (e.g., a luma or chroma component) of a picture. nnpfc_auxiliary_inp_idc greater than 0 indicates that auxiliary input data is present in the input tensor of the NNPF. nnpfc_auxiliary_inp_idc equal to 0 indicates that auxiliary input data is not present in the input tensor. nnpfc_auxiliary_inp_idc equal to 1 specifies that auxiliary input data is derived as specified in Formula 84. The value of nnpfc_auxiliary_inp_idc shall be in the range of 0 to 1, inclusive, in bitstreams conforming to this edition of this document. Values of 2 to 255, inclusive, for nnpfc_inp_order_idc are reserved for future use by ITU-T|ISO/IEC and shall not be present in bitstreams conforming to this edition of this document. Decoders conforming to this edition of this document shall ignore NNPFC SEI messages with nnpfc_inp_order_idc in the range of 2 to 255, inclusive. Values of nnpfc_inp_order_idc greater than 255 shall not be present in bitstreams conforming to this edition of this document and are not reserved for future use.

When nnpfc_auxiliary_inp_idc is equal to 1, the variable strengthControlScaledVal is derived as follows:

```
if( nnpfc_inp_format_idc = = 1 )
  strengthControlScaledVal = Floor ( StrengthControlVal * ( ( 1 <<
  inpTensorBitDepth_{Y} ) − 1 ) ) (83)
else
  strengthControlScaledVal = StrengthControlVal
```

The process DeriveInputTensors( ) for deriving the input tensor inputTensor for a given vertical sample coordinate cTop and a horizontal sample coordinate cLeft specifying the top-left sample location for the patch of samples included in the input tensor, is specified as follows:

```
  for( i = 0; i < numInputPics; i++ ) {
    if( nnpfc_inp_order_idc = = 0 )
      for( yP = −nnpfc_overlap; yP < inpPatchHeight + nnpfc_overlap; yP++)
        for( xP = −nnpfc_overlap; xP < inpPatchWidth + nnpfc_overlap; xP++ ) {
```

```
inpVal = InpY( InpSampleVal( cTop + yP, cLeft + xP, CroppedHeight,
    CroppedWidth, CroppedYPic[ i ] ) )
yPovlp = yP + nnpfc_overlap
xPovlp = xP + nnpfc_overlap
if( nnpfc_{—}input_{—}depth_{—}flag ) {
  inpDVal = InpD( InpSampleVal( cTop + yP, cLeft + xP, CroppedHeight,
    CroppedWidth, CroppedDPic[ i ] ) )
  if( !nnpfc_{—}component_{—}last_{—}flag ) {
    inputTensor[ 0 ][ i ][ 0 ][ yPovlp ][ xPovlp ] = inpVal
    inputTensor[ 0 ][ i ][ 1 ][ yPovlp ][ xPovlp ] = inpDVal
  } else {
    inputTensor[ 0 ][ i ][ yPovlp ][ xPovlp ][ 0 ] = inpVal
    inputTensor[ 0 ][ i ][ yPovlp ][ xPovlp ][ 1 ] = inpDVal
  }
    if( nnpfc_{—}auxiliary_{—}inp_{—}idc = = 1 )
    if( !nnpfc_{—}component_{—}last_{—}flag )
      inputTensor[ 0 ][ i ][ 2 ][ yPovlp ][ xPovlp ] = strengthControlScaledVal
    else
      inputTensor[ 0 ][ i ][ yPovlp ][ xPovlp ][ 2 ] = strengthControlScaledVal
} else {
  if( !nnpfc_component_last_flag )
    inputTensor[ 0 ][ i ][ 0 ][ yPovlp ][ xPovlp ] = inpVal
  else
    inputTensor[ 0 ][ i ][ yPovlp ][ xPovlp ][ 0 ] = inpVal
  if( nnpfc_auxiliary_inp_idc = = 1 )
    if( !nnpfc_component_last_flag )
      inputTensor[ 0 ][ i ][ 1 ][ yPovlp ][ xPovlp ] = strengthControlScaledVal
    else
      inputTensor[ 0 ][ i ][ yPovlp ][ xPovlp ][ 1 ] = strengthControlScaledVal
}
        }
```

| | |
|---|---|
| else if( nnpfc_inp_order_idc = = 1 ) | (84) |

```
      for( yP = −nnpfc_overlap; yP < inpPatchHeight + nnpfc_overlap; yP++)
        for( xP = −nnpfc_overlap; xP < inpPatchWidth + nnpfc_overlap; xP++ ) {
```

| | |
|---|---|
| — | inpCbVal = InpC( InpSampleVal( cTop + yP, cLeft + xP, CroppedHeight / SubHeightC, |
| | CroppedWidth / SubWidthC, CroppedCbPic[ i ] ) ) |
| | inpCrVal = InpC( InpSampleVal( cTop + yP, cLeft + xP, CroppedHeight / SubHeightC, |
| | CroppedWidth / SubWidthC, CroppedCrPic[ i ] ) ) |
| | yPovlp = yP + nnpfc_{—}overlap |
| | xPovlp = xP + nnpfc_{—}overlap |
| | if( nnpfc_{—}input_{—}depth_{—}flag ) { |
| | yY = cTop + yP |
| | xY = cLeft + xP |
| | yC = yY / SubHeightC |
| | xC = xY / SubWidthC |
| | inpCbVal = InpC( InpSampleVal( yC, xC, CroppedHeight / SubHeightC, |
| | CroppedWidth / SubWidthC, CroppedCbPic[ i ] ) ) |
| | inpCrVal = InpC( InpSampleVal( yC, xC, CroppedHeight / SubHeightC, |
| | CroppedWidth / SubWidthC, CroppedCrPic[ i ] ) ) |
| | inpDVal = InpD( InpSampleVal( yY, xY, CroppedHeight, |
| | CroppedWidth, CroppedDPic[ i ] ) ) |
| | yPovlp = yP + nnpfc_{—}overlap |
| | xPovlp = xP + nnpfc_{—}overlap |
| | if( !nnpfc_{—}component_{—}last_{—}flag ) { |
| | inputTensor[ 0 ][ i ][ 0 ][ yPovlp ][ xPovlp ] = inpCbVal |
| | inputTensor[ 0 ][ i ][ 1 ][ yPovlp ][ xPovlp ] = inpCrVal |
| | inputTensor[ 0 ][ i ][ 2 ][ yPovlp ][ xPovlp ] = inpDVal |
| | } else { |
| | inputTensor[ 0 ][ i ][ yPovlp ][ xPovlp ][ 0 ] = inpCbVal |
| | inputTensor[ 0 ][ i ][ yPovlp ][ xPovlp ][ 1 ] = inpCrVal |
| | inputTensor[ 0 ][ i ][ yPovlp ][ xPovlp ][ 2 ] = inpDVal |
| | } |
| | if( nnpfc_{—}auxiliary_{—}inp_{—}idc = = 1 ) |
| | if( !nnpfc_{—}component_{—}last_{—}flag ) |
| | inputTensor[ 0 ][ i ][ 3 ][ yPovlp ][ xPovlp ] = strength ControlScaledVal |
| | else |
| | inputTensor[ 0 ][ i ][ yPovlp ][ xPovlp ][ 3 ] = strengthControlScaledVal |
| | } else { |
| | inpCbVal = InpC( InpSampleVal( cTop + yP, cLeft + xP, CroppedHeight / |

SubHeightC,

```
      CroppedWidth / SubWidthC, CroppedCbPic[ i ] ) )
  inpCrVal = InpC( InpSampleVal( cTop + yP, cLeft + xP, CroppedHeight / SubHeightC,
      CroppedWidth / SubWidthC, CroppedCrPic[ i ] ) )
  yPovlp = yP + nnpfc_{—}overlap
  xPovlp = xP + nnpfc_{—}overlap
  if( !nnpfc_component_last_flag ) {
    inputTensor[ 0 ][ i ][ 0 ][ yPovlp ][ xPovlp ] = inpCbVal
    inputTensor[ 0 ][ i ][ 1 ][ yPovlp ][ xPovlp ] = inpCrVal
  } else {
    inputTensor[ 0 ][ i ][ yPovlp ][ xPovlp ][ 0 ] = inpCbVal
    inputTensor[ 0 ][ i ][ yPovlp ][ xPovlp ][ 1 ] = inpCrVal
  }
  if( nnpfc_auxiliary_inp_idc = = 1 )
    if( !nnpfc_component_last_flag )
      inputTensor[ 0 ][ i ][ 2 ][ yPovlp ][ xPovlp ] = strengthControlScaledVal
    else
      inputTensor[ 0 ][ i ][ yPovlp ][ xPovlp ][ 2 ] = strengthControlScaledVal
}
```

```
        }
    else if( nnpfc_inp_order_idc = = 2 )
      for( yP = −nnpfc_overlap; yP < inpPatchHeight + nnpfc_overlap; yP++)
        for( xP = −nnpfc_overlap; xP < inpPatchWidth + nnpfc_overlap; xP++ ) {
```

```
yY = cTop + yP
xY = cLeft + xP
yC = yY / SubHeightC
xC = xY / SubWidthC
inp YVal = InpY( InpSampleVal( yY, xY, CroppedHeight,
    CroppedWidth, CroppedYPic[ i ] ) )
inpCbVal = InpC( InpSampleVal( yC, xC, CroppedHeight / SubHeightC,
    CroppedWidth / SubWidthC, CroppedCbPic[ i ] ) )
inpCrVal = InpC( InpSampleVal( yC, xC, CroppedHeight / SubHeightC,
    CroppedWidth / SubWidthC, CroppedCrPic[ i ] ) )
yPovlp = yP + nnpfc_overlap
xPovlp = xP + nnpfc_overlap
if( nnpfc_{—}input_{—}depth_{—}flag ) {
  inpDVal = InpD( InpSampleVal( yY, xY, CroppedHeight,
      CroppedWidth, CroppedDPic[ i ] ) )
  if( !nnpfc_{—}component_{—}last_{—}flag ) {
    inputTensor[ 0 ][ i ][ 0 ][ yPovlp ][ xPovlp ] = inpYVal
    inputTensor[ 0 ][ i ][ 1 ][ yPovlp ][ xPovlp ] = inpCbVal
    inputTensor[ 0 ][ i ][ 2 ][ yPovlp ][ xPovlp ] = inpCrVal
    inputTensor[ 0 ][ i ][ 3 ][ yPovlp ][ xPovlp ] = inpDVal
  } else {
    inputTensor[ 0 ][ i ][ yPovlp ][ xPovlp ][ 0 ] = inpYVal
    inputTensor[ 0 ][ i ][ yPovlp ][ xPovlp ][ 1 ] = inpCbVal
    inputTensor[ 0 ][ i ][ yPovlp ][ xPovlp ][ 2 ] = inpCrVal
    inputTensor[ 0 ][ i ][ yPovlp ][ xPovlp ][ 3 ] = inpDVal
  }
  if( nnpfc_{—}auxiliary_{—}inp_{—}idc = = 1 )
    if( !nnpfc_{—}component_{—}last_{—}flag )
      inputTensor[ 0 ][ i ][ 4 ][ yPovlp ][ xPovlp ] = strength ControlScaledVal
    else
      inputTensor[ 0 ][ i ][ yPovlp ][ xPovlp ][ 4 ] = strengthControlScaledVal
} else {
  if( !nnpfc_component_last_flag ) {
    inputTensor[ 0 ][ i ][ 0 ][ yPovlp ][ xPovlp ] = inpYVal
    inputTensor[ 0 ][ i ][ 1 ][ yPovlp ][ xPovlp ] = inpCbVal
    inputTensor[ 0 ][ i ][ 2 ][ yPovlp ][ xPovlp ] = inpCrVal
  } else {
    inputTensor[ 0 ][ i ][ yPovlp ][ xPovlp ][ 0 ] = inpYVal
    inputTensor[ 0 ][ i ][ yPovlp ][ xPovlp ][ 1 ] = inpCbVal
    inputTensor[ 0 ][ i ][ yPovlp ][ xPovlp ][ 2 ] = inpCrVal
  }
  if( nnpfc_auxiliary_inp_idc = = 1 )
    if( !nnpfc_component_last_flag )
      inputTensor[ 0 ][ i ][ 3 ][ yPovlp ][ xPovlp ] = strengthControlScaledVal
    else
      inputTensor[ 0 ][ i ][ yPovlp ][ xPovlp ][ 3 ] = strengthControlScaledVal
}
```

```
        }
    else if( nnpfc_inp_order_idc = = 3 )
      for( yP = −nnpfc_overlap; yP < inpPatchHeight + nnpfc_overlap; yP++)
        for( xP = −nnpfc_overlap; xP < inpPatchWidth + nnpfc_overlap; xP++ ) {
```

```
yTL = cTop + yP * 2
xTL = cLeft + xP * 2
yBR = yTL + 1
xBR = xTL + 1
yC = cTop / 2 + yP
xC = cLeft / 2 + xP
inpTLVal = InpY( InpSampleVal( yTL, xTL, CroppedHeight,
    CroppedWidth, CroppedYPic[ i ] ) )
inpTRVal = InpY( InpSampleVal( yTL, xBR, CroppedHeight,
    CroppedWidth, CroppedYPic[ i ] ) )
inpBLVal = InpY( InpSampleVal( yBR, xTL, CroppedHeight,
    CroppedWidth, CroppedYPic[ i ] ) )
inpBRVal = InpY( InpSampleVal( yBR, xBR, CroppedHeight,
    CroppedWidth, CroppedYPic[ i ] ) )
inpCbVal = InpC( InpSampleVal( yC, xC, CroppedHeight / 2,
    CroppedWidth / 2, CroppedCbPic[ i ] ) )
inpCrVal = InpC( InpSampleVal( yC, xC, CroppedHeight / 2,
    CroppedWidth / 2, CroppedCrPic[ i ] ) )
yPovlp = yP + nnpfc_overlap
xPovlp = xP + nnpfc_overlap
if( nnpfc_{—}input_{—}depth_{—}flag ) {
        inpDTLVal = InpD( InpSampleVal( yTL, xTL, CroppedHeight,
```

CroppedWidth, CroppedDPic[ i ] ) )

inpDTRVal = InpD( InpSampleVal( yTL, xBR, CroppedHeight,

CroppedWidth, CroppedDPic[ i ] ) )

inpDBLVal = InpD( InpSampleVal( yBR, xTL, CroppedHeight,

CroppedWidth, CroppedDPic[ i ] ) )

inpDBRVal = InpD( InpSampleVal( yBR, xBR, CroppedHeight,

CroppedWidth, CroppedDPic[ i ] ) )

if( !nnpfc_{—}component_{—}last_{—}flag ) {

inputTensor[ 0 ][ i ][ 0 ][ yPovlp ][ xPovlp ] =

inpTLVal

inputTensor[ 0 ][ i ][ 1 ][ yPovlp ][ xPovlp ] =

inpTRVal

inputTensor[ 0 ][ i ][ 2 ][ yPovlp ][ xPovlp ] =

inpBLVal

inputTensor[ 0 ][ i ][ 3 ][ yPovlp ][ xPovlp ] =

inpBRVal

inputTensor[ 0 ][ i ][ 4 ][ yPovlp ][ xPovlp ] =

inpCbVal

inputTensor[ 0 ][ i ][ 5 ][ yPovlp ][ xPovlp ] =

inpCrVal

inputTensor[ 0 ][ i ][ 6 ][ yPovlp ][ xPovlp ] =

inpDTLVal

inputTensor[ 0 ][ i ][ 7 ][ yPovlp ][ xPovlp ] =

inpDTRVal

inputTensor[ 0 ][ i ][ 8 ][ yPovlp ][ xPovlp ] =

inpDBLVal

inputTensor[ 0 ][ i ][ 9 ][ yPovlp ][ xPovlp ] =

inpDBRVal

```
  } else {
      inputTensor[ 0 ][ i ][ yPovlp ][ xPovlp ][ 0 ] =
```

inpTLVal

inputTensor[ 0 ][ i ][ yPovlp ][ xPovlp ][ 1 ] =

inpTRVal

inputTensor[ 0 ][ i ][ yPovlp ][ xPovlp ][ 2 ] =

inpBLVal

inputTensor[ 0 ][ i ][ yPovlp ][ xPovlp ][ 3 ] =

inpBRVal

inputTensor[ 0 ][ i ][ yPovlp ][ xPovlp ][ 4 ] =

inpCbVal

inputTensor[ 0 ][ i ][ yPovlp ][ xPovlp ][ 5 ] =

inpCrVal

input Tensor[ 0 ][ i ][ yPovlp ][ xPovlp ][ 6 ] =

inpDTLVal

input Tensor[ 0 ][ i ][ yPovlp ][ xPovlp ][ 7 ] =

inpDTRVal

inputTensor[ 0 ][ i ][ yPovlp ][ xPovlp ][ 8 ] =

inpDBLVal

inputTensor[ 0 ][ i ][ yPovlp ][ xPovlp ][ 9 ] =

inpDBRVal

}

if( nnpfc_{—}auxiliary_{—}inp_{—}idc = = 1 )

if( !nnpfc_{—}component_{—}last_{—}flag )

inputTensor[ 0 ][ i ][ 10 ][ yPovlp ][ xPovlp ] = strengthControlScaledVal

else

inputTensor[ 0 ][ i ][ yPovlp ][ xPovlp ][ 10 ] = strengthControlScaledVal

} else{

if( !nnpfc_component_last_flag ) {
inputTensor[ 0 ][ i ][ 0 ][ yPovlp ][ xPovlp ] =

inpTLVal

inputTensor[ 0 ][ i ][ 1 ][ yPovlp ][ xPovlp ] =

inpTRVal

inputTensor[ 0 ][ i ][ 2 ][ yPovlp ][ xPovlp ] =

inpBLVal

inputTensor[ 0 ][ i ][ 3 ][ yPovlp ][ xPovlp ] =

inpBRVal

inputTensor[ 0 ][ i ][ 4 ][ yPovlp ][ xPovlp ] =

inpCbVal

inputTensor[ 0 ][ i ][ 5 ][ yPovlp ][ xPovlp ] =

inpCrVal

```
  } else {
        inputTensor[ 0 ][ i ][ yPovlp ][ xPovlp ][ 0 ] =
```

inpTLVal

inputTensor[ 0 ][ i ][ yPovlp ][ xPovlp ][ 1 ] =

inpTRVal

inputTensor[ 0 ][ i ][ yPovlp ][ xPovlp ][ 2 ] =

inpBLVal

inputTensor[ 0 ][ i ][ yPovlp ][ xPovlp ][ 3 ] =

inpBRVal

inputTensor[ 0 ][ i ][ yPovlp ][ xPovlp ][ 4 ] =

inpCbVal

inputTensor[ 0 ][ i ][ yPovlp ][ xPovlp ][ 5 ] =

inpCrVal

}

if( nnpfc_auxiliary_inp_idc = = 1 )

if( !nnpfc_component_last_flag )

inputTensor[ 0 ][ i ][ 6 ][ yPovlp ][ xPovlp ] = strengthControlScaledVal

else

inputTensor[ 0 ][ i ][ yPovlp ][ xPovlp ][ 6 ] = strengthControlScaledVal

```
        }
    }
```

}
...

nnpfc_out_format_idc equal to 0 indicates that the sample values output by the NNPF are real numbers where the value range of 0 to 1, inclusive, maps linearly to the unsigned integer value range of 0 to (1<<bitDepth)−1, inclusive, for any desired bit depth bitDepth for subsequent post-processing or displaying.

nnpfc_out_format_idc equal to 1 indicates that the luma sample values output by the NNPF are unsigned integer numbers in the range of 0 to (1<<(nnpfc_out_tensor_luma_bitdepth_minus8+8))−1, inclusive, and the chroma sample values output by the NNPF are unsigned integer numbers in the range of 0 to (1<<(nnpfc_out_tensor_chroma_bitdepth_minus8+8))−1, inclusive.

Values of nnpfc_out_format_idc greater than 1 are reserved for future specification by ITU-T|ISO/IEC and shall not be present in bitstreams conforming to this edition of this document. Decoders conforming to this edition of this document shall ignore NNPFC SEI messages that contain reserved values of nnpfc_out_format_idc. nnpfc_out_tensor_luma_bitdepth_minus8 plus 8 specifies the bit depth of luma sample values in the output integer tensor. The value of nnpfc_out_tensor_luma_bitdepth_minus8 shall be in the range of 0 to 24, inclusive. nnpfc_out_tensor_chroma_bitdepth_minus8 plus 8 specifies the bit depth of chroma sample values in the output integer tensor. The value of nnpfc_out_tensor_chroma_bitdepth_minus8 shall be in the range of 0 to 24, inclusive.

When nnpfc_purpose & 0x10 is not equal to 0, the value of nnpfc_out_format_idc shall be equal to 1 and at least one of the following conditions shall be true:
nnpfc_out_tensor_luma_bitdepth_minus8+8 is greater than BitDepth_{Y}.
nnpfc_out_tensor_chroma_bitdepth_minus8+8 is greater than BitDepth_{C}.

nnpfc_out_order_idc indicates the output order of samples resulting from the NNPF.

The value of nnpfc_out_order_idc shall be in the range of 0 to 3, inclusive, in bitstreams conforming to this edition of this document. Values of 4 to 255, inclusive, for nnpfc_out_order_idc are reserved for future use by ITU-T|ISO/IEC and shall not be present in bitstreams conforming to this edition of this document. Decoders conforming to this edition of this document shall ignore NNPFC SEI messages with nnpfc_out_order_idc in the range of 4 to 255, inclusive. Values of nnpfc_out_order_idc greater than 255 shall not be present in bitstreams conforming to this edition of this document and are not reserved for future use.

When nnpfc_purpose & 0x02 is not equal to 0, nnpfc_out_order_idc shall not be equal to 3.

Table 12 contains an informative description of nnpfc_out_order_idc values.

TABLE 12
Description of nnpfc_out_order_idc values

| nnpfc_out_{—} | |
|---|---|
| order_idc | Description |
| 0 | Only the luma matrix is present in the output tensor, thus the number of channels is 1. |
| 1 | Only the chroma matrices are present in the output tensor, thus the number of channels is 2. |
| 2 | The luma and chroma matrices are present in the output tensor, thus the number of channels |
| | is 3. |
| 3 | Four luma matrices and two chroma matrices are present in the output tensor, thus the |
| | number of channels is 6. This nnpfc_out_order_idc can only be used when the output chroma |
| | format is 4:2:0. |
| 4 . . . 255 | Reserved |

The process StoreOutputTensors( ) for deriving sample values in the filtered output sample arrays FilteredYPic, FilteredCbPic, and FilteredCrPic from the output tensor outputTensor for a given vertical sample coordinate cTop and a horizontal sample coordinate cLeft specifying the top-left sample location for the patch of samples included in the input tensor, is specified as follows:

```
  for( i = 0; i < numOutputPics; i++ ) {
    if( nnpfc_out_order_idc = = 0 )
      for( yP = 0; yP < outPatchHeight; yP++)
        for( xP = 0; xP < outPatchWidth; xP++ ) {
          yY = cTop * outPatchHeight / inpPatchHeight + yP
          xY = cLeft * outPatchWidth / inpPatchWidth + xP
          if ( yY < nnpfc_pic_height_in_luma_samples && xY < nnpfc_pic_width_in_luma_samples )
            if( !nnpfc_component_last_flag )
              FilteredYPic[ i ][ xY ][yY ] = outputTensor[ 0 ][ i ][ 0 ][ yP ][ xP ]
            else
              FilteredYPic[ i ][ xY ][ yY ] = outputTensor[ 0 ][ i ][ yP ][ xP ][ 0 ]
        }
    else if( nnpfc_out_order_idc = = 1 ) (85)
      for( yP = 0; yP < outPatchCHeight; yP++)
        for( xP = 0; xP < outPatchCWidth; xP++ ) {
          xSrc = cLeft * horCScaling + xP
          ySrc = cTop * verCScaling + yP
          if ( ySrc < nnpfc_pic_height_in_luma_samples / outSubHeightC &&
              xSrc < nnpfc_pic_width_in_luma_samples / outSubWidthC )
            if( !nnpfc_component_last_flag ) {
              FilteredCbPic[ i ][ xSrc ][ ySrc ] = outputTensor[ 0 ][ i ][ 0 ][ yP ][ xP ]
              FilteredCrPic[ i ][ xSrc ][ ySrc ] = outputTensor[ 0 ][ i ][ 1 ][ yP ][ xP ]
            } else {
              FilteredCbPic[ i ][ xSrc ][ ySrc ] = outputTensor[ 0 ][ i ][ yP ][ xP ][ 0 ]
              FilteredCrPic[ i ][ xSrc ][ ySrc ] = outputTensor[ 0 ][ i ][ yP ][ xP ][ 1 ]
            }
        }
    else if( nnpfc_out_order_idc = = 2 )
      for( yP = 0; yP < outPatchHeight; yP++)
        for( xP = 0; xP < outPatchWidth; xP++ ) {
          yY = cTop * outPatchHeight / inpPatchHeight + yP
          xY = cLeft * outPatchWidth / inpPatchWidth + xP
          yC = yY / outSubHeightC
          xC = xY / outSubWidthC
          yPc = ( yP / outSubHeightC ) * outSubHeightC
          xPc = ( xP / outSubWidthC ) * outSubWidthC
          if ( yY < nnpfc_pic_height_in_luma_samples && xY < nnpfc_pic_width_in_luma_samples)
            if( !nnpfc_component_last_flag ) {
              FilteredYPic[ i ][ xY ][ yY ] = outputTensor[ 0 ][ i ][ 0 ][ yP ][ xP ]
              FilteredCbPic[ i ][ xC ][ yC ] = outputTensor[ 0 ][ i ][ 1 ][ yPc ][ xPc ]
              FilteredCrPic[ i ][ xC ][ yC ] = outputTensor[ 0 ][ i ][ 2 ][ yPc ][ xPc ]
            } else {
              FilteredYPic[ i ][ xY ][ yY ] = outputTensor[ 0 ][ i ][ yP ][ xP ][ 0 ]
              FilteredCbPic[ i ][ xC ][ yC ] = outputTensor[ 0 ][ i ][ yPc ][ xPc ][ 1 ]
              FilteredCrPic[ i ][ xC ][ yC ] = outputTensor[ 0 ][ i ][ yPc ][ xPc ][ 2 ]
            }
        }
    else if( nnpfc_out_order_idc = = 3 )
      for( yP = 0; yP < outPatchHeight; yP++ )
        for( xP = 0; xP < outPatchWidth; xP++ ) {
          ySrc = cTop / 2 * outPatchHeight / inpPatchHeight + yP
          xSrc = cLeft / 2 * outPatchWidth / inpPatchWidth + xP
          if ( ySrc < nnpfc_pic_height_in_luma_samples / 2 &&
              xSrc < nnpfc_pic_width_in_luma_samples / 2 )
            if( !nnpfc_component_last_flag ) {
              FilteredYPic[ i ][ xSrc * 2 ][ ySrc * 2 ] = outputTensor[ 0 ][ i ][ 0 ][ yP ][ xP ]
              FilteredYPic[ i ][ xSrc * 2 + 1 ][ ySrc * 2 ] = outputTensor[ 0 ][ i ][ 1 ][ yP ][ xP ]
              FilteredYPic[ i ][ xSrc * 2 ][ ySrc * 2 + 1 ] = outputTensor[ 0 ][ i ][ 2 ][ yP ][ xP ]
              FilteredYPic[ i ][ xSrc * 2 + 1][ ySrc * 2 + 1 ] = outputTensor[ 0 ][ i ][ 3 ][ yP ][ xP ]
              FilteredCbPic[ i ][ xSrc ][ ySrc ] = outputTensor[ 0 ][ i ][ 4 ][ yP ][ xP ]
              FilteredCrPic[ i ][ xSrc ][ ySrc ] = outputTensor[ 0 ][ i ][ 5 ][ yP ][ xP ]
            } else {
              FilteredYPic[ i ][ xSrc * 2 ][ ySrc * 2 ] = outputTensor[ 0 ][ i ][ yP ][ xP ][ 0 ]
              FilteredYPic[ i ][ xSrc * 2 + 1 ][ ySrc * 2 ] = outputTensor[ 0 ][ i ][ yP ][ xP ][ 1 ]
              FilteredYPic[ i ][ xSrc * 2 ][ ySrc * 2 + 1 ] = outputTensor[ 0 ][ i ][ yP ][ xP ][ 2 ]
              FilteredYPic[ i ][ xSrc * 2 + 1][ ySrc * 2 + 1 ] = outputTensor[ 0 ][ i ][ yP ][ xP ][ 3 ]
              FilteredCbPic[ i ][ xSrc ][ ySrc ] = outputTensor[ 0 ][ i ][ yP ][ xP ][ 4 ]
              FilteredCrPic[ i ][ xSrc ][ ySrc ] = outputTensor[ 0 ][ i ][ yP ][ xP ][ 5 ]
            }
        }
  }
...
```

nnpfc_padding_type indicates the process of padding when referencing sample locations outside the boundaries of the cropped decoded output picture as described in Table 13. The value of nnpfc_padding_type shall be in the range of 0 to 15, inclusive.

TABLE 13
Informative description of nnpfc_padding_type values

| nnpfc_padding_type | Description |
|---|---|
| 0 | zero padding |
| 1 | replication padding |
| 2 | reflection padding |
| 3 | wrap-around padding |
| 4 | fixed padding |
| 5 . . . 15 | Reserved |

nnpfc_luma_padding_val indicates the luma value to be used for padding when nnpfc_padding_type is equal to 4.

nnpfc_cb_padding_val indicates the Cb value to be used for padding when nnpfc_padding_type is equal to 4. nnpfc_cr_padding_val indicates the Cr value to be used for padding when nnpfc_padding_type is equal to 4. nnpfc_depth_padding_val indicates the depth value to be used for padding when nnpfc_padding_type is equal to 4. The value of nnpfc_depth_padding_val shall be in the range of 0 to 2^{nnpfc_inp_tensor_depth_bitdepth_minus8+8}−1, inclusive.

The function InpSampleVal (y, x, picHeight, picWidth, croppedPic) with inputs being a vertical sample location y, a horizontal sample location x, a picture height picHeight, a picture width picWidth, and sample array croppedPic returns the value of sample Val derived as follows:
NOTE 6—For the inputs to the function InpSampleVal( ) the vertical location is listed before the horizontal location for compatibility with input tensor conventions of some inference engines.

```
If( nnpfc_padding_type = = 0 )
  if( y < 0 || x < 0 || y >= picHeight || x >= picWidth )
    sampleVal = 0
  else
    sampleVal = croppedPic[ x ][ y ] (92)
else if( nnpfc_padding_type = = 1 )
  sampleVal = croppedPic[ Clip3( 0, picWidth − 1, x) ][ Clip3( 0,
  picHeight − 1, y) ]
else if( nnpfc_padding_type = = 2 )
  sampleVal = croppedPic[ Reflect( picWidth − 1, x ) ][ Reflect(
  picHeight − 1, y) ]
else if( nnpfc_padding_type = = 3 )
  if( y >= 0 && y < picHeight )
    sampleVal = croppedPic[ Wrap( picWidth − 1, x ) ][ y ]
else if( nnpfc_padding_type = = 4 )
  if( y < 0 || x < 0 || y >= picHeight || x >= picWidth ) {
    sampleVal[ 0 ] = nnpfc_luma_padding_val
    sampleVal[ 1 ] = nnpfc_cb_padding_val
    sampleVal[ 2 ] = nnpfc_cr_padding_val
    if( nnpfc_{—}depth_{—}input_{—}flag )
      sampleVal[ 3 ] = nnpfc_{—}depth_{—}padding_{—}val
  } else
    sampleVal = croppedPic[ x ][ y ]
```

More details of the embodiments of the present disclosure will be described below which are related to neural-network post-processing filter. As used herein, the term “neural-network post-processing filter” and “neural-network post-filter” may be used interchangeably. The embodiments of the present disclosure should be considered as examples to explain the general concepts and should not be interpreted in a narrow way. Furthermore, these embodiments can be applied individually or combined in any manner.

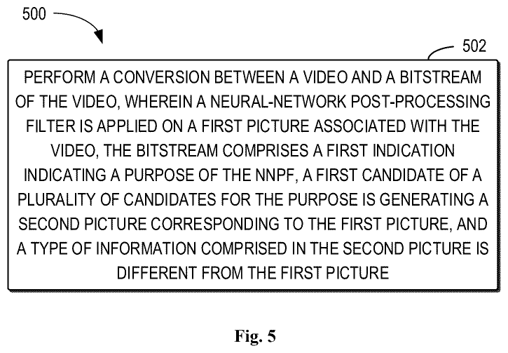

FIG. 5 illustrates a flowchart of a method 500 for video processing in accordance with some embodiments of the present disclosure. As shown in FIG. 5, at 502, a conversion between a video and a bitstream of the video is performed. In some embodiments, the conversion may include encoding the video into the bitstream. Alternatively or additionally, the conversion may include decoding the video from the bitstream.

A neural-network post-processing filter (NNPF) is applied on first picture associated with the video. For example, the first picture may be used as an input for the NNPF. In some embodiments, the first picture may be a decoded picture of the video. Alternatively, the first picture may be a cropped decoded picture of the video. For example, the decoded picture and/or the cropped decoded picture may be outputted by a decoder that decodes the video from the bitstream. In some further embodiments, the first picture may comprise an output of a further NNPF used to filter one or more decoded pictures or cropped decoded pictures of the video. For example, the NNPF is concatenated with the further NNPF. It should be understood that the possible implementations of the first picture associated with the video described here are merely illustrative and therefore should not be construed as limiting the present disclosure in any way.

The bitstream comprises a first indication indicating a purpose of the NNPF. By way of example, the first indication may be comprised in a supplemental enhancement information (SEI) message or any other suitable video message unit in the bitstream. For example, the first indication may comprise a syntax element nnpfc_purpose. It should be understood that the name for an indication and/or a syntax element is used only for illustration rather than limitation, the indication(s) and the syntax element(s) mentioned throughout the present disclosure may be represented by any other suitable string different from that mentioned in this disclosure. The scope of the present disclosure is not limited in this respect.

In addition, a first candidate of a plurality of candidates for the purpose is generating a second picture corresponding to the first picture, and a type of information comprised in the second picture is different from the first picture. By way of example rather than limitation, the first picture may comprise texture information, and the first picture may be a texture picture.

In one example, the second picture may comprise depth information, and the second picture may be a depth picture (a.k.a., depth image or depth map). In this case, the first candidate for the purpose may be depth picture generation. In another example, the second picture may comprise alpha channel information, and the second picture may be an alpha channel picture. In this case, the first candidate for the purpose may be alpha channel picture generation. In a further example, the second picture may comprise disparity information, and the second picture may be a disparity picture (a.k.a., disparity image or disparity map). In this case, the first candidate for the purpose may be disparity picture generation. In a still further example, the second picture may comprise geometry information, and the second picture may be a geometry picture. In this case, the first candidate for the purpose may be geometry picture generation. It should be understood that the possible implementations of the first picture and the second picture described here are merely illustrative and therefore should not be construed as limiting the present disclosure in any way.

In view of the above, candidates for a purpose of NNPF comprises generating a second picture corresponding to a first picture, and a type of information comprised in the second picture is different from the first picture. Compared with the conventional solution, the proposed method can advantageously make it possible for the NNPF to support generate a picture that is of a type different from the input picture of the NNPF. Thereby, the functionality of NNPF may be extended and enhanced.

In some embodiments, the first candidate may be only for generating the second picture. Alternatively, the first candidate may be allowed to be combined with at least one further candidate of the plurality of candidates. By way of example rather than limitation, the at least one further candidate may comprise picture rate upsampling of the video, general visual quality improvement of the first picture, colorization of the first picture, chroma upsampling of the video, bit depth upsampling of the first picture, and/or the like.

In some embodiments, the above-mentioned purpose candidates may be combined based on a bit masking method. For example, each of the plurality of candidates for the purpose may correspond to a bit mask, and the bit mask may be used for determining the purpose of the NNPF based on the first indication. In addition, one bit in the first indication indicates whether the purpose of the NNPF may comprise one of the plurality of candidates for the purpose. By way of example rather than limitation, if a value of a first bit (such as bit 0, bit 1 or the like) in the first indication is equal to a first value (such as 1 or the like), the purpose of the NNPF may comprise the first candidate for the purpose. If the value of the first bit is equal to a second value (such as 0 or the like), the purpose of the NNPF may do not comprise the first candidate for the purpose.

Furthermore, the purpose of the NNPF may be determined based on a result of applying a bitwise operation on the first indication and at least one bit mask. By way of example rather than limitation, bit 0 may represent the least significant bit in a syntax element nnpfc_purpose, while bit 1 in the syntax element nnpfc_purpose may correspond to depth picture generation. A bit mask 0x02 may be used for determining whether the purpose of the NNPF comprises depth picture generation. If (nnpfc_purpose & 0x02) is equal to 0, the purpose of the NNPF does not comprise depth picture generation. If (nnpfc_purpose & 0x02) is larger than 0, the purpose of the NNPF comprises depth picture generation. The operator “&” represents a bitwise AND operation. It should be understood that the above illustrations are described merely for purpose of description. The scope of the present disclosure is not limited in this respect.

In view of the above, one of the plurality of candidates for the purpose of the NNPF corresponds to a bit mask that is used for determining the purpose of the NNPF based on the first indication. Compared with the conventional solution, the proposed method advantageously provides a systematic scheme for signaling the purpose of the NNPF, and thus supports a possible extension of the purpose. Thereby, potential instability and logical issues can be avoided, and the coding efficiency can be improved.

In some embodiments, a bit depth of a sample value in the second picture may be determined. Alternatively, the bit depth of the sample value in the second picture may be specified, e.g., in a standard specification or the like. In some further embodiments, the bit depth of the sample value in the second picture may be predetermined. In some still further embodiments, the bit depth of the sample value in the second picture may be indicated in the bitstream. By way of example rather than limitation, the bitstream may comprise a syntax element indicating a bit depth of a sample value in the second picture.

In some embodiments, a bit depth of a sample value in the second picture may be the same as a bit depth of a luma sample value in the first picture. Alternatively, the bit depth of the sample value in the second picture may be the same as a bit depth of a chroma sample value in the first picture.

In some embodiments, a width and/or a height of the second picture may be determined. Alternatively, the width and/or the height of the second picture may be specified, e.g., in a standard specification or the like. In some further embodiments, the width and/or the height of the second picture may be indicated in the bitstream.

In some embodiments, a width of the second picture may be the same as a width of the first picture, and/or a height of the second picture may be the same as a height of the first picture. Alternatively, one of a width or a height of the second picture may be indicated in the bitstream, and the other one of the width or the height of the second picture may be determined based on an aspect ratio of the second picture. For example, the aspect ratio of the second picture may be required to the same as an aspect ratio of the first picture.

In view of the above, the solutions in accordance with some embodiments of the present disclosure can advantageously extend and enhance the functionality of NNPF.

According to further embodiments of the present disclosure, a non-transitory computer-readable recording medium is provided. The non-transitory computer-readable recording medium stores a bitstream of a video which is generated by a method performed by an apparatus for video processing. In the method, a conversion between a video and a bitstream of the video is performed. An NNPF is applied on a first picture associated with the video. The bitstream comprises a first indication indicating a purpose of the NNPF. Moreover, a first candidate of a plurality of candidates for the purpose is generating a second picture corresponding to the first picture, and a type of information comprised in the second picture is different from the first picture.

According to still further embodiments of the present disclosure, a method for storing bitstream of a video is provided. In the method, a conversion between a video and a bitstream of the video is performed. An NNPF is applied on a first picture associated with the video. The bitstream comprises a first indication indicating a purpose of the NNPF. Moreover, a first candidate of a plurality of candidates for the purpose is generating a second picture corresponding to the first picture, and a type of information comprised in the second picture is different from the first picture. In addition, the bitstream is stored in a non-transitory computer-readable recording medium.

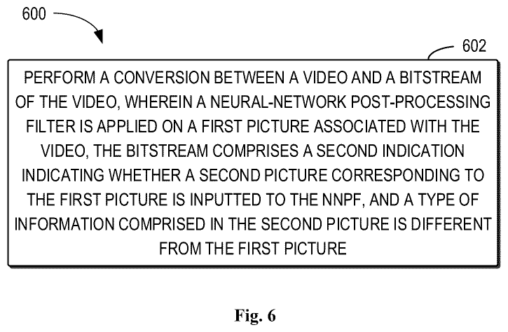

FIG. 6 illustrates a flowchart of another method 600 for video processing in accordance with some embodiments of the present disclosure. As shown in FIG. 6, at 602, a conversion between a video and a bitstream of the video is performed. In some embodiments, the conversion may include encoding the video into the bitstream. Alternatively or additionally, the conversion may include decoding the video from the bitstream.

A neural-network post-processing filter (NNPF) is applied on first picture associated with the video. For example, the first picture may be used as an input for the NNPF. In some embodiments, the first picture may be a decoded picture of the video. Alternatively, the first picture may be a cropped decoded picture of the video. For example, the decoded picture and/or the cropped decoded picture may be outputted by a decoder that decodes the video from the bitstream. In some further embodiments, the first picture may comprise an output of a further NNPF used to filter one or more decoded pictures or cropped decoded pictures of the video. For example, the NNPF is concatenated with the further NNPF. It should be understood that the possible implementations of the first picture associated with the video described here are merely illustrative and therefore should not be construed as limiting the present disclosure in any way.

The bitstream comprises a second indication indicating whether a second picture corresponding to the first picture is inputted to the NNPF, and a type of information comprised in the second picture is different from the first picture. In other words, the second indication indicates whether the second picture is used as input to the NNPF. By way of example, the second indication may be comprised in a supplemental enhancement information (SEI) message or any other suitable video message unit in the bitstream. For example, the second indication may comprise a syntax element, such as, a syntax element nnpfc_input_depth_flag. It should be understood that the name for an indication and/or a syntax element is used only for illustration rather than limitation, the indication(s) and the syntax element(s) mentioned throughout the present disclosure may be represented by any other suitable string different from that mentioned in this disclosure. The scope of the present disclosure is not limited in this respect.

By way of example rather than limitation, the first picture may comprise texture information, and the first picture may be a texture picture. In one example, the second picture may comprise depth information, and the second picture may be a depth picture (a.k.a., depth image or depth map). In another example, the second picture may comprise alpha channel information, and the second picture may be an alpha channel picture. In a further example, the second picture may comprise disparity information, and the second picture may be a disparity picture (a.k.a., disparity image or disparity map). In a still further example, the second picture may comprise geometry information, and the second picture may be a geometry picture. It should be understood that the possible implementations of the first picture and the second picture described here are merely illustrative and therefore should not be construed as limiting the present disclosure in any way.

In view of the above, the bitstream comprises an indication indicating whether a second picture corresponding to a first picture is inputted to the NNPF, and a type of information comprised in the second picture is different from the first picture. Compared with the conventional solution, the proposed method can advantageously make it possible for the NNPF use a picture that is of a type different from an input picture of the NNPF as an additional input. Thereby, the functionality of NNPF may be extended and enhanced.

In some embodiments, the second indication may indicate that the second picture is inputted to the NNPF, and the second picture may be inputted to the NNPF. In one example embodiment, the NNPF may be applied on the first picture based on the second picture. For example, the second picture may be used to assist the NNPF in processing the first picture for a selected purpose. By way of example, the purpose of the NNPF may comprise picture rate upsampling of the video, general visual quality improvement of the first picture, colorization of the first picture, chroma upsampling of the video, bit depth upsampling of the first picture, generating a second picture corresponding to the first picture, and/or the like.

In some embodiments, a bit depth of a sample value in the second picture may be determined. Alternatively, the bit depth of the sample value in the second picture may be specified, e.g., in a standard specification or the like. In some still further embodiments, the bit depth of the sample value in the second picture may be predetermined. In some further embodiments, the bit depth of the sample value in the second picture may be indicated in the bitstream. By way of example rather than limitation, a result of subtracting a predetermined value (such as 8 or the like) from the bit depth of the sample value in the second picture may be indicated in the bitstream.

In some embodiments, a bit depth of a sample value in the second picture may be the same as a bit depth of a luma sample value in the first picture. Alternatively, the bit depth of the sample value in the second picture may be the same as a bit depth of a chroma sample value in the first picture.

In some embodiments, if the second picture is inputted to the NNPF, a value used for padding the second picture when a type of padding is fixed padding may be indicated in the bitstream. For example, this value may be indicated by a syntax element nnpfc_depth_padding_val or the like. The value used for padding the second picture may be in a range of 0 to 2^{B}−1 inclusive, and B represents a bit depth of a sample value in the second picture.

In some embodiments, the second picture may be specified as auxiliary input data. Additionally or alternatively, the second picture may be accessed in a sample-wise manner.

In some embodiments, the second picture may be decoded from the bitstream. For example, the second picture may be obtained via a layer for the second picture. By way of example rather than limitation, if the second picture is a depth picture, the depth picture may be obtained from the decoder via a depth layer, e.g., with AuxId equal to AUX_DEPTH. It should be understood that the second picture may also be obtained in any other suitable, e.g., being received from a further device. The scope of the present disclosure is not limited in this respect.

In view of the above, the solutions in accordance with some embodiments of the present disclosure can advantageously extend and enhance the functionality of NNPF.

According to further embodiments of the present disclosure, a non-transitory computer-readable recording medium is provided. The non-transitory computer-readable recording medium stores a bitstream of a video which is generated by a method performed by an apparatus for video processing. In the method, a conversion between a video and a bitstream of the video is performed. An NNPF is applied on a first picture associated with the video. In addition, the bitstream comprises a second indication indicating whether a second picture corresponding to the first picture is inputted to the NNPF, and a type of information comprised in the second picture is different from the first picture.

According to still further embodiments of the present disclosure, a method for storing bitstream of a video is provided. In the method, a conversion between a video and a bitstream of the video is performed. An NNPF is applied on a first picture associated with the video. In addition, the bitstream comprises a second indication indicating whether a second picture corresponding to the first picture is inputted to the NNPF, and a type of information comprised in the second picture is different from the first picture. Moreover, the bitstream is stored in a non-transitory computer-readable recording medium.

Implementations of the present disclosure can be described in view of the following clauses, the features of which can be combined in any reasonable manner.

Clause 1. A method for video processing, comprising: performing a conversion between a video and a bitstream of the video, wherein a neural-network post-processing filter (NNPF) is applied on a first picture associated with the video, the bitstream comprises a first indication indicating a purpose of the NNPF, a first candidate of a plurality of candidates for the purpose is generating a second picture corresponding to the first picture, and a type of information comprised in the second picture is different from the first picture.

Clause 2. The method of clause 1, wherein the second picture comprises one of the following: depth information, alpha channel information, disparity information, or geometry information.

Clause 3. The method of any of clauses 1-2, wherein the second picture is one of the following: a depth picture, an alpha channel picture, a disparity picture, or a geometry picture.

Clause 4. The method of any of clauses 1-3, wherein the first indication comprises a syntax element nnpfc_purpose.

Clause 5. The method of any of clauses 1-4, wherein the first picture is a decoded picture of the video or a cropped decoded picture of the video.

Clause 6. The method of any of clauses 1-5, wherein the first candidate is only for generating the second picture.

Clause 7. The method of any of clauses 1-5, wherein the first candidate is allowed to be combined with at least one further candidate of the plurality of candidates.

Clause 8. The method of clause 7, wherein the at least one further candidate comprises at least one of the following: picture rate upsampling of the video, general visual quality improvement of the first picture, colorization of the first picture, chroma upsampling of the video, or bit depth upsampling of the first picture.

Clause 9. The method of any of clauses 1-8, wherein each of the plurality of candidates for the purpose corresponds to a bit mask, and the bit mask is used for determining the purpose of the NNPF based on the first indication.

Clause 10. The method of any of clauses 1-9, wherein one bit in the first indication indicates whether the purpose of the NNPF comprises one of the plurality of candidates for the purpose.

Clause 11. The method of any of clauses 9, wherein the purpose of the NNPF is determined based on a result of applying a bitwise operation on the first indication and at least one bit mask.

Clause 12. The method of any of clauses 1-11, wherein a bit depth of a sample value in the second picture is determined, or the bit depth of the sample value in the second picture is specified, or the bit depth of the sample value in the second picture is indicated in the bitstream, or the bit depth of the sample value in the second picture is predetermined.

Clause 13. The method of any of clauses 1-12, wherein the bitstream comprises a syntax element indicating a bit depth of a sample value in the second picture.

Clause 14. The method of any of clauses 1-12, wherein a bit depth of a sample value in the second picture is the same as a bit depth of a luma sample value in the first picture, or the bit depth of the sample value in the second picture is the same as a bit depth of a chroma sample value in the first picture.

Clause 15. The method of any of clauses 1-14, wherein at least one of a width or a height of the second picture is determined, or at least one of the width or the height of the second picture is specified, or at least one of the width or the height of the second picture is indicated in the bitstream.

Clause 16. The method of any of clauses 1-14, wherein a width of the second picture is the same as a width of the first picture, and/or a height of the second picture is the same as a height of the first picture.

Clause 17. The method of any of clauses 1-14, wherein one of a width or a height of the second picture is indicated in the bitstream, and the other one of the width or the height of the second picture is determined based on an aspect ratio of the second picture.

Clause 18. The method of clause 17, wherein the aspect ratio of the second picture is the same as an aspect ratio of the first picture.

Clause 19. A method for video processing, comprising: performing a conversion between a video and a bitstream of the video, wherein a neural-network post-processing filter (NNPF) is applied on a first picture associated with the video, the bitstream comprises a second indication indicating whether a second picture corresponding to the first picture is inputted to the NNPF, and a type of information comprised in the second picture is different from the first picture.

Clause 20. The method of clause 19, wherein the second picture comprises one of the following: depth information, alpha channel information, disparity information, or geometry information.

Clause 21. The method of any of clauses 19-20, wherein the second picture is one of the following: a depth picture, an alpha channel picture, a disparity picture, or a geometry picture.

Clause 22. The method of any of clauses 19-21, wherein the first indication comprises a syntax element.

Clause 23. The method of any of clauses 19-22, wherein the first picture is a decoded picture of the video or a cropped decoded picture of the video.

Clause 24. The method of any of clauses 19-23, wherein the second picture is inputted to the NNPF.

Clause 25. The method of clause 24, wherein the NNPF is applied on the first picture based on the second picture.

Clause 26. The method of any of clauses 19-25, wherein a purpose of the NNPF comprises at least one of the following: picture rate upsampling of the video, general visual quality improvement of the first picture, colorization of the first picture, chroma upsampling of the video, bit depth upsampling of the first picture, or generating a second picture corresponding to the first picture.

Clause 27. The method of any of clauses 19-26, wherein a bit depth of a sample value in the second picture is determined, or the bit depth of the sample value in the second picture is specified, or the bit depth of the sample value in the second picture is indicated in the bitstream, or the bit depth of the sample value in the second picture is predetermined.

Clause 28. The method of any of clauses 19-27, wherein a result of subtracting a predetermined value from a bit depth of a sample value in the second picture is indicated in the bitstream.

Clause 29. The method of clause 28, wherein the predetermined value is equal to 8.

Clause 30. The method of any of clauses 19-29, wherein a bit depth of a sample value in the second picture is the same as a bit depth of a luma sample value in the first picture, or the bit depth of the sample value in the second picture is the same as a bit depth of a chroma sample value in the first picture.

Clause 31. The method of any of clauses 19-30, wherein if the second picture is inputted to the NNPF, a value used for padding the second picture when a type of padding is fixed padding is indicated in the bitstream.

Clause 32. The method of clause 31, wherein the value used for padding the second picture is in a range of 0 to 2^{B}−1 inclusive, and B represents a bit depth of a sample value in the second picture.

Clause 33. The method of any of clauses 19-32, wherein the second picture is specified as auxiliary input data.

Clause 34. The method of any of clauses 19-33, wherein the second picture is accessed in a sample-wise manner.

Clause 35. The method of any of clauses 19-34, wherein the second picture is decoded from the bitstream.

Clause 36. The method of any of clauses 19-35, wherein the second picture is obtained via a layer for the second picture.

Clause 37. The method of any of clauses 1-36, wherein the first picture comprises texture information.

Clause 38. The method of any of clauses 1-27, wherein the first picture is a texture picture.

Clause 39. The method of any of clauses 1-38, wherein the conversion includes encoding the video into the bitstream.

Clause 40. The method of any of clauses 1-38, wherein the conversion includes decoding the video from the bitstream.

Clause 41. An apparatus for video processing comprising a processor and a non-transitory memory with instructions thereon, wherein the instructions upon execution by the processor, cause the processor to perform a method in accordance with any of clauses 1-40.

Clause 42. A non-transitory computer-readable storage medium storing instructions that cause a processor to perform a method in accordance with any of clauses 1-40.

Clause 43. A non-transitory computer-readable recording medium storing a bitstream of a video which is generated by a method performed by an apparatus for video processing, wherein the method comprises: performing a conversion between a video and a bitstream of the video, wherein a neural-network post-processing filter (NNPF) is applied on a first picture associated with the video, the bitstream comprises a first indication indicating a purpose of the NNPF, a first candidate of a plurality of candidates for the purpose is generating a second picture corresponding to the first picture, and a type of information comprised in the second picture is different from the first picture.

Clause 44. A method for storing a bitstream of a video, comprising: performing a conversion between a video and a bitstream of the video, wherein a neural-network post-processing filter (NNPF) is applied on a first picture associated with the video, the bitstream comprises a first indication indicating a purpose of the NNPF, a first candidate of a plurality of candidates for the purpose is generating a second picture corresponding to the first picture, and a type of information comprised in the second picture is different from the first picture; and storing the bitstream in a non-transitory computer-readable recording medium.

Clause 45. A non-transitory computer-readable recording medium storing a bitstream of a video which is generated by a method performed by an apparatus for video processing, wherein the method comprises: performing a conversion between a video and a bitstream of the video, wherein a neural-network post-processing filter (NNPF) is applied on a first picture associated with the video, the bitstream comprises a second indication indicating whether a second picture corresponding to the first picture is inputted to the NNPF, and a type of information comprised in the second picture is different from the first picture.

Clause 46. A method for storing a bitstream of a video, comprising: performing a conversion between a video and a bitstream of the video, wherein a neural-network post-processing filter (NNPF) is applied on a first picture associated with the video, the bitstream comprises a second indication indicating whether a second picture corresponding to the first picture is inputted to the NNPF, and a type of information comprised in the second picture is different from the first picture; and storing the bitstream in a non-transitory computer-readable recording medium.

### Example Device

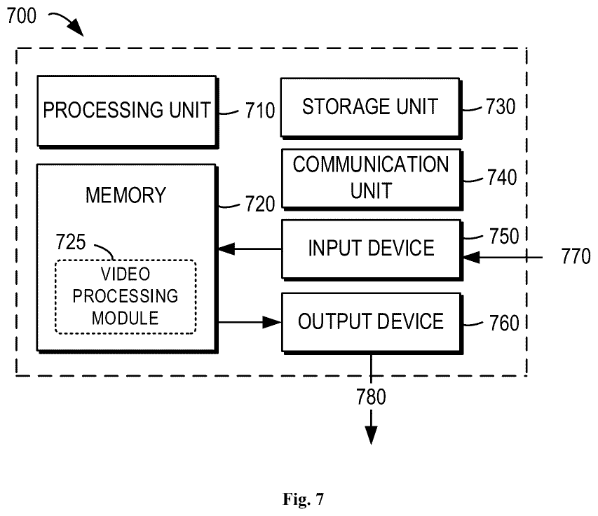

FIG. 7 illustrates a block diagram of a computing device 700 in which various embodiments of the present disclosure can be implemented. The computing device 700 may be implemented as or included in the source device 110 (or the video encoder 114 or 200) or the destination device 120 (or the video decoder 124 or 300).

It would be appreciated that the computing device 700 shown in FIG. 7 is merely for purpose of illustration, without suggesting any limitation to the functions and scopes of the embodiments of the present disclosure in any manner.

As shown in FIG. 7, the computing device 700 includes a general-purpose computing device 700. The computing device 700 may at least comprise one or more processors or processing units 710, a memory 720, a storage unit 730, one or more communication units 740, one or more input devices 750, and one or more output devices 760.

In some embodiments, the computing device 700 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 700 can support any type of interface to a user (such as “wearable” circuitry and the like).

The processing unit 710 may be a physical or virtual processor and can implement various processes based on programs stored in the memory 720. In a multi-processor system, multiple processing units execute computer executable instructions in parallel so as to improve the parallel processing capability of the computing device 700. The processing unit 710 may also be referred to as a central processing unit (CPU), a microprocessor, a controller or a microcontroller.

The computing device 700 typically includes various computer storage medium. Such medium can be any medium accessible by the computing device 700, including, but not limited to, volatile and non-volatile medium, or detachable and non-detachable medium. The memory 720 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 730 may be any detachable or non-detachable medium and may include a machine-readable medium such as a memory, flash memory drive, magnetic disk or another other media, which can be used for storing information and/or data and can be accessed in the computing device 700.

The computing device 700 may further include additional detachable/non-detachable, volatile/non-volatile memory medium. Although not shown in FIG. 7, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 740 communicates with a further computing device via the communication medium. In addition, the functions of the components in the computing device 700 can be implemented by a single computing cluster or multiple computing machines that can communicate via communication connections. Therefore, the computing device 700 can operate in a networked environment using a logical connection with one or more other servers, networked personal computers (PCs) or further general network nodes.

The input device 750 may be one or more of a variety of input devices, such as a mouse, keyboard, tracking ball, voice-input device, and the like. The output device 760 may be one or more of a variety of output devices, such as a display, loudspeaker, printer, and the like. By means of the communication unit 740, the computing device 700 can further communicate with one or more external devices (not shown) such as the storage devices and display device, with one or more devices enabling the user to interact with the computing device 700, or any devices (such as a network card, a modem and the like) enabling the computing device 700 to communicate with one or more other computing devices, if required. Such communication can be performed via input/output (I/O) interfaces (not shown).

In some embodiments, instead of being integrated in a single device, some or all components of the computing device 700 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 700 may be used to implement video encoding/decoding in embodiments of the present disclosure. The memory 720 may include one or more video coding modules 725 having one or more program instructions. These modules are accessible and executable by the processing unit 710 to perform the functionalities of the various embodiments described herein.

In the example embodiments of performing video encoding, the input device 750 may receive video data as an input 770 to be encoded. The video data may be processed, for example, by the video coding module 725, to generate an encoded bitstream. The encoded bitstream may be provided via the output device 760 as an output 780.

In the example embodiments of performing video decoding, the input device 750 may receive an encoded bitstream as the input 770. The encoded bitstream may be processed, for example, by the video coding module 725, to generate decoded video data. The decoded video data may be provided via the output device 760 as the output 780.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for video processing, comprising:
performing a conversion between a video and a bitstream of the video, wherein a neural-network post-processing filter (NNPF) is applied on a first picture associated with the video, the bitstream comprises a first indication indicating a purpose of the NNPF, a first candidate of a plurality of candidates for the purpose is generating a second picture corresponding to the first picture, and a type of information comprised in the second picture is different from the first picture.

2. The method of claim 1, wherein the second picture comprises one of the following:
depth information,
alpha channel information,
disparity information, or
geometry information.

3. The method of claim 1, wherein the second picture is one of the following:
a depth picture,
an alpha channel picture,
a disparity picture, or
a geometry picture.

4. The method of claim 1, wherein the first indication comprises a syntax element nnpfc_purpose, or
wherein the first picture is a decoded picture of the video or a cropped decoded picture of the video, or
wherein the first candidate is only for generating the second picture.

5. The method of claim 1, wherein the first candidate is allowed to be combined with at least one further candidate of the plurality of candidates.

6. The method of claim 5, wherein the at least one further candidate comprises at least one of the following:
picture rate upsampling of the video,
general visual quality improvement of the first picture,
colorization of the first picture,
chroma upsampling of the video, or
bit depth upsampling of the first picture.

7. The method of claim 1, wherein each of the plurality of candidates for the purpose corresponds to a bit mask, and the bit mask is used for determining the purpose of the NNPF based on the first indication.

8. The method of claim 1, wherein one bit in the first indication indicates whether the purpose of the NNPF comprises one of the plurality of candidates for the purpose.

9. The method of claim 1, wherein the purpose of the NNPF is determined based on a result of applying a bitwise operation on the first indication and at least one bit mask.

10. The method of claim 1, wherein a bit depth of a sample value in the second picture is determined, or the bit depth of the sample value in the second picture is specified, or the bit depth of the sample value in the second picture is indicated in the bitstream, or the bit depth of the sample value in the second picture is predetermined, or
wherein the bitstream comprises a syntax element indicating a bit depth of a sample value in the second picture, or a bit depth of a sample value in the second picture is the same as a bit depth of a luma sample value in the first picture, or the bit depth of the sample value in the second picture is the same as a bit depth of a chroma sample value in the first picture, or
wherein at least one of a width or a height of the second picture is determined, or at least one of the width or the height of the second picture is specified, or at least one of the width or the height of the second picture is indicated in the bitstream, or
wherein a width of the second picture is the same as a width of the first picture, and/or a height of the second picture is the same as a height of the first picture.

11. The method of claim 1, wherein one of a width or a height of the second picture is indicated in the bitstream, and the other one of the width or the height of the second picture is determined based on an aspect ratio of the second picture.

12. The method of claim 11, wherein the aspect ratio of the second picture is the same as an aspect ratio of the first picture.

13. The method of claim 1, wherein the bitstream comprises a second indication indicating whether a third picture corresponding to the first picture is inputted to the NNPF, and a type of information comprised in the third picture is different from the first picture.

14. The method of claim 13, wherein the third picture comprises one of the following: depth information, alpha channel information, disparity information, or geometry information, or
wherein the third picture is one of the following: a depth picture, an alpha channel picture, a disparity picture, or a geometry picture,
wherein the first indication comprises a syntax element, or
wherein the first picture is a decoded picture of the video or a cropped decoded picture of the video, or
wherein the third picture is inputted to the NNPF, and the NNPF is applied on the first picture based on the third picture, or
wherein a purpose of the NNPF comprises at least one of the following:
picture rate upsampling of the video,
general visual quality improvement of the first picture,
colorization of the first picture,
chroma upsampling of the video,
bit depth upsampling of the first picture, or
generating the second picture corresponding to the first picture.

15. The method of claim 13, wherein a bit depth of a sample value in the third picture is determined, or the bit depth of the sample value in the third picture is specified, or the bit depth of the sample value in the third picture is indicated in the bitstream, or the bit depth of the sample value in the third picture is predetermined, or
wherein a result of subtracting a predetermined value from a bit depth of a sample value in the third picture is indicated in the bitstream, or
wherein a bit depth of a sample value in the third picture is the same as a bit depth of a luma sample value in the first picture, or
the bit depth of the sample value in the third picture is the same as a bit depth of a chroma sample value in the first picture, or
wherein if the third picture is inputted to the NNPF, a value used for padding the third picture when a type of padding is fixed padding is indicated in the bitstream, or
wherein the third picture is specified as auxiliary input data, or
wherein the third picture is accessed in a sample-wise manner, or
wherein the third picture is decoded from the bitstream, or
wherein the third picture is obtained via a layer for the third picture.

16. The method of claim 1, wherein the first picture comprises texture information, or
wherein the first picture is a texture picture.

17. The method of claim 1, wherein the conversion includes encoding the video into the bitstream, or
wherein the conversion includes decoding the video from the bitstream.

18. An apparatus for video processing comprising a processor and a non-transitory memory with instructions thereon, wherein the instructions upon execution by the processor, cause the processor to perform acts comprising:
performing a conversion between a video and a bitstream of the video, wherein a neural-network post-processing filter (NNPF) is applied on a first picture associated with the video, the bitstream comprises a first indication indicating a purpose of the NNPF, a first candidate of a plurality of candidates for the purpose is generating a second picture corresponding to the first picture, and a type of information comprised in the second picture is different from the first picture.

19. A non-transitory computer-readable storage medium storing instructions that cause a processor to perform acts comprising:
performing a conversion between a video and a bitstream of the video, wherein a neural-network post-processing filter (NNPF) is applied on a first picture associated with the video, the bitstream comprises a first indication indicating a purpose of the NNPF, a first candidate of a plurality of candidates for the purpose is generating a second picture corresponding to the first picture, and a type of information comprised in the second picture is different from the first picture.

20. A non-transitory computer-readable recording medium storing a bitstream of a video which is generated by a method performed by an apparatus for video processing, wherein the method comprises:
performing a conversion between a video and a bitstream of the video, wherein a neural-network post-processing filter (NNPF) is applied on a first picture associated with the video, the bitstream comprises a first indication indicating a purpose of the NNPF, a first candidate of a plurality of candidates for the purpose is generating a second picture corresponding to the first picture, and a type of information comprised in the second picture is different from the first picture.
